(19) United States
(12) Patent Application Publication
(10) Pub. No.: US 2016/0379074 A1
(43) Pub. Date: Dec. 29, 2016

(54) SYSTEM AND A METHOD FOR TRACKING MOBILE OBJECTS USING CAMERAS AND TAG DEVICES

(71) Applicant: Appropolis Inc., Calgary (CA)

(72) Inventors: Jorgen Staal NIELSEN, Calgary (CA); Phillip Richard GEE, Calgary (CA)

(21) Appl. No.: 14/997,977

(22) Filed: Jan. 18, 2016

Related U.S. Application Data
(60) Provisional application No. 62/184,726, filed on Jun. 25, 2015.
(60) Provisional application No. 62/236,412, filed on Oct. 2, 2015.

(51) Int. Cl. G06K 9/32; H04N 7/18; G06T 7/20; G06K 9/00

(52) U.S. Cl. CPC G06K 9/3241; G06K 9/00771; H04N 7/181; G06T 7/20

(57) ABSTRACT

A method and system for tracking mobile objects in a site are disclosed. The system comprises a computer cloud communicating with one or more imaging devices and one or more tag devices. Each tag device is attached to a mobile object, and has one or more sensors for sensing the motion of the mobile object. The computer cloud visually tracks mobile objects in the site using image streams captured by the imaging devices, and uses measurements obtained from tag devices to resolve ambiguity occurred in mobile object tracking. The computer cloud uses an optimization method to reduce power consumption of tag devices.

### FIELD OF THE DISCLOSURE

The present invention relates generally to a system and a method for tracking mobile objects, and in particular, a system and a method for tracking mobile objects using cameras and tag devices.

### BACKGROUND

Outdoor mobile object tracking such as the Global Positioning System (GPS) is known. In the GPS system of the U.S.A. or similar systems such as the GLONASS system of Russia, the Doppler Orbitography and Radio-positioning Integrated by Satellite (DORIS) of France, the Galileo system of the European Union and the BeiDou system of China, a plurality of satellites on earth orbits communicate with a mobile device in an outdoor environment to determine the location thereof. However, a drawback of these systems is that the satellite communication generally requires line-of-sight communication between the satellites and the mobile device, and thus they are generally unusable in indoor environments, except in restricted areas adjacent to windows and open doors.

Some indoor mobile object tracking methods and systems are also known. For example, in the Bluetooth® Low Energy (BLE) technology, such as the iBeacon™ technology specified by Apple Inc. of Cupertino, Calif., U.S.A. or Samsung's Proximity™, a plurality of BLE access points are deployed in a site and communicate with nearby mobile BLE devices such as smartphones for locating the mobile BLE devices using triangulation. Also indoor WiFi signals are becoming ubiquitous and commonly used for object tracking based on radio signal strength (RSS) observables. However, the mobile object tracking accuracy of these systems is still to be improved. Moreover, these systems can only track the location of a mobile object, and other information such as gestures of a person being tracked cannot be determined by these systems.

It is therefore an object to provide a novel mobile object tracking system and method with higher accuracy, robustness and that provides more information about the mobile objects being tracked.

### SUMMARY

There are a plethora of applications that desire extension of the location of a mobile device or a person in an indoor environment or in a dense urban outdoor environment. According to one aspect of this disclosure, an object tracking system and a method is disclosed for tracking mobile objects in a site, such as a campus, a building, a shopping center or the like.

Herein, mobile objects are moveable objects in the site, such as human being, animals, carts, wheelchairs, robots and the like, and may be moving or stationary from time to time, usually in a random fashion from a statistic point of view.

According to another aspect of this disclosure, visual tracking in combination of tag devices are used for tracking mobile objects in the site. One or more imaging devices such as one or more cameras, are used for intermittently or continuously, visually tracking the locations of one or more mobile objects using suitable image processing technologies. One or more tag devices attached to mobile objects may also be used for refining object tracking and for resolving ambiguity occurred in visual tracking of mobile objects.

As will be described in more detail later, herein, ambiguity occurred in visual object tracking includes a variety of situations that cause visual object tracking less reliable or even unreliable.

Each tag device is a uniquely identifiable, small electronic device attached to a mobile object of interest and moving therewith, undergoing the same physical motion. However, some mobile objects may not have any tag device attached thereto.

Each tag device comprises one or more sensors, and is battery powered and operable for an extended period of time, e.g., several weeks, between battery charges or replacements. The tag devices communicate with one or more processing structures, such as one or more processing structures of one or more server computers, e.g., a so-called computer cloud, using suitable wireless communication methods. Upon receiving a request signal from the computer cloud, a tag device uses its sensors to make measurements or observations of the mobile object associated therewith, and transmits these measurements wirelessly to the system. For example, a tag device may make measurements of the characteristics of the physical motion of itself. As the tag devices undergo the same physical motion as the associated mobile object, the measurements made by the tag devices represent the motion measurements of their associated mobile objects.

According to another aspect of this disclosure, the object tracking system comprises a computer cloud having one or more servers, communicating with one or more imaging devices deployed in a site for visually detecting and tracking moving and stationary mobile objects in the site.

The computer cloud accesses suitable image processing technologies to detect foreground objects, denoted as foreground feature clusters (FFCs), from images or image frames captured by the imaging devices, each FFC representing a candidate mobile object in the field of view (FOV) of the imaging device. The computer cloud then identifies and tracks the FFCs.

When ambiguity occurs in identifying and tracking FFCs, the computer cloud requests one or more candidate tag devices to make necessary tag measurements. The computer cloud uses tag measurements to resolve any ambiguity and associates FFCs with tag devices for tracking.

According to another aspect of this disclosure, when associating FFCs with tag devices, the computer cloud calculates a FFC-tag association probability, indicating the correctness, reliability or belief in the determined association. In this embodiment, the FFC-tag association probability is numerically calculated, e.g., by using a suitable numerical method to find a numerical approximation of the FFC-tag association probability. The FFC-tag association probability is constantly updated as new images and/or tag measurements are made available to the system. The computer cloud attempts to maintain the FFC-tag association probability at or above a predefined probability threshold. If the FFC-tag association probability falls below the probability threshold, more tag measurements are requested. The tag devices, upon request, make the requested measurements and send the requested measurements to the computer cloud for establishing the FFC-tag association.

Like any other systems, the system disclosed herein operates with constraints such as power consumption. Generally, the overall power consumption of the system comprises the power consumption of the tag devices in making tag measurements and the power consumed by other components of the system including the computer cloud and the imaging devices. While the computer cloud and the imaging devices are usually powered by relatively unlimited sources of power, tag devices are usually powered by batteries having limited stored energy. Therefore, it is desirable, although optional in some embodiments, to manage power consumption of tag devices during mobile object tracking through using low power consumption components known in the art, and by only triggering tag devices to conduct measurements when actually needed.

Therefore, according to another aspect of this disclosure, at least in some embodiments, the system is designed using a constrained optimization algorithm with an objective of minimizing tag device energy consumption for a constraint of the probability of correctly associating the tag device with an FFC. The system achieves this objective by requesting tag measurements only when necessary, and by determining the candidate tag devices for providing the required tag measurements.

When requesting tag measurements, the computer cloud first determines a group of candidate tag devices based on the analysis of captured images and determines required tag measurements based on the analysis of captured images and the knowledge of power consumption for making the tag measurements. The computer cloud then only requests the required tag measurements from the candidate tag devices.

One objective of the object tracking system is to visually track mobile objects and using measurements from tag devices attached to mobile objects to resolve ambiguity occurred in visual object tracking. The system tracks the locations of mobile objects having tag devices attached thereto, and optionally and if possible, tracks mobile objects having no tag devices attached thereto. The object tracking system is the combination of:

1) Computer vision processing to visually track the mobile objects as they move throughout the site;

2) Wireless messaging between the tag device and the computer cloud to establish the unique identity of each tag device; herein, wireless messaging refers to any suitable wireless messaging means such as messaging via electromagnetic wave, optical means, acoustic telemetry, and the like;

3) Motion related observations or measurements registered by various sensors in tag devices, communicated wirelessly to the computer cloud; and

4) Cloud or network based processing to correlate the measurements of motion and actions of the tag devices and the computer vision based motion estimation and characterization of mobile objects such that the association of the tag devices and the mobile objects observed by the imaging devices can be quantified through a computed probability of such association.

The object tracking system combines the tracking ability of imaging devices with that of tag devices for associating a unique identity to the mobile object being tracked. Thereby the system can also distinguish between objects that appear similar, being differentiated by the tag. In another aspect, if some tag devices are associated with the identities of the mobile objects they attached to, the object tracking system can further identify the identities of the mobile objects and track them.

In contradistinction, known visual object tracking technologies using imaging devices can associate a unique identity to the mobile object being tracked only if the image of the mobile object has at least one unique visual feature such as an identification mark, e.g., an artificial mark or a biometrical mark, e.g., a face feature, which may be identified by computer vision processing methods such as face recognition. Such detailed visual identity recognition is not always available or economically feasible.

According to one aspect of this disclosure, there is provided a system for tracking at least one mobile object in a site. The system comprises: one or more imaging devices capturing images of at least a portion of the site; and one or more tag devices, each of the one or more tag devices being associated with one of the at least one mobile object and moveable therewith, each of the one or more tag devices obtaining one or more tag measurements related to the mobile object associated therewith; and at least one processing structure combining the captured images with at least one of the one or more tag measurements for tracking the at least one mobile object.

In some embodiments, each of the one or more tag devices comprises one or more sensors for obtaining the one or more tag measurements.

In some embodiments, the one or more sensors comprise at least one of an Inertial Measurement Unit (IMU), a barometer, a thermometer, a magnetometer, a global navigation satellite system (GNSS) sensor, an audio frequency microphone, a light sensor, a camera, and a receiver signal strength (RSS) measurement sensor.

In some embodiments, the RSS measurement sensor is a sensor for measuring the signal strength of a received wireless signal received from a transmitter, for estimating the distance from the transmitter.

In some embodiments, the wireless signal is at least one of a Bluetooth signal and a WiFi signal.

In some embodiments, the at least one processing structure analyzes images captured by the one or more imaging devices for determining a set of candidate tag devices for providing said at least one of the one or more tag measurements.

In some embodiments, the at least one processing structure analyzes images captured by the one or more imaging devices for selecting said at least one of the one or more tag measurements.

In some embodiments, each of the tag devices provides the at least one of the one or more tag measurements to the at least one processing structure only when said tag device receives from the at least one processing structure a request for providing the at least one of the one or more tag measurements.

In some embodiments, each of the tag devices, when receiving from the at least one processing structure a request for providing the at least one of the one or more tag measurements, only provides the requested the at least one of the one or more tag measurements to the at least one processing structure.

In some embodiments, the at least one processing structure identifies from the captured images one or more foreground feature clusters (FFCs) for tracking the at least one mobile object.

In some embodiments, the at least one processing structure determines a bounding box for each FFC.

In some embodiments, the at least one processing structure determines a tracking point for each FFC.

In some embodiments, for each FFC, the at least one processing structure determines a bounding box and a tracking point therefor, said tracking point being at a bottom edge of the bounding box.

In some embodiments, at least one processing structure associates each tag device with one of the FFCs.

In some embodiments, when associating a tag device with a FFC, the at least one processing structure calculates an FFC-tag association probability indicating the reliability of the association between the tag device and the FFC.

In some embodiments, said FFC-tag association probability is calculated based on a set of consecutively captured images.

In some embodiments, said FFC-tag association probability is calculated by finding a numerical approximation thereof.

In some embodiments, when associating a tag device with a FFC, the at least one processing structure executes a constrained optimization algorithm for minimizing the energy consumption of the one or more tag devices while maintaining the FFC-tag association probability above a target value.

In some embodiments, when associating a tag device with a FFC, the at least one processing structure calculates a tag-image correlation between the tag measurements and the analysis results of the captured images.

In some embodiments, when the tag measurements for calculating said tag-image correlation comprise measurement obtained from an IMU.

In some embodiments, when the tag measurements for calculating said tag-image correlation comprise measurements obtained from at least one of an accelerometer, a gyroscope and a magnetometer for calculating a correlation between the tag measurements and the analysis results of the captured images to determine whether a mobile object is changing its moving direction.

In some embodiments, the at least one processing structure maintains a background image for each of the one or more imaging devices.

In some embodiments, when detecting FFCs from each of the captured images, the at least one processing structure generates a difference image by calculating the difference between the captured image and the corresponding background image, and detects one or more FFCs from the difference image.

In some embodiments, when detecting one or more FFCs from the difference image, the at least one processing structure mitigates shadow from each of the one or more FFCs.

In some embodiments, after detecting the one or more FFCs, the at least one processing structure determines the location of each of the one or more FFCs in the captured image, and maps each of the one or more FFCs to a three-dimensional (3D) coordinate system of the site by using perspective mapping.

In some embodiments, the at least one processing structure stores a 3D map of the site for mapping each of the one or more FFCs to the 3D coordinate system of the site, and wherein in said map, the site includes one or more areas, and each of the one or more areas has a horizontal, planar floor.

In some embodiments, the at least one processing structure tracks at least one of the one or more FFCs based on the velocity thereof determined from the captured images.

In some embodiments, each FFC corresponds to a mobile object, and wherein the at least one processing structure tracks the FFCs using a first order Markov process.

In some embodiments, the at least one processing structure tracks the FFCs using a Kalman filter with a first order Markov Gaussian process.

In some embodiments, when tracking each of the FFCs, the at least one processing structure uses the coordinates of the corresponding mobile object in a 3D coordinate system of the site as state variables, and the coordinates of the FFC in a two dimensional (2D) coordinate system of the captured images as observations for the state variables, and wherein the at least one processing structure maps the coordinates of the corresponding mobile object in a 3D coordinate system of the site to the 2D coordinate system of the captured images.

In some embodiments, the at least one processing structure discretizes at least a portion of the site into a plurality of grid points, and wherein, when tracking a mobile object in said discretized portion of the site, the at least one processing structure uses said grid points for approximating the location of the mobile object.

In some embodiments, when tracking a mobile object in said discretized portion of the site, the at least one processing structure calculates a posterior position probability of the mobile object.

In some embodiments, the at least one processing structure identifies at least one mobile object from the captured images using biometric observation made from the captured images.

In some embodiments, the biometric observation comprise at least one of face characteristics and gait, and wherein the at least one processing structure makes the biometric observation using at least one of face recognition and gait recognition.

In some embodiments, at least a portion of the tag devices store a first ID for identifying the type of the associated mobile object.

In some embodiments, at least one of said tag devices is a smart phone.

In some embodiments, at least one of said tag devices comprises a microphone, and wherein the at least one processing structure uses tag measurement obtained from the microphone to detect at least one of room reverberation, background noise level and spectrum of noise, for establishing the FFC-tag association.

In some embodiments, at least one of said tag devices comprises a microphone, and wherein the at least one processing structure uses tag measurement obtained from the microphone to detect motion related sound, for establishing the FFC-tag association.

In some embodiments, said motion related sound comprises at least one of brushing of clothes against the microphone, sound of a wheeled object wheeling over a floor surface and sound of an object sliding on a floor surface.

In some embodiments, one or more first tag device broadcast an ultrasonic sound signature, and wherein at least a second tag device comprises a microphone for receiving and detecting the ultrasonic sound signature broadcast from said one or more first tag devices, for establishing the FFC-tag association.

In some embodiments, the one or more processing structures are processing structures of one or more computer servers.

According to another aspect of this disclosure, there is provided a method of tracking at least one mobile object in at least one visual field of view. The method comprises: capturing at least one image of the at least one visual field of view; identifying at least one candidate mobile object in the at least one image; obtaining one or more tag measurements from at least one tag device, each of said at least one tag device being associated with a mobile object and moveable therewith; and tracking at least one mobile object using the at least one image and the one or more tag measurements.

In some embodiments, the method further comprises: analyzing the at least one image for determining a set of candidate tag devices for providing said one or more tag measurements.

In some embodiments, the method further comprises: analyzing the at least one image for selecting said at least one of the one or more tag measurements.

In some embodiments, the method further comprises: identifying, from the at least one image, one or more foreground feature clusters (FFCs) for tracking the at least one mobile object, and determines a bounding box and a tracking point therefor, said tracking point being at a bottom edge of the bounding box.

In some embodiments, the method further comprises: associating each tag device with one of the FFCs.

In some embodiments, the method further comprises: calculating an FFC-tag association probability indicating the reliability of the association between the tag device and the FFC.

In some embodiments, the method further comprises: tracking the FFCs using a first order Markov process.

In some embodiments, the method further comprises: discretizing at least a portion of the site into a plurality of grid points; and tracking a mobile object in said discretized portion of the site by using said grid points for approximating the location of the mobile object.

According to another aspect of this disclosure, there is provided a non-transitory, computer readable storage device comprising computer-executable instructions for tracking at least one mobile object in a site, wherein the instructions, when executed, cause a first processor to perform actions comprising: capturing at least one image of the at least one visual field of view; identifying at least one candidate mobile object in the at least one image; obtaining one or more tag measurements from at least one tag device, each of said at least one tag device being associated with a mobile object and moveable therewith; and tracking at least one mobile object using the at least one image and the one or more tag measurements.

In some embodiments, the storage device further comprises computer-executable instructions, when executed, causing the one or more processing structure to perform actions comprising: calculating an FFC-tag association probability indicating the reliability of the association between the tag device and the FFC.

In some embodiments, the storage device further comprises computer-executable instructions, when executed, causing the one or more processing structure to perform actions comprising: analyzing the at least one image for selecting said at least one of the one or more tag measurements.

In some embodiments, the storage device further comprises computer-executable instructions, when executed, causing the one or more processing structure to perform actions comprising: identifying, from the at least one image, one or more foreground feature clusters (FFCs) for tracking the at least one mobile object, and determines a bounding box and a tracking point therefor, said tracking point being at a bottom edge of the bounding box.

In some embodiments, the storage device further comprises computer-executable instructions, when executed, causing the one or more processing structure to perform actions comprising: associating each tag device with one of the FFCs.

In some embodiments, the storage device further comprises computer-executable instructions, when executed, causing the one or more processing structure to perform actions comprising: calculating an FFC-tag association probability indicating the reliability of the association between the tag device and the FFC.

In some embodiments, the storage device further comprises computer-executable instructions, when executed, causing the one or more processing structure to perform actions comprising: discretizing at least a portion of the site into a plurality of grid points; and tracking a mobile object in said discretized portion of the site by using said grid points for approximating the location of the mobile object.

According to another aspect of this disclosure, there is provided a system for tracking at least one mobile object in a site. The system comprises: at least a first imaging device having a field of view (FOV) overlapping a first subarea of the site and capturing images of at least a portion of the first subarea, the first subarea having at least a first entrance; and one or more tag devices, each of the one or more tag devices being associated with one of the at least one mobile object and moveable therewith, each of the one or more tag devices having one or more sensors for obtaining one or more tag measurements related to the mobile object associated therewith; and at least one processing structure for: determining one or more initial conditions of the at least one mobile object entering the first subarea from the at least first entrance; and combining the one or more initial conditions, the captured images, and at least one of the one or more tag measurements for tracking the at least one mobile object.

In some embodiments, the at least one processing structure builds a birds-eye view based on a map of the site, for mapping the at least one mobile object therein.

In some embodiments, said one or more initial conditions comprise data determined from one or more tag measurements regarding the at least one mobile object before the at least one mobile object enters the first subarea from the at least first entrance.

In some embodiments, the system further comprises: at least a second imaging device having an FOV overlapping a second subarea of the site and capturing images of at least a portion of the second subarea, the first and second subareas sharing the at least first entrance; and wherein the one or more initial conditions comprise data determined from the at least second imaging device regarding the at least one mobile object before the at least one mobile object enters the first subarea from the at least first entrance.

In some embodiments, the first subarea comprises at least one obstruction in the FOV of the at least first imaging device; and wherein the at least one processing structure uses a statistic model based estimation for resolving ambiguity during tracking when the at least one mobile object temporarily moves behind the obstruction.

According to another aspect of this disclosure, there is provided a method for tracking at least one mobile object in a site. The method comprises: obtaining a plurality of images captured by at least a first imaging device having a field of view (FOV) overlapping a first subarea of the site, the first subarea having at least a first entrance; obtaining tag measurements from one or more tag devices, each of the one or more tag devices being associated with one of the at least one mobile object and moveable therewith, each of the one or more tag devices having one or more sensors for obtaining one or more tag measurements related to the mobile object associated therewith; determining one or more initial conditions of the at least one mobile object entering the first subarea from the at least first entrance; and combining the one or more initial conditions, the captured images, and at least one of the one or more tag measurements for tracking the at least one mobile object.

In some embodiments, the method further comprises: building a birds-eye view based on a map of the site, for mapping the at least one mobile object therein.

In some embodiments, the method further comprises: assembling said one or more initial conditions using data determined from one or more tag measurements regarding the at least one mobile object before the at least one mobile object enters the first subarea from the at least first entrance.

In some embodiments, the method further comprises: obtaining images captured by at least a second imaging device having an FOV overlapping a second subarea of the site, the first and second subareas sharing the at least first entrance; and assembling the one or more initial conditions using data determined from the at least second imaging device regarding the at least one mobile object before the at least one mobile object enters the first subarea from the at least first entrance.

In some embodiments, the first subarea comprises at least one obstruction in the FOV of the at least first imaging device; and the method further comprises: using a statistic model based estimation for resolving ambiguity during tracking when the at least one mobile object temporarily moves behind the obstruction.

According to another aspect of this disclosure, there is provided one or more non-transitory, computer readable media storing computer executable code for tracking at least one mobile object in a site. The computer executable code comprises computer executable instructions for: obtaining a plurality of images captured by at least a first imaging device having a field of view (FOV) overlapping a first subarea of the site, the first subarea having walls and at least a first entrance; obtaining tag measurements from one or more tag devices, each of the one or more tag devices being associated with one of the at least one mobile object and moveable therewith, each of the one or more tag devices having one or more sensors for obtaining one or more tag measurements related to the mobile object associated therewith; determining one or more initial conditions of the at least one mobile object entering the first subarea from the at least first entrance; and combining the one or more initial conditions, the captured images, and at least one of the one or more tag measurements for tracking the at least one mobile object.

In some embodiments, the computer executable code further comprises computer executable instructions for: building a birds-eye view based on a map of the site, for mapping the at least one mobile object therein.

In some embodiments, the computer executable code further comprises computer executable instructions for: assembling said one or more initial conditions using data determined from one or more tag measurements regarding the at least one mobile object before the at least one mobile object enters the first subarea from the at least first entrance.

In some embodiments, the computer executable code further comprises computer executable instructions for: obtaining images captured by at least a second imaging device having an FOV overlapping a second subarea of the site, the first and second subareas sharing the at least first entrance; and assembling the one or more initial conditions using data determined from the at least second imaging device regarding the at least one mobile object before the at least one mobile object enters the first subarea from the at least first entrance.

In some embodiments, the first subarea comprises at least one obstruction in the FOV of the at least first imaging device; and wherein the computer executable code further comprises computer executable instructions for: using a statistic model based estimation for resolving ambiguity during tracking when the at least one mobile object temporarily moves behind the obstruction.

### BRIEF DESCRIPTION OF THE DRAWINGS

FIG. 1 is a schematic diagram showing an object tracking system deployed in a site, according to one embodiment;

FIG. 2 is a schematic diagram showing the functional structure of the object tracking system of FIG. 1;

FIG. 3 shows a foreground feature cluster (FFC) detected in a captured image;

FIG. 4 is a schematic diagram showing the main function blocks of the system of FIG. 1 and the data flow therebetween;

FIGS. 5A and 5B illustrate connected flowcharts showing steps of a process of tracking mobile objects using a vision assisted hybrid location algorithm;

FIGS. 6A to 6D show steps of an example of establishing and tracking an FFC-tag association following the process of FIGS. 5A and 5B;

FIG. 7 is a schematic diagram showing the main function blocks of the system of FIG. 1 and the data flows therebetween, according to an alternative embodiment;

FIG. 8 is a flowchart showing the detail of FFC detection, according to one embodiment;

FIGS. 9A to 9F show a visual representation of steps in an example of FFC detection;

FIG. 10 shows a visual representation of an example of a difference image wherein the mobile object captured therein has a shadow;

FIG. 11A is a three-dimensional (3D) perspective view of a portion of a site;

FIG. 11B is a plan view of the site portion of FIG. 11A;

FIGS. 11C and 11D show the partition of the site portion of FIGS. 11B and 11A, respectively;

FIGS. 11E and 11F show the calibration processing for establishing perspective mapping between the site portion of FIG. 11A and captured images;

FIG. 12A shows a captured image of the site portion of FIG. 11A, the captured image having an FFC of a person detected therein;

FIG. 12B is a plan view of the site portion of FIG. 11A with the FFC of FIG. 12A mapped thereto;

FIG. 12C shows a sitemap having the site portion of FIG. 11A and the FFC of FIG. 12A mapped thereto;

FIG. 13 shows a plot of the x-axis position of a bounding box tracking point (BBTP) of an FFC in captured images, wherein the vertical axis represents the BBTP's x-axis position (in pixel) in captured images, and the horizontal axis represents the image frame index;

FIG. 14 is a flowchart showing the detail of mobile object tracking using an extended Kalman filter (EKF);

FIG. 15A shows an example of two imaging devices CA and CB with overlapping field of view (FOV) covering an L-shaped room;

FIG. 15B shows a grid partitioning of the room of FIG. 15A;

FIG. 16A shows an imaginary, one-dimensional room partitioned to six grid points;

FIG. 16B is a state diagram for the imaginary room of FIG. 16A;

FIGS. 17A and 17B are graphs for a deterministic example, where a mobile object is moving left to right along the x-axis in the FOV of an imaging device, wherein FIG. 17A is a state transition diagram, and FIG. 17B shows a graph of simulation results;

FIGS. 18A to 18C show another example, where a mobile object is slewing to the right hand side along the x-axis in the FOV of an imaging device, wherein FIG. 18A is a state transition diagram, and FIGS. 18B and 18C are graphs of simulation results of the mean and the standard deviation (STD) of x- and y-coordinates of the mobile object, respectively;

FIG. 19 is a schematic diagram showing the data flow for determining a state transition matrix;

FIGS. 20A to 20E show visual representation of an example of merging/occlusion of two mobile objects;

FIGS. 21A to 21E show visual representation of an example that a mobile object is occluded by a background object;

FIG. 22 shows a portion of the functional structure of a Visual Assisted Indoor Location System (VAILS), according to an alternative embodiment, the portion shown in FIG. 22 corresponding to the computer cloud of FIG. 2;

FIG. 23 is a schematic diagram showing the association of a blob in a camera view, a BV object in a birds-eye view of the site and a tag device;

FIG. 24 is a schematic illustration of an example site, which is divided into a number of rooms, with entrances/exits connecting the rooms;

FIG. 25 is a schematic illustration showing a mobile object entering a room and moving therein;

FIG. 26 is a schematic diagram showing data flow between the imaging device, camera view processing submodule, internal blob track file (IBTF), birds-eye view processing submodule, network arbitrator, external blob track file (EBTF) and object track file (OTF);

FIGS. 27A to 27D are schematic illustrations showing possibilities that may cause ambiguity;

FIG. 28 is a schematic illustration showing an example, in which a tagged mobile object moves in a room from a first entrance on the left-hand side of the room to the right-hand side thereof towards a second entrance, and an untagged object moves in the room from the second entrance on the right-hand side of the room to the left-hand side thereof towards the first entrance;

FIG. 29 is a schematic diagram showing the relationship between the IBTF, EBTF, OTF, Tag Observable File (TOF) for storing tag observations, network arbitrator and tag devices;

FIG. 30 is a schematic diagram showing information flow between camera views, birds-eye view and tag devices;

FIG. 31 is a more detailed version of FIG. 30, showing information flow between camera views, birds-eye view and tag devices, and the function of the network arbitrator in the information flow;

FIG. 32A shows an example of a type 3 blob having a plurality of sub-blobs;

FIG. 32B is a diagram showing the relationship of the type 3 blob and its sub-blobs of FIG. 32A;

FIG. 33 shows a timeline history diagram of a life span of a blob from its creation event to its annihilation event;

FIG. 34 shows a timeline history diagram of the blobs of FIG. 28;

FIG. 35A shows an example of a type 6 blob merged from two blobs;

FIG. 35B is a diagram showing the relationship of the type 6 blob and its sub-blobs of FIG. 35A;

FIG. 36A is a schematic illustration showing two tagged objects simultaneously entering a room from a same entrance and moving therein;

FIG. 36B shows a timeline history diagram of a life span of a blob from its creation event to its annihilation event, for tracking two tagged objects simultaneously entering a room from a same entrance and moving therein with different speeds;

FIG. 37A is a schematic illustration showing an example wherein a blob is split to two sub-blobs;

FIG. 37B is a schematic illustration showing an example wherein a person enters a room, moves therein, and later pushes a cart to exit the room;

FIG. 37C is a schematic illustration showing an example wherein a person enters a room, moves therein, sits down for a while, and then moves out of the room;

FIG. 37D is a schematic illustration showing an example wherein a person enters a room, moves therein, sits down for a while at a location already having two person sitting, and then moves out of the room;

FIG. 38 is a table listing the object activities and the performances of the network arbitrator, camera view processing and tag devices that may be triggered by the corresponding object activities;

FIGS. 39A and 39B show two consecutive image frames, each having detected blobs;

FIG. 39C shows the maximum correlation of image frames of FIGS. 39A and 39B;

FIG. 40 shows an image frame having two blobs;

FIG. 41A is a schematic illustration showing an example wherein a mobile object is moving in a room and is occluded by an obstruction therein;

FIG. 41B is a schematic diagram showing data flow in tracking the mobile object of FIG. 41A;

FIG. 42 shows a timeline history diagram of the blobs of FIG. 41A;

FIG. 43 shows an alternative possibility that may give rise to same camera view observations of FIG. 41A;

FIG. 44 shows an example of a blob with a BBTP ambiguity region determined by the system;

FIGS. 45A and 45B show a BBTP in the camera view and mapped into the birds-eye view, respectively;

FIGS. 46A and 46B show an example of an ambiguity region of a BBTP (not shown) in the camera view and mapped into the birds-eye view, respectively;

FIG. 47 shows a simulation configuration having an imaging device and an obstruction in the FOV of the imaging device;

FIG. 48 shows the results of the DBN prediction of FIG. 47 without velocity feedback;

FIG. 49 shows the prediction likelihood over time in tracking the mobile object of FIG. 47 without velocity feedback;

FIG. 50 shows the results of the DBN prediction in tracking the mobile object of FIG. 47 with velocity feedback;

FIG. 51 shows the prediction likelihood over time in tracking the mobile object of FIG. 47 with velocity feedback;

FIGS. 52A to 52C show another example of a simulation configuration, the simulated prediction likelihood without velocity feedback, and the simulated prediction likelihood with velocity feedback, respectively;

FIG. 53A shows a simulation configuration for simulating the tracking of a first mobile object (not shown) with an interference object nearby the trajectory of the first mobile object and an obstruction between the imaging device and the trajectory;

FIG. 53B shows the prediction likelihood of FIG. 53A;

FIGS. 54A and 54B show another simulation example of tracking a first mobile object (not shown) with an interference object nearby the trajectory of the first mobile object and an obstruction between the imaging device and the trajectory;

FIG. 55 shows the initial condition flow and the output of the network arbitrator;

FIG. 56 is a schematic illustration showing an example wherein two mobile object moves across a room but the imaging device therein reports only one mobile object exiting from an entrance on the right-hand side of the room;

FIG. 57 shows another example, wherein the network arbitrator may delay the choice among candidate routes if the likelihoods of candidate routes are still high, and make a choice when one candidate route exhibits sufficiently high likelihood;

FIG. 58A is a schematic illustration showing an example wherein a mobile object moves across a room;

FIG. 58B is a schematic diagram showing the initial condition flow and the output of the network arbitrator in a mobile object tracking example of FIG. 58A;

FIG. 59 is a schematic illustration showing an example wherein a tagged object is occluded by an untagged object;

FIG. 60 shows the relationship between the camera view processing submodule, birds-eye view processing submodule, and the network arbitrator/tag devices;

FIG. 61 shows a 3D simulation of a room having an indentation representing a portion of the room that is inaccessible to any mobile objects;

FIG. 62 shows the prediction probability based on arbitrary building wall constraints of FIG. 61, after sufficient number of iterations to approximate a steady state;

FIGS. 63A and 63B show a portion of the MATLAB® code used in a simulation;

FIG. 64 shows a portion of the MATLAB® code for generating a Gaussian shaped likelihood kernel;

FIGS. 65A to 65C show the plotting of the initial probability subject to the site map wall regions, the measurement probability kernel, and the probability after the measurement likelihood has been applied, respectively;

FIG. 66 shows a steady state distribution reached in a simulation;

FIGS. 67A to 67D show the mapping between a world coordinate system and a camera coordinate system;

FIG. 68A is an original picture used in a simulation;

FIG. 68B is an image of the picture of FIG. 68A captured by an imaging device;

FIG. 69 show a portion of MATLAB® code for correcting the distortion in FIG. 68B; and

FIG. 70 shows the distortion-corrected image of FIG. 68B.

### DETAILED DESCRIPTION

### Glossary

Global Positioning System (GPS)

Doppler Orbitography and Radio-positioning Integrated by Satellite (DORIS)

Bluetooth® Low Energy (BLE)

foreground feature clusters (FFCs)

field of view (FOV)

Inertial Measurement Unit (IMU)

a global navigation satellite system (GNSS),

a receiver signal strength (RSS)

two dimensional (2D)

three-dimensional (3D)

bounding box tracking point (BBTP)

Kalman filter (EKF)

standard deviation (STD)

Visual Assisted Indoor Location System (VAILS)

internal blob track file (IBTF),

external blob track file (EBTF)

object track file (OTF)

Tag Observable File (TOF)

central processing units (CPUs)

input/output (I/O)

frames per second (fps)

personal data assistant (PDA)

universally unique identifier (UUID)

security camera system (SCS)

Radio-frequency identification (RFID)

probability density function (PDF)

mixture of gaussians (MoG) model

singular value decomposition (SVD)

access point (AP)

standard deviation (STD) of x- and y-coordinates of the mobile object, denoted as STDx and STDy

a birds-eye view (BV)

camera view processing and birds-eye view processing (CV/BV)

camera view (CV) objects

birds-eye view (CV) objects

object track file (OTF)

In the following, a method and system for tracking mobile objects in a site are disclosed. The system comprises one or more computer servers, e.g., a so-called computer cloud, communicating with one or more imaging devices and one or more tag devices. Each tag device is attached to a mobile object, and has one or more sensors for sensing the motion of the mobile object. The computer cloud visually tracks mobile objects in the site using image streams captured by the imaging devices, and uses measurements obtained from tag devices to resolve ambiguity occurred in mobile object tracking. The computer cloud uses an optimization method to reduce power consumption of tag devices.

System Overview

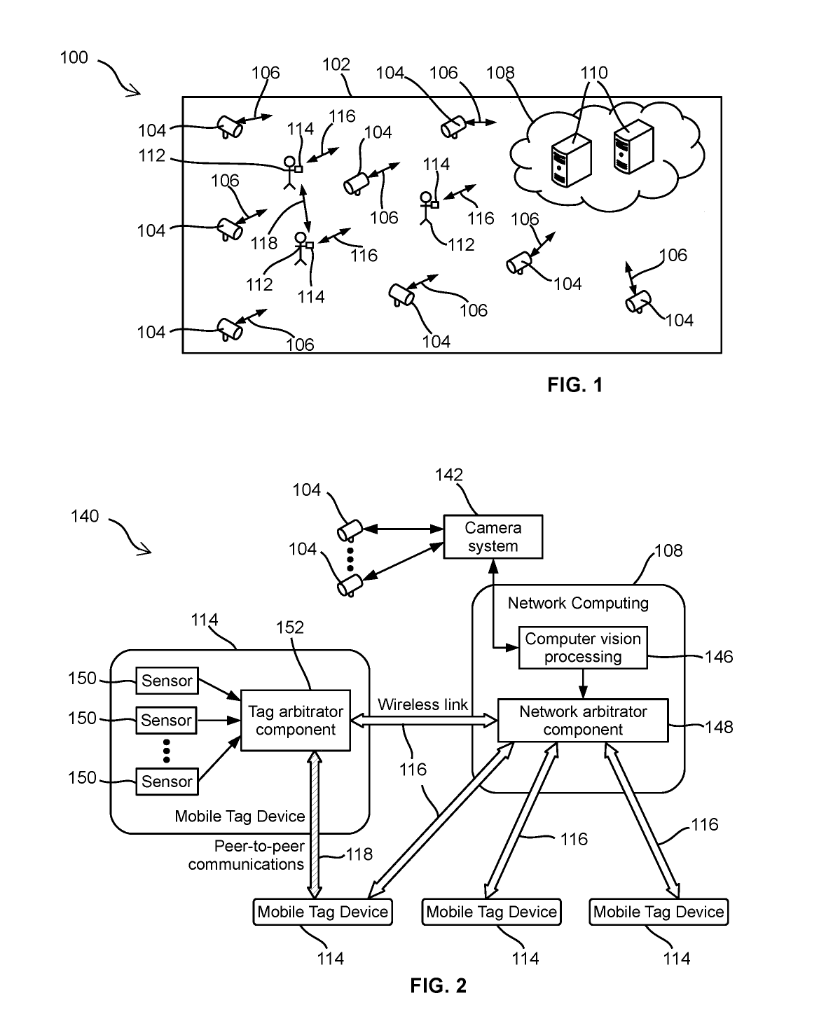

Turning to FIG. 1, an object tracking system is shown, and is generally identified using numeral 100. The object tracking system 100 comprises one or more imaging devices 104, e.g., security cameras or other camera devices, deployed in a site 102, such as a campus, a building, a shopping center or the like. Each imaging device 104 is communicated with a computer network or cloud 108 via suitable wired communication means 106, such as Ethernet, serial cable, parallel cable, USB cable, HDMI® cable or the like, and/or via suitable wireless communication means such as Wi-Fi®, Bluetooth®, ZigBee®, 3G or 4G wireless telecommunications or the like. In this embodiment, the computer cloud 108 is also deployed in the site 102, and comprises one or more server computers 110 interconnected via necessary communication infrastructure.

One or more mobile objects 112, e.g., one or more persons, enter the site 102, and may move to different locations therein. From time to time, some mobile objects 112 may be moving, and some other mobile objects 112 may be stationary. Each mobile object 112 is associated with a tag device 114 movable therewith. Each tag device 114 communicates with the computer cloud 108 via suitable wireless communication means 116, such as Wi-Fi®, Bluetooth®, ZigBee®, 3G or 4G wireless telecommunications, or the like. The tag devices 114 may also communicate with other nearby tag devices using suitable peer-to-peer wireless communication means 118. Some mobile objects may not have a tag device associated therewith, and such objects cannot benefit fully from the embodiments disclosed herein.

The computer cloud 108 comprises one or more server computers 110 connected via suitable wired communication means 106. As those skilled in the art understand, the server computers 110 may be any computing devices suitable for acting as servers. Typically, a server computer may comprise one or more processing structures such as one or more single-core or multiple-core central processing units (CPUs), memory, input/output (I/O) interfaces including suitable wired or wireless networking interfaces, and control circuits connecting various computer components. The CPUs may be, e.g., Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like. The memory may be volatile and/or non-volatile, non-removable or removable memory such as RAM, ROM, EEPROM, solid-state memory, hard disks, CD, DVD, solid-state memory, flash memory, or the like. The networking interfaces may be wired networking interfaces such as Ethernet interfaces, or wireless networking interfaces such as WiFi®, Bluetooth®, 3G or 4G mobile telecommunication, ZigBee®, or the like. In some embodiments, parallel ports, serial ports, USB connections may also be used for networking although they are usually considered as input/output interfaces for connecting input/output devices. The I/O interfaces may also comprise keyboards, computer mice, monitors, speakers and the like.

The imaging devices 104 are usually deployed in the site 102 covering most or all of the common traffic areas thereof, and/or other areas of interest. The imaging devices 104 capture images of the site 102 in their respective field of views (FOVs). Images captured by each imaging device 104 may comprise the images of one or more mobile objects 112 within the FOV thereof.

Each captured image is sometimes called an image frame. Each imaging device 104 captures images or image frames at a designated frame rate, e.g., in some embodiments, 30 frames per second (fps), i.e., capturing 30 images per second. Of course, those skilled in the art understand that the imaging devices may capture image streams at other frame rates. The frame rate of an imaging device may be a predefined frame rate, or a frame rate adaptively designated by the computer cloud 108. In some embodiments, all imaging devices have the same frame rate. In some other embodiments, imaging devices may have different frame rate.

As the frame rate of each imaging device is known, each image frame is thus captured at a known time instant, and the time interval between each pair of consecutively captured image frames is also known. As will be described in more detail later, the computer cloud 108 analyses captured image frames to detect and track mobile objects. In some embodiments, the computer cloud 108 detects and tracks mobile objects in the FOV of each imaging device by individual analyzing each image frame captured therefrom (i.e., without using historical image frames). In some alternative embodiments, the computer cloud 108 detects and tracks mobile objects in the FOV of each imaging device by analyzing a set of consecutively captured images, including the most recently captured image and a plurality of previously consecutively captured images. In some other embodiments, the computer cloud 108 may combine image frames captured by a plurality of imaging devices for detecting and tracking mobile objects.

Ambiguity may occur during visual tracking of mobile objects. Ambiguity is a well-known issue in visual object tracking, and includes a variety of situations that cause visual object tracking less reliable or even unreliable.

Ambiguity may occur in a single imaging device capturing images of a single mobile object. For example, in a series of images captured by an imaging device, a mobile object is detected moving towards a bush, disappeared and then appearing from the opposite side of the bush. Ambiguity may occur as it may be uncertain whether the images captured a mobile object passing the bush from behind, or the images captured a first mobile object moved behind the bush and stayed therebehind, and then a second mobile object previously staying behind the bush now moved out thereof.

Ambiguity may occur in a single imaging device capturing images of multiple mobile objects. For example, in a series of image frames captured by an imaging device, two mobile objects are detected moving towards each other, merging to one object, and then separating to two objects again and moving apart from each other. Ambiguity occurs in this situation as it may be uncertain whether the two mobile objects are crossing each other or the two mobile objects are moving towards each other to a meeting point (appearing in the captured images as one object), and then turning back to their respective coming directions.

Ambiguity may occur across multiple imaging devices. For example, in images captured by a first imaging device, a mobile object moves and disappears from the field of view (FOV) of the first imaging device. Then, in images captured by a second, neighboring imaging device, a mobile object appears in the FOV thereof. Ambiguity may occur in this situation as it may be uncertain whether it was a same mobile object moving from the FOV of the first imaging device into that of the second imaging device, or a first mobile object moved out of the FOV the first imaging device and a second mobile object moved into of the FOV the second imaging device.

Other types of ambiguity in visual object tracking are also possible. For example, when determining the location of a mobile object in the site 102 based on the location of the mobile object in a captured image, ambiguity may occur as the determined location may not have sufficient precision required by the system.

In embodiments disclosed herein, when ambiguity occurs, the system uses tag measurements obtain from tag devices to associate objects detected in captured images and the tag devices for resolving the ambiguity.

Each tag device 114 is a small, battery-operated electronic device, which in some embodiments, may be a device designed specifically for mobile object tracking, or alternatively may be a multi-purpose mobile device suitable for mobile device tracking, e.g., a smartphone, a tablet, a smart watch and the like. Moreover, in some alternative embodiments, some tag devices may be integrated with the corresponding mobile objects such as carts, wheelchairs, robots and the like.

Each tag device comprises a processing structure, one or more sensors and necessary circuit connecting the sensors to the processing structure. The processing structure controls the sensors to collect data, also called tag measurements or tag observations, and establishes communication with the computer cloud 108. In some embodiments, the processing structure may also establish peer-to-peer communication with other tag devices 114. Each tag device also comprises a unique identification code, which is used by the computer cloud 108 for uniquely identifying the tag devices 114 in the site 102.

In different embodiments, the tag device 114 may comprise one or more sensors for collecting tag measurements regarding the mobile object 112. The number and types of sensors used in each embodiment depend on the design target thereof, and may be selected by the system designer as needed and/or desired. The sensors may include, but not limited to, an inertial Measurement Unit (IMU) having accelerometers and/or gyroscopes (e.g., rate gyros) for motion detection, a barometer for measuring atmospheric pressure, a thermometer for measuring temperature external to the tag 114, a magnetometer, a global navigation satellite system (GNSS) sensor, e.g., a Global Positioning System (GPS) receiver, an audio frequency microphone, a light sensor, a camera, and an RSS measurement sensors for measuring the signal strength of a received wireless signal.

An RSS measurement sensor is a sensor for measuring the signal strength of a received wireless signal received from a transmitter, for estimating the distance from the transmitter. The RSS measurement may be useful for estimating the location of a tag device 114. As described above, a tag device 114 may communicate with other nearby tag devices 114 using peer-to-peer communications 118. For example, some tag devices 114 may comprise a short-distance communication device such as a Bluetooth® Low Energy (BLE) device. Examples of BLE devices include transceivers using the iBeacon™ technology specified by Apple Inc. of Cupertino, Calif., U.S.A. or using Samsung's Proximity™ technology. As those skilled in the art understand, a BLE device broadcasts a BLE signal (so-called BLE beacon), and/or receives BLE beacons transmitted from nearby BLE devices. A BLE device may be a mobile device such as a tag device 114, a smartphone, a tablet, a laptop, a personal data assistant (PDA) or the like that uses a BLE technology. A BLE device may also be a stationary device such as a BLE transmitter deployed in the site 102.

A BLE device may detect BLE beacons transmitted from nearby BLE devices, determine their identities using the information embedded in the BLE beacons, and establish peer-to-peer link therewith. A BLE beacon usually includes a universally unique identifier (UUID), a Major ID and a Minor ID. The UUID generally represents a group, e.g., an organization, a firm, a company or the like, and is the same for all BLE devices in a same group. The Major ID represents a subgroup, e.g., a store of a retail company, and is the same for all BLE devices in a same subgroup. The Minor ID represents the BLE device in a subgroup. The combination of the UUID, Major ID and Minor ID, i.e., (UUID, Major ID, Minor ID), then uniquely determines the identity of the BLE device.

The short-distance communication device may comprise sensors for wireless receiver signal strength (RSS) measurement, e.g., Bluetooth® RSS measurement. As those skilled in the art appreciate, a BLE beacon may further include a reference transmit signal power indicator. Therefore, a tag device 114, when detects a BLE beacon broadcast from a nearby transmitter BLE device (which may be a nearby tag device 114 or a different BLE device such as a BLE transmitter deployed in the site 102), may measure the received signal power of the BLE beacon obtaining a RSS measurement, and compare the RSS measurement with the reference transmit signal power embedded in the BLE beacon to estimate the distance from the transmitter BLE device.

The system 100 therefore may use the RSS measurement obtained by a target tag device regarding the BLE beacon of a transmitter BLE device to determine that two mobile objects 112 are in close proximity such as two persons in contact, conversing, or the like (if the transmitter BLE device is another tag device 114), or to estimate the location of the mobile object 112 associated with the target tag device (if the transmitter BLE device is a BLE transmitter deployed at a known location), which may be used to facilitate the detection and tracking of the mobile object 112.

Alternatively, in some embodiments, the system may comprise a map of the site 102 indicative of the transmitter signal strength of a plurality of wireless signal transmitters, e.g., Bluetooth and/or WiFi access points, deployed at known locations of the site 102. The system 100 may use this wireless signal strength map and compare with the RSS measurement of a tag device 114 to estimate the location of the tag device 114. In these embodiments, the wireless signal transmitters do not need to include a reference transmit signal power indicator in the beacon.

The computer cloud 108 tracks the mobile objects 112 using information obtained from images captured by the one or more imaging devices 104 and from the above-mentioned sensor data of the tag devices 114. In particular, the computer cloud 108 detects foreground objects or foreground feature clusters (FFCs) from images captured by the imaging devices 104 using image processing technologies.

Herein, the imaging devices 104 are located at fixed locations in the site 102, generally oriented toward a fixed direction (except that in some embodiments an imaging device may occasionally pan to a different direction), and focused, to provide a reasonably static background. Moreover, the lighting in the FOV of each imaging device is generally unchanged for the time intervals of interest, or the lighting changing slowly that it may be considered unchanged among a finite number of consecutively captured images. Generally, the computer cloud 108 maintains a background image for each imaging device 104, which typically comprising image of permanent features of the site such as floor, ceiling, walls and the like, and semi-permanent structures such as furniture, plants, trees and the like. The computer cloud 108 periodically updates the background images.

Mobile objects, being moving or stationary, generally appear in the captured images as foreground objects or FFCs that occlude the background. Each FFC is an identified area in the captured images corresponding to a moving object that may be associated with a tag device 114. Each FFC is bounded by a bounding box. A mobile object being stationary for an extended period of time, however, may become a part of the background and undetectable from the captured images.

The computer cloud 108 associates detected FFCs with tag devices 114 using the information of the captured images and information received from the tag devices 114, for example, both evidencing motion of 1 meter per second. As each tag device 114 is associated with a mobile object 112, an FFC successfully associated with a tag device 114 is then considered an identified mobile object 112, and is tracked in the site 102.

Obviously, there may exist mobile objects in the site 102 but not associated with any tag device 114, which cannot be identified. Such unidentified mobile objects may be robots, animals, or may be people without a tag device. In this embodiment, unidentified mobile objects are ignored by the computer cloud 108. However, those skilled in the art appreciate that, alternatively, the unidentified mobile objects may also be tracked, to some extent, solely by using images captured by the one or more imaging devices 104.

FIG. 2 is a schematic diagram showing the functional structure 140 of the object tracking system 100. As shown, the computer cloud 108 functionally comprises a computer vision processing structure 146 and a network arbitrator component 148. Each tag device 114 functionally comprises one or more sensors 150 and a tag arbitrator component 152.

The network arbitrator component 148 and the tag arbitrator component 152 are the central components of the system 100 as they “arbitrate” the observations to be done by the tag device 114. The network arbitrator component 148 is a master component and the tag arbitrator components 152 are slave components. Multiple tag arbitrator components 152 may communicate with the network arbitrator component 148 at the same time and observations therefrom may be jointly processed by the network arbitrator component 148.

The network arbitrator component 148 manages all tag devices 114 in the site 102. When a mobile object 112 having a tag device 114 enters the site 102, the tag arbitrator component 152 of the tag device 114 automatically establishes communication with the network arbitrator component 148 of the computer cloud 108, via a so called “handshaking” process. With handshaking, the tag arbitrator component 152 communicates its unique identification code to the network arbitrator component 148. The network arbitrator component 148 registers the tag device 114 in a tag device registration table (e.g., a table in a database), and communicates with the tag arbitrator component 152 of the tag device 114 to understand what types of tag measurements can be provided by the tag device 114 and how much energy each tag measurement will consume.

During mobile object tracking, the network arbitrator component 148 maintains communication with the tag arbitrator components 152 of all tag devices 114, and may request one or more tag arbitrator component 152 to provide one or more tag measurements. The tag measurements that a tag device 114 can provide depend on the sensors installed in the tag device. For example, accelerometers have an output triggered by magnitude of change of acceleration, which can be used for sensing the moving of the tag device 114. The accelerometer and rate gyro can provide motion measurement of the tag device 114 or the mobile object 112 associated therewith. The barometer may provide air pressure measurement indicative of the elevation of the tag device 114.

With the information of each tag device 114 obtained during handshaking, the network arbitrator component 148 can dynamically determine, which tag devices and what tag measurements therefrom are needed to facilitate mobile object tracking with minimum power consumption incurred to the tag devices (described in more detail later).

When the network arbitrator component 148 is no longer able to communicate with the tag arbitrator component 152 of a tag device 114 for a predefined period of time, the network arbitrator component 148 considers that the tag device 114 has left the site 102 or has been deactivated or turned off. The network arbitrator component 148 then deletes the tag device 114 from the tag device registration table.

Shown in FIG. 2, a camera system 142 such as a security camera system (SCS) controls the one or more imaging devices 104, collects images captured by the imaging devices 104, and sends captured images to the computer vision processing structure 146.

The computer vision processing structure 146 processes the received images for detecting FFCs therein. Generally, the computer vision processing structure 146 maintains a background image for each imaging device 104. When an image captured by an imaging device 104 is sent to the computer vision processing structure 146, the computer vision processing structure 146 calculates the difference between the received image and the stored background image to obtain a difference image. With suitable image processing technology, the computer vision processing structure 146 detects the FFCs from the difference image. In this embodiment, the computer vision processing structure 146 periodically updates the background image to adapt to the change of the background environment, e.g., the illumination change from time to time.

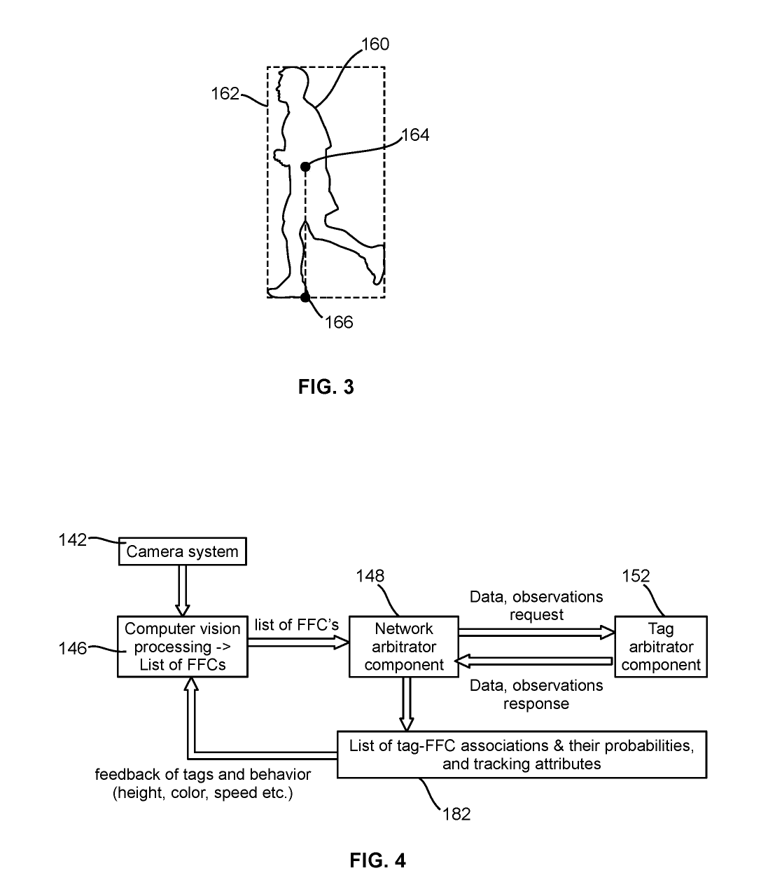

FIG. 3 shows an FFC 160 detected in a captured image. As shown, a bounding box 162 is created around the extremes of the blob of the FFC 160. In this embodiment, the bounding box is a rectangular bounding box, and is used in image analysis unless detail, e.g., color, pose and other features, of the FFC is required.

A centroid 164 of FFC 160 is determined. Here, the centroid 164 is not necessarily the center of the bounding box 162.

A bounding box tracking point (BBTP) 166 is determined at a location on the lower edge of the bounding box 162 such that a virtual line between the centroid 164 and the BBTP 166 is perpendicular to the lower edge of the bounding box 162. The BBTP 166 is used for determining the location of the FFC 160 (more precisely the mobile object represented by FFC 160) in the site 102. In some alternative embodiments, both the centroid 164 and the BBTP 166 are used for determining the location of the FFC 160 in the site 102.

In some embodiments, the outline of the FFC 160 may be reduced to a small set of features based on posture to determine, e.g., if the corresponding mobile object 112 is standing or walking. Moreover, analysis of the FFC 160 detected over a group of sequentially captured images may show that the FFC 160 is walking and may further provide an estimate of the gait frequency. As will be described in more detail later, a tag-image correlation between the tag measurements, e.g., gait frequency obtained by tag devices, and the analysis results of the captured images may be calculated for establishing FFC-tag association.

The computer vision processing structure 146 sends detected FFCs to the network arbitrator component 148. The network arbitrator component 148 associate the detected FFCs with tag devices 114, and, if needed, communicates with the tag arbitrator components 152 of the tag devices 114 to obtain tag measurements therefrom for facilitating FFC-tag association.

The tag arbitrator component 152 of a tag device 114 may communicate with the tag arbitrator components 152 of other nearby tag devices 114 using peer-to-peer communications 118.

FIG. 4 is a schematic diagram showing the main function blocks of the system 100 and the data flows therebetween. As shown, the camera system 142 feeds images captured by the cameras 104 in the site 102 into the computer vision processing block 146. The computer vision processing block 146 processes the images received from the camera system 142 such as necessary filtering, image corrections and the like, and isolates or detects a set of FFCs in the images that may be associated with tag devices 114.

The set of FFCs and their associated bounding boxes are then sent to the network arbitrator component 148. The network arbitrator component 148 analyzes the FFCs and may request the tag arbitrator components 152 of one or more tag devices 114 to report tag measurements for facilitating FFC-tag association.

Upon receiving a request from the network arbitrator component 148, the tag arbitrator component 152 in response makes necessary tag measurements from the sensors 150 of the tag device 114, and sends tag measurements to the network arbitrator component 148. The network arbitrator component 148 uses received tag measurements to establish the association between the FFCs and the tag devices 114. Each FFC associated with a tag device 114 is considered as an identified mobile object 112 and is tracked by the system 100.

The network arbitrator component 148 stores each FFC-tag association and an association probability thereof (FFC-tag association probability, described later) in a tracking table 182 (e.g., a table in a database). The tracking table 182 is updated every frame as required.

Data of FFC-tag associations in the tracking table 182, such as the height, color, speed and other feasible characteristics of the FFCs, is fed back to the computer vision processing block 146 for facilitating the computer vision processing block 146 to better detect the FFC in subsequent images.

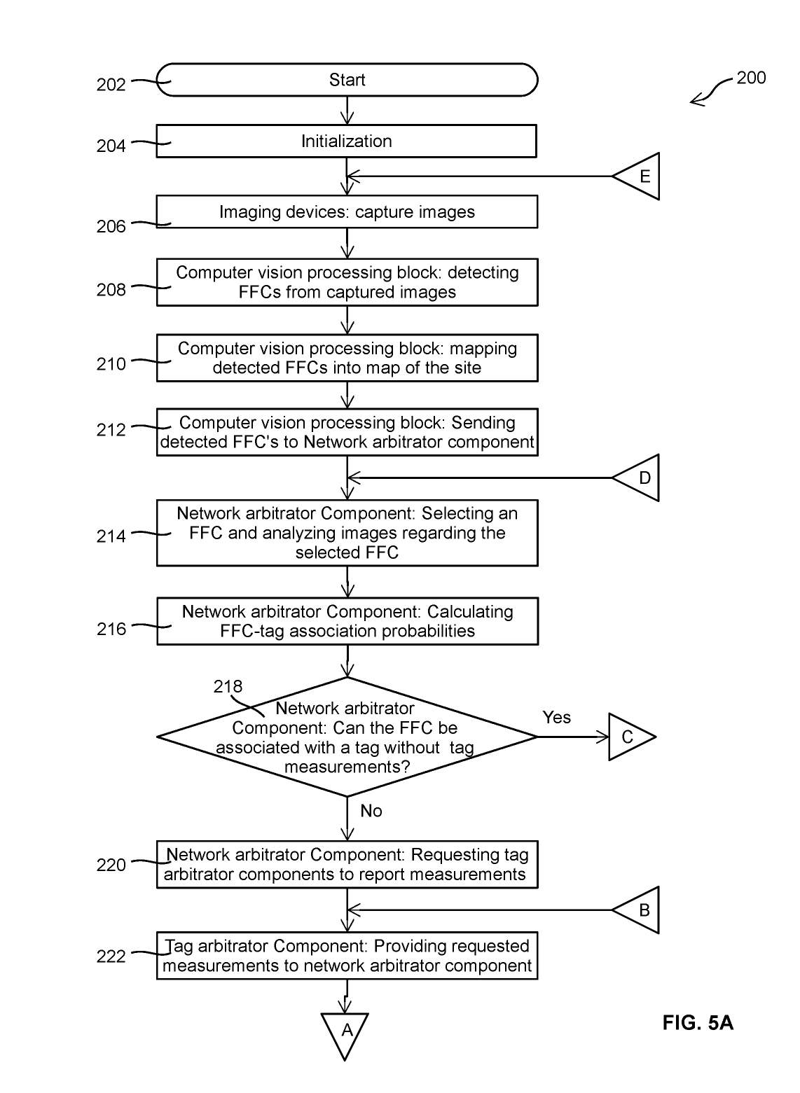

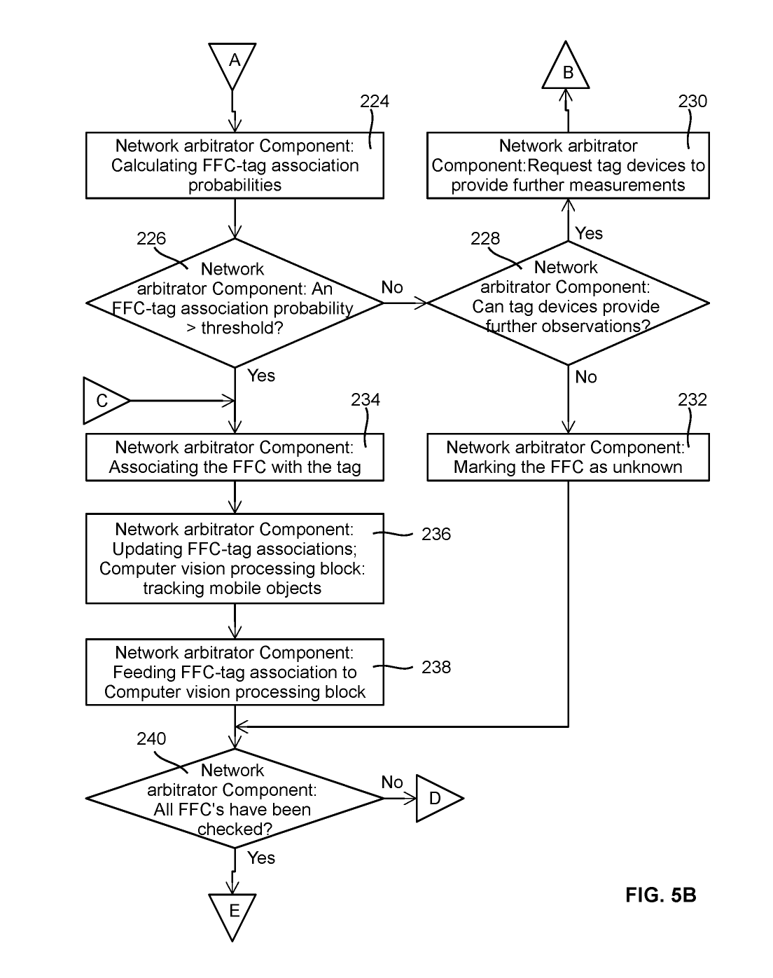

FIGS. 5A and 5B illustrate a flowchart 200, in two sheets, showing steps of a process of tracking mobile objects 112 using a vision assisted hybrid location algorithm. As described before, a mobile object 112 is considered by the system 100 as an FFC associated with a tag device 114, or an “FFC-tag association” for simplicity of description.

The process starts when the system is started (step 202). After start, the system first go through an initialization step 204 to ensure that all function blocks are ready for tracking mobile objects. For ease of illustration, this step also includes tag device initialization that will be executed whenever a tag device enters the site 102.

As described above, when a tag device 114 is activated, e.g., entering the site 102, or upon turning on, it automatically establishes communication with the computer cloud 108, via the “handshaking” process, to register itself in the computer cloud 108 and to report to the computer cloud regarding what types of tag measurements can be provided by the tag device 114 and how much energy each tag measurement will consume.

As the newly activated tag device 114 does not have any prior association with an FFC, the computer cloud 108, during handshaking, requests the tag device 114 to conduct a set of observations or measurements to facilitate the subsequent FFC-tag association with a sufficient FFC-tag association probability. For example, in an embodiment, the site 102 is a building, with a Radio-frequency identification (RFID) reader and an imaging device 104 installed at the entrance thereof. A mobile object 112 is equipped with a tag device 114 having an RFID tag. When the mobile object 112 enters the site 102 through the entrance thereof, the system detects the tag device 114 via the RFID reader. The detection of the tag device 114 is then used for associating the tag device with the FFC detected in the images captured by the imaging device at the entrance of the site 102.

Alternatively, facial recognition using images captured by the imaging device at the entrance of the site 102 may be used to establish initial FFC-tag association. In some alternatively embodiments, other biometric sensors coupled to the computer cloud 108, e.g., iris or fingerprint scanners, may be used to establish initial FFC-tag association.

After initialization, each imaging device 104 of the camera system 142 captures images of the site 102, and send a stream of captured images to the computer vision processing block 146 (step 206).

The computer vision processing block 146 detects FFCs from the received image streams (step 208). As described before, the computer vision processing structure 146 maintains a background image for each imaging device 104. When a captured image is received, the computer vision processing structure 146 calculates the difference between the received image and the stored background image to obtain a difference image, and detects FFCs from the difference image.

The computer vision processing block 146 then maps the detected FFCs into a three-dimensional (3D), physical-world coordinate system of the site by using, e.g., a perspective mapping or perspective transform technology (step 210). With the perspective mapping technology, the computer vision processing block 146 maps points in a two-dimensional (2D) image coordinate system (i.e., a camera coordinate system) to points in the 3D, physical-world coordinate system of the site using a 3D model of the site. The 3D model of site is generally a description of the site and comprises a plurality of localized planes connected by stairs and ramps. The computer vision processing block 146 determines the location of the corresponding mobile object in the site by mapping the BBTP and/or the centroid of the FFC to the 3D coordinate system of the site.

The computer vision processing block 146 sends detected FFCs, including their bounding boxes, BBTPs, their locations in the site and other relevant information, to the network arbitrator component 148 (step 212). The network arbitrator component 148 then collaborates with the tag arbitrator components 152 to associate each FFC with a tag device 114 and track the FFC-tag association, or, if an FFC cannot be associated with any tag device 114, mark it as unknown (steps 214 to 240).

In particular, the network arbitrator component 148 selects an FFC, and analyzes the image streams regarding the selected FFC (step 214). Depending on the implementation, in some embodiments, the image stream from the imaging device that captures the selected FFC is analyzed. In some other embodiments, other image streams, such as image streams from neighboring imaging devices, are also used in the analysis.

In this embodiment, the network arbitrator component 148 uses a position estimation method based on a suitable statistic model, such as a first order Markov process, and in particular, uses a Kalman filter with a first order Markov Gaussian process, to analyze the FFCs in the current images and historical images captured by the same imaging device to associate the FFCs with tag devices 114 for tracking. Motion activities of the FFCs are estimated, which may be compared with tag measurements for facilitating the FFC-tag association.

Various types of image analysis may be used for estimating motion activity and modes of the FFCs.

For example, analyzing the BBTP of an FFC and background may determine whether the FFC is stationary or moving in foreground. Usually, a slight movement is detectable. However, as the computer vision processing structure 146 periodically updates the background image, a long-term stationary object 112 may become indistinguishable from background, and no FFC corresponding to such object 112 would be reliably detected from captured images. In some embodiments, if an FFC that has been associated with a tag device disappears at a location, i.e., the FFC is no longer detectable in the current image, but have been detected as stationary in historical images, the computer cloud 108 then assumes that a “hidden” FFC is still at the last known location, and maintains the association of the tag device with the “hidden” FFC.

By analyzing the BBTP of an FFC and background, it may be detected that an FFC spontaneously appears from the background, if the FFC is detected in the current image but not in historical images previously captured by the same imaging device. Such a spontaneous appearance of FFC may indicate that a long-term stationary mobile object starts to move, that a mobile object enters the FOV of the imaging device from a location undetectable by the imaging device (e.g., behind a door) if the FFC appears at an entrance location such as a door, or that a mobile object enters the FOV of the imaging device from the FOV of a neighboring imaging device if the FFC appears at about the edge of the captured image. In some embodiments, the computer cloud 108 jointly processes the image streams from all imaging devices. If an FFC FA associated with a tag device TA disappears from the edge of the FOV of a first imaging device, and a new FFC FB spontaneously appears in the FOV of a second, neighboring imaging device at a corresponding edge, the computer cloud 108 may determine that the mobile object previously associated with FFC FA has moved from the FOV of the first imaging device into the FOV of the second imaging device, and associates the FFC FB with the tag device TA.

By determining the BBTP in a captured image and mapping it into the 3D coordinate system of the site using perspective mapping, the location of the corresponding mobile object in the site, or its coordinate in the 3D coordinate system of the site, may be determined.

A BBTP may be mapped from a 2D image coordinate system into 3D, physical-world coordinate system of the site using perspective mapping, and various inferences can then be extracted therefrom.

For example, as will be described in more detail later, a BBTP may appear to suddenly “jump”, i.e., quickly move upward, if the mobile object moves partially behind a background object and is partially occluded, or may appear to quickly move downwardly if the mobile object is moving out of the occlusion. Such a quick upward/downward movement is unrealistic from a Bayesian estimation. As will be described in more detail later, the system 100 can detect such unrealistic upward/downward movement of the BBTP and correctly identify occlusion.

Identifying occlusion may be further facilitated by a 3D site map with identified background structures, such as trees, statues, posts and the like, that may cause occlusion. By combining the site map and the tracking information mapped thereinto, a trajectory of the mobile object passing possible background occlusion objects may be derived with a high reliability.

If it is detected that the height of the bounding box of the FFC is shrinking or increasing, it may be determined that the mobile object corresponding the FFC is moving away from or moving towards the imaging device, respectively. The change of scale of the FFC bounding box may be combined with the position change of the FFC in the captured images to determine the moving direction of the corresponding mobile object. For example, if the FFC is stationary or slightly moving, but the height of the bounding box of the FFC is shrinking, it may be determined that the mobile object corresponding the FFC is moving radially away from the imaging device.

The biometrics of the FFC, such as height, width, face, stride length of walking, length of arms and/or legs, and the like may be detected using suitable algorithms for identification of the mobile object. For example, an Eigenface algorithm may be used for detecting face features of an FFC. The detected face features may be compared with those registered in a database to determine the identity of the corresponding mobile object, or be used to compare with suitable tag measurements to identify the mobile object.

The angles and motion of joints, e.g., elbows and knees, of the FFC may be detected using segmentation methods, and correlated with plausible motion as mapped into the 3D coordinate system of the site. The detected angles and motion of joints may be used for sensing the activity of the corresponding mobile object such as walking, standing, dancing or the like. For example, in FIG. 3, it may be detected that the mobile object corresponding to FFC 160 is running by analyzing the angles of the legs with respect to the body. Generally, this analysis requires at least some of the joints of the FFC is unobstructed in the captured images.

Two mobile objects may merge into one FFC in captured images. By using a Bayesian model, it may be detected that an FFC corresponding to two or more occluding objects. As will be described in more detail later, when establishing FFC-tag association, the FFC is associated with the tag devices of the occluding mobile objects.

Similarly, two or more FFCs may emerge from a previously single FFC, which may be detected by using the Bayesian model. As will be described in more detail later, when establishing FFC-tag association, each of these FFCs is associated with a tag device with an FFC-tag association probability.

As described above, based on the perspective mapping, the direction of the movement of an FFC may be detected. With the assumption that the corresponding mobile object is always facing the direction of the movement, the heading of the mobile object may be detected by tracking the change of direction of the FFC in the 3D coordinate system. If the movement trajectory of the FFC changes direction, the direction change of the FFC would be highly correlated with the change of direction sensed by the IMU of the corresponding tag device.

Therefore, tag measurements comprising data obtained from the IMU (comprising accelerometer and/or gyroscope) may be used to for calculating a tag-image correlation between the IMU data, or data obtained from the accelerometer and/or gyroscope, and the FFC analysis of captured images to determine whether the mobile object corresponding to the FFC is changing its moving direction. In an alternative embodiment, data obtained from a magnetometer may be used and correlated with the FFC analysis of captured images to determine whether the mobile object corresponding to the FFC is changing its moving direction.

The colors of the pixels of the FFC may also be tracked for determining the location and environment of the corresponding mobile object. Color change of the FFC may be due to lighting, the pose of the mobile object, the distance of the mobile object from the imaging device, and/or the like. A Bayesian model may be used for tracking the color attributes of the FFC.

By analyzing the FFC, a periodogram of walking gait of the corresponding mobile object may be established. The periodicity of the walking gait can be determined from the corresponding periodogram of the bounding box variations.

For example, if a mobile object is walking, the bounding box of the corresponding FFC will undulate with the object's walking. The bounding box undulation can be analyzed in terms of it frequency and depth for obtaining an indication of the walking gait.

The above list of analysis is non-exhaustive, and may be selectively included in the system 100 by a system designer in various embodiments.

Referring back to FIG. 5A, at step 216, the network arbitrator component uses the image analysis results to calculate an FFC-tag association probability between the selected FFC and each of one or more candidate tag devices 114, e.g., the tag devices 114 that have not been associated with any FFCs. At this step, no tag measurements are used in calculating the FFC-tag association probabilities.

Each calculated FFC-tag association probability is an indicative measure of the reliability of associating the FFC with a candidate tag device. If any of the calculated FFC-tag association probabilities is higher than a predefined threshold, the selected can be associated with a tag device without using any tag measurements.

In some situations, an FFC may be associated with a tag device 114 and tracked by image analysis only and without using any tag measurements. For example, if a captured image comprises only one FFC, and there is only one tag device 114 registered in the system 100, the FFC may be associated with the tag device 114 without using any tag measurements.

As another example, the network arbitrator component 148 may analyze the image stream captured by an imaging device, including the current image and historical images captured by the same imaging device, to associate an FFC in the current image with an FFC in previous images such that the associated FFCs across these images represent a same object. If such object has been previously associated with a tag device 114, then the FFC in the current image may be associated with the same tag device 114 without using any tag measurements.

As a further example, the network arbitrator component 148 may analyze a plurality of image streams, including the current images and historical images captured by the same and neighboring imaging devices, to associate an FFC with a tag device. For example, if an identified FFC in a previous image captured by a neighboring imaging device appears to be leaving the FOV thereof towards the imaging device that captures the current image, and the FFC in the current image with an FFC appears to enter the FOV thereof from the neighboring imaging device, then the FFC in the current image may be considered the same FFC in the previous image captured by the neighboring imaging device, and can be identified, i.e., associated with the tag device that was associated with the FFC in the previous image captured by the neighboring imaging device.

At step 218, the network arbitrator component 148 uses the calculated FFC-tag association probabilities to check if the selected FFC can be associated with a tag device 114 and tracked without using any tag measurements. If any of the calculated FFC-tag association probabilities is higher than a predefined threshold, the selected can be associated with a tag device without using any tag measurements, the process goes to step 234 in FIG. 5B (illustrated in FIGS. 5A and 5B using connector C).

However, if at step 218, none of the calculated FFC-tag association probabilities is higher than a predefined threshold, the selected FFC can only be associated with a tag device if further tag measurements are obtained. The network arbitrator component 148 then determines, based on the analysis of step 214, a set of tag measurements that may be most useful for establishing the FFC-tag association with a minimum tag device power consumption, and then requests the tag arbitrator components 152 of the candidate tag devices 114 to activate only the related sensors to gather the requested measurements, and report the set of tag measurements (step 220).

Depending on the sensors installed on the tag device 114, numerous attributes of a mobile object 112 may be measured.

For example, by using the accelerometer and rate gyro of the IMU, a mobile object in a stationary state may be detected. In particular, a motion measurement is first determined by combining and weighting the magnitude of the rate gyro vector and the difference in the accelerometer vector magnitude output. If the motion measurement does not exceed a predefined motion threshold for a predefined time threshold, then the tag device 114, or the mobile object 112 associated therewith, is in a stationary state. There can be different levels of static depending on how long the threshold has not been exceeded. For example, one level of static may be sitting still for 5 seconds, and another level of static may be lying inactively on a table for hours.

Similarly, a mobile object 112 transition from stationary to moving may be detected by using the accelerometer and rate gyro of the IMU. As described above, the motion measurement is first determined. If the motion measurement exceeds the predefined motion threshold for a predefined time threshold, the tag device 114 or mobile object 112 is in motion.

Slight motion, walking or running of a mobile object 112 may be detected by using the accelerometer and rate gyro of the IMU. While being non-stationary, a tag device 114 or mobile object 112 in motion of slight motion while standing in one place, walking at a regular pace, running or jumping may be further determined using outputs of the accelerometer and rate gyro. Moreover, the outputs of the accelerometer and rate gyro may also be used for recognizing gestures of the mobile object 112.

Rotating of a mobile object 112 while walking or standing still may be detected by using the accelerometer and rate gyro of the IMU. Provided that attitude of the mobile object 114 does not change during the rotation, the angle of rotation is approximately determined from the magnitude of the rotation vector, which may be determined from the outputs of the accelerometer and rate gyro.

A mobile object 112 going up/down stairs may be detected by using the barometer and accelerometer. Using output of the barometer, pressure changes may be resolvable almost to each step going up or down stairs, which may be confirmed by the gesture detected from the output of the accelerometer.

A mobile object 112 going up/down elevator may be detected by using the barometer and accelerometer. The smooth pressure changes between each floor as elevator ascends and descends may be detected from the output of the barometer, which may be confirmed by a smooth change of the accelerometer output.

A mobile object 112 going in or out of a doorway may be detected by using the thermometer and barometer. Going from outdoor to indoor or from indoor to outdoor causes a change in temperature and pressure, which may be detected from the outputs of the thermometer and barometer. Going from one room through a doorway to another room also causes change in temperature and pressure detectable by the thermometer and barometer.

Short term relative trajectory of a mobile object 112 may be detected by using the accelerometer and rate gyro. Conditioned on an initial attitude of the mobile object 114, the short term trajectory may be detected based on the integration and transformation of the outputs of the accelerometer and rate gyro. Initial attitudes of the mobile object 114 may need to be taken into account in detection of short term trajectory.

Periodogram of walking gait of a mobile object 112 may be detected by using the accelerometer and rate gyro.

Fingerprinting position and trajectory of a mobile object 112 based on magnetic vector may be determined by using magnetometer and accelerometer. In some embodiments, the system 100 comprises a magnetic field map of the site 102. Magnetometer fingerprinting, aided by the accelerometer outputs, may be used to determine the position of the tag device 114/mobile object 112. For example, by expressing the magnetometer and accelerometer measurements as two vectors, respectively, the vector cross-product of the magnetometer measurement vector and the accelerometer measurement vector can be calculated. With suitable time averaging, deviations of such a cross-product is approximately related to the magnetic field anomalies. In an indoor environment or environment surrounded by magnetic material (such as iron rods in construction), the magnetic field anomaly will vary significantly. Such magnetic field variation due to the building structure and furniture can be captured or recorded in the magnetic field site map during a calibration process. Thereby, the likelihood of the magnetic anomalies can be determined by continuously sampling the magnetic and accelerometer vectors over time and comparing the measured anomaly with that recorded in the magnetic field site map.

Fingerprinting position and trajectory of a mobile object 112 based on RSS may be determined by using RSS measurement sensors, e.g., RSS measurement sensors measuring Bluetooth and/or WiFi signal strength. By using the wireless signal strength map or reference transmit signal power indicator in the beacon as described above, the location of a tag device 114 may be approximately determined using RSS fingerprinting based on the output of the RSS measurement sensor.

A single sample of the RSS measurement taken by a tag device 114 can be highly ambiguous as it is subjected to multipath distortion of the electromagnetic radio signal. However, a sequence of samples taken by the tag device 114 as it is moving with the associated mobile object 112 will provide an average that can be correlated with an RSS radio map of the site. Consequently the trend of the RSS measurements as the mobile is moving is related to the mobile position. For example, an RSS measurement may indicate that the mobile object is moving closer to an access point at a known position. Such RSS measurement may be used with the image based object tracking for resolving ambiguity. Moreover, some types of mobile objects, such as human body, will absorb wireless electromagnetic signals, which may be leveraged from obtaining more inferences from RSS measurement.

Motion related sound, such as periodic rustling of clothes items brushing against the tag device, a wheeled object wheeling over a floor surface, sound of an object sliding on a floor surface, and the like, may be detected by using an audio microphone. Periodogram of the magnitude of the acoustic signal captured by a microphone of the tag device 114 may be used to detect walking or running gait.

Voice of the mobile object or voice of another nearby mobile object may be detected by using an audio microphone. Voice is a biometric that can be used to facilitate tag-object association. By using voice detection and voice recognition, analysis of voice picked up by the microphone can be useful for determining the background environment of the tag device 114/mobile object 112, e.g., in a quiet room, outside, in a noisy cafeteria, in a room with reverberations and the like. Voice can also be used to indicate approximate distance between two mobile objects 112 having tag devices 114. For example, if the microphones of two tag devices 114 can mutually hear each other, the system 100 may establish that the two corresponding mobile objects are at a close distance.

Proximity of two tag devices may be detected by using audio microphone and ultrasonic sounding. In some embodiments, a tag device 114 can broadcast an ultrasonic sound signature using the microphone, which may be received and detected by another tag device 114 using microphone, and used for establishing the FFC-tag association and ranging.

The above list of tag measurements is non-exhaustive, and may be selectively included in the system 100 by a system designer in various embodiments. Typically there is ample information for tag devices to measure for positively forging the FFC-tag association.

The operation of the network arbitrator component 148 and the tag arbitrator component 152 is driven by an overriding optimization objective. In other words, a constrained optimization is conducted with the objective of minimizing the tag device energy expenditure (e.g., minimizing battery consumption such that the battery of the tag device can last for several weeks). The constraint is that the estimated location of the mobile object equipping with the tag device (i.e., the tracking precision) is needed to be within an acceptable error range, e.g., within a two-meter range, and that the association probability between an FFC, i.e., an observed object, and the tag device is required to be above a pre-determined threshold.

In other words, the network arbitrator component 148, during above-mentioned handshaking process with each tag device 114, understands what types of tag measurements can be provided by the tag device 114 and how much energy each tag measurement will consume. The network arbitrator component 148 then uses the image analysis results obtained at step 214 to determine which tag measurement would likely give rise to a sufficient FFC-tag association probability higher than the predefined probability threshold with a smallest power consumption.

In some embodiments, one of the design goals of the system is to reduce the power consumption of the battery-driven tag devices 114. On the other hand, the power consumption of the computer cloud 108 is not constrained. In these embodiments, the system 100 may be designed in such a way that the computer cloud 108 takes as much computation as possible to reduce the computation need of the tag devices 114. Therefore, the computer cloud 108 may employ complex vision-based object detection methods such as face recognition, gesture recognition and other suitable biometrics detection methods, and jointly processing the image streams captured by all imaging devices, to identify as many mobile objects as feasible, within their capability. The computer cloud 108 requests tag devices to report tag measurements only when necessary.

Referring back to FIG. 5A, at step 222, the tag arbitrator components 152 of the candidate tag devices 114 receive the tag measurement request from the network arbitrator component 148. In response, each tag arbitrator component 152 makes requested tag measurements and report tag measurements to the network arbitrator component 148. The process then goes to step 224 of FIG. 5B (illustrated in FIGS. 5A and 5B using connector A).

In this embodiment, at step 222, the tag arbitrator component 152 collects data from suitable sensors 150 and processes collected data to obtain tag measurements. The tag arbitrator component 152 sends tag measurements, rather than raw sensor data, to the network arbitrator component 148 to save transmission bandwidth and cost.

For example, if the network arbitrator component 148 requests a tag arbitrator component 152 to report whether its associated mobile object is stationary or walking, the tag arbitrator component 152 collects data and the IMU and processes collected IMU data to calculate a walking probability indicating the likelihood of the associated mobile object being walking. The tag arbitrator component 152 then sends the calculated walking probability to the network arbitrator component 148. Comparing to transmitting the raw IMU data, transmitting the calculated walking probability of course consumes much less communication bandwidth and power.

At step 224 (FIG. 5B), the network arbitrator component 148 then correlates the image analysis results of the FFC and the tag measurements received thererfrom and calculates an FFC-tag association probability between the FFC and each candidate tag device 114.

At step 226, the network arbitrator component 148 checks if any of the calculated FFC-tag association probabilities is greater than the predefined probability threshold. If a calculated FFC-tag association probability is greater than the predefined probability threshold, the network arbitrator component 148 associates the FFC with the corresponding tag device 114 (step 234).

At step 236, the network arbitrator component 148 stores the FFC-tag association in the tracking table 182, together with data related thereto such as the location, speed, moving direction, and the like, if the tag device 114 has not yet been associated with any FFC, or update the FFC-tag association in the tracking table if the tag device 114 has already associated with an FFC in previous processing. The computer vision processing block 146 tracks the FFCs/mobile objects.

In this way, the system continuously detects and tracks the mobile objects 112 in the site 102 until the tag device 114 is no longer detectable, implying that the mobile object 112 has been stationary for an extended period of time or has moved out of the site 102, or until the tag device 114 cannot be associated with any FFC, implying that the mobile object 112 is at an undetectable location in the site (e.g., a location beyond the FOV of all imaging devices).

After storing/updating the FFC-tag association, the network arbitrator component 148 sends data of the FFC-tag association, such as the height, color, speed and other feasible characteristics of the FFCs, to the computer vision processing block 146 (step 238) for facilitating the computer vision processing block 146 to better detect the FFC in subsequent images, e.g., facilitating the computer vision processing block 146 in background differencing and bounding box estimation.

The process then goes to step 240, and the network arbitrator component 148 checks if all FFCs have been processed. If yes, the process goes to step 206 of FIG. 5A (illustrated in FIGS. 5A and 5B using connector E) to process further images captured by the imaging devices 104. If not, the process loops to step 214 of FIG. 5A (illustrated in FIGS. 5A and 5B using connector D) to select another FFC for processing.

If, at step 226, the network arbitrator component 148 determines that no calculated FFC-tag association probability is greater than the predefined threshold, the network arbitrator component 148 then checks if the candidate tag devices 114 can provide further tag measurements helpful in leading to a sufficiently high FFC-tag association probability (step 228), and if yes, requests the candidate tag devices 114 to provide further tag measurements (step 230). The process then loops to step 222 of FIG. 5A (illustrated in FIGS. 5A and 5B using connector B).

If, at step 228, it is determined that no further tag measurements would be available for leading to a sufficiently high FFC-tag association probability, the network arbitrator component 148 marks the FFC as an unknown object (step 232). As described before, unknown objects are omitted, or alternatively, tracked up to a certain extent. The process then goes to step 240.

Although not shown in FIGS. 5A and 5B, the process 200 may be terminated upon receiving a command from an administrative user.

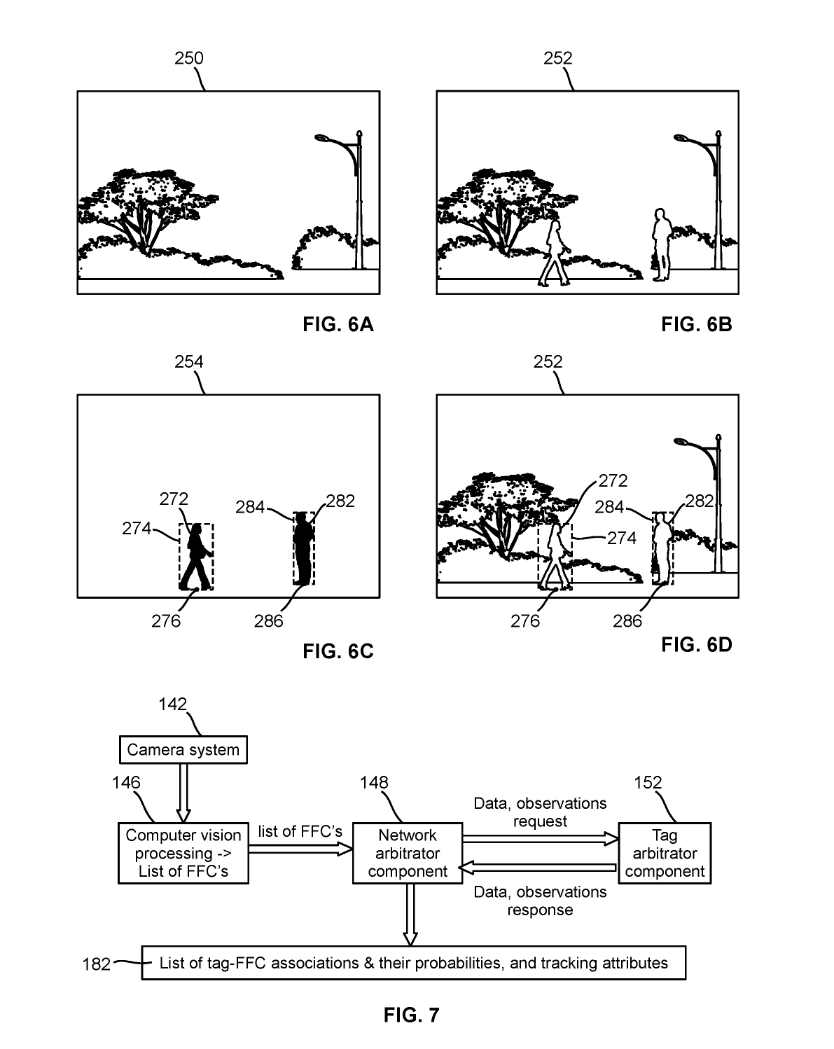

FIGS. 6A to 6D show an example of establishing and tracking an FFC-tag association following the process 200. As shown, the computer vision processing block 146 maintains a background image 250 of an imaging device. When an image 252 of captured by the imaging device is received, the computer vision processing block 146 calculates a difference image 254 using suitable image processing technologies. As shown in FIG. 6C, two FFCs 272 and 282 are detected from the difference image 254. The two FFCs 272 and 282 are bounded by their respective bounding boxes 274 and 284. Each bounding box 274, 284 comprises a respective BBTP 276, 286. FIG. 6D shows the captured image 252 with detected FFCs 272 and 282 as well as their bounding boxes 274 and 284 and BBTPs 276 and 286.

When processing the FFC 272, the image analysis of image 252 and historical images show that the FFC 272 is moving by a walking motion and the FFC 282 is stationary. As the image 252 comprises two FFCs 272 and 282, FFC-tag association cannot be established by using the image analysis results only.

Two tag devices 114A and 114B have been registered in the system 100, neither of which have been associated with an FFC. Therefore, both tag devices 114A and 114B are candidate tag devices.

The network arbitrator component 148 then requests the candidate tag devices 114A and 1146 to measure certain characteristics of the motion of their corresponding mobile objects. After receiving the tag measurements from tag devices 114A and 1146, the network arbitrator component 148 compares the motion tag measurements of each candidate tag device with that obtained from the image analysis to calculate the probability that the object is undergoing a walking activity. One of the candidate tag devices, e.g., tag device 114A, may obtain a motion tag measurement leading to an FFC-tag association probability higher than the predefined probability threshold. The network arbitrator component 148 then associates FFC 272 with tag device 114A and store this FFC-tag association in the tracking table 182. Similarly, the network arbitrator component 148 determines that the motion tag measurement from tag device 1146 indicates that its associated mobile object is in a stationary state, and thus associates tag device 1146 with FFC 284. The computer vision processing block 146 tracks the FFCs 272 and 282.

With the process 200, the system 100 tracks the FFCs that are potentially moving objects in the foreground. The system 100 also tracks objects disappearing from the foreground, i.e., tag devices not associated with any FFC, which implies that the corresponding mobile objects may be outside the FOV of any imaging device 104, e.g., in a washroom area or private office where there is no camera coverage. Such disappearing objects, i.e., those corresponding to tag devices with no FFC-tag association, are still tracked based on tag measurements they provide to the computer cloud 108 such as RSS measurements.

Disappearing objects may also be those who have become static for an extended period of time and therefore part of the background and hence not part of a bounding box 162. It is usually necessary for the system 100 to track all tag devices 114 because in many situations only a portion of the tag devices can be associated with FFCs. Moreover, not all FFCs or foreground objects can be associated with tag devices. The system may track these FFCs based on image analysis only, or alternatively, ignore them.

With the process 200, an FFC may be associated with one or more tag device 114. For example, when a mobile object 112C having a tag device 114C is sufficiently distant from other mobile objects in the FOV of an imaging device, the image of the mobile object 112C as an FFC is distinguishable from other mobile objects in the captured images. The FFC of the mobile object 112C is then associated with the tag device 114C only.

However, when a group of mobile objects 112D are close to each one, e.g., two persons shaking hands, they may be detected as one FFC in the captured images. In this case, the FFC is associated with all tag devices of the mobile objects 112D.

Similarly, when a mobile object 112E is partially or fully occluded in the FOV of an imaging device by one or more mobile objects 112F, the mobile objects 112E and 112F may be indistinguishable in the captured images, and be detected as one FFC. In this case, the FFC is associated with all tag devices of the mobile objects 112E and 112F.

Those skilled in the art understand that an FFC associated with multiple tag devices is usually temporary. Any ambiguity caused therefrom may be automatically resolved in subsequent mobile object detection and tracking when the corresponding mobile objects are separated in the FOV of the imaging devices.

While the above has described a number of embodiments, those skilled in the art appreciate that other alternative embodiments are also readily available. For example, although in above embodiments, data of FFC-tag associations in the tracking table 182 is fed back to the computer vision processing block 146 for facilitating the computer vision processing block 146 to better detect the FFC in subsequent images (FIG. 4), in an alternative embodiment, no data of FFC-tag associations is fed back to the computer vision processing block 146. FIG. 7 is a schematic diagram showing the main function blocks of the system 100 and the data flows therebetween in this embodiment. The object tracking process in this embodiment is the same as the process 200 of FIGS. 5A and 5B, except that, in this embodiment, the process does not have step 238 of FIG. 5B.

In above embodiments, the network arbitrator component 148, when needing further tag measurements for establishing FFC-tag association, only checks if the candidate tag devices 114 can provide further tag measurements helpful in leading to a sufficiently high FFC-tag association probability (step 228 of FIG. 5B). In an alternative embodiment, when needing further tag measurements of a first mobile object, the network arbitrator component 148 can request tag measurements from the tag devices near the first mobile object, or directly use the tag measurements if they are already sent to the computer cloud 108 (probably previously requested for tracking other mobile objects). The tag measurements obtained from these tag devices can be used as inference to the location of the first mobile object. This may be advantageous, e.g., for saving tag device power consumption if the tag measurements of the nearby tag devices are already available in the computer cloud, or when the battery power of the tag device associated with the first object is low.

In another embodiment, the tag devices constantly send tag measurements to the computer cloud 108 without being requested.

In another embodiment, each tag device attached to a non-human mobile object, such as a wheelchair, a cart, a shipping box or the like, stores a Type-ID indicating the type of the mobile object. In this embodiment, the computer cloud 108, when requesting tag measurements, can request tag devices to provide their stored Type-ID, and then uses object classification to determine the type of the mobile object, which may be helpful for establishing FFC-tag association. Of course, alternatively, each tag device associated with a human object may also store a Type-ID indicating the type, i.e., human, of the mobile object.

In another embodiment, each tag device is associated with a mobile object, and the association is stored in a database of the computer cloud 108. In this embodiment, when ambiguity occurs in the visual tracking of mobile objects, the computer cloud 108 may request tag devices to provide their ID, and checks the database to determine the identity of the mobile object for resolving the ambiguity.

In another embodiment, contour segmentation can be applied in detecting FFCs. Then, motion of the mobile objects can be detected using suitable classification methods. For example, for individuals, after detecting an FFC, the outline of the detected FFC can be characterized to a small set of features based on posture for determining if the mobile object is standing or walking. Furthermore, the motion detected over a set of sequential image frames can give rise to an estimate of the gait frequency, which may be correlated with the gait determined from tag measurements.

In above embodiments, the computer cloud 108 is deployed at the site 102, e.g., at an administration location thereof. However, those skilled in the art appreciate that, alternatively, the computer cloud 108 may be deployed at a location remote to the site 102, and communicates with imaging devices 104 and tag devices 114 via suitable wired or wireless communication means. In some other embodiments, a portion of the computer cloud 108, including one or more server computers 110 and necessary network infrastructure, may be deployed on the site 102, and other portions of the computer cloud 108 may be deployed remote to the site 102. Necessary network infrastructure known in the art is required for communication between different portions of the computer cloud 108, and for communication between the computer cloud 108 and the imaging devices 104 and tag devices 114.

Implementation

The above embodiments show that the system and method disclosed herein are highly customizable, providing great flexibility to a system designer to implement the basic principles ye design the system in a way as desired, and adapt to the design target that the designer has to meet and to the resources that the designer has, e.g., available sensors in tag devices, battery capacities of tag devices, computational power of tag devices and the computer cloud, and the like.

In the following, several aspects in implementing the above described system are described.

### I. Imaging Device Frame Rates

In some embodiments, the imaging devices 104 may have different frame rates. For imaging devices with higher frame rates than others, the computer cloud 108 may, at step 206 of the process 200, reduce their frame rate by time-sampling images captured by these imaging devices, or by commanding these imaging devices to reduce their frame rates. Alternatively, the computer cloud 108 may adapt to the higher frame rates thereof to obtain better real-time tracking of the mobile objects in the FOVs of these imaging devices.

### II. Background Images

The computer cloud 108 stores and periodically updates a background image for each imaging device. In one embodiment, the computer cloud 108 uses a moving average method to generate the background image for each imaging device. That is, the computer cloud 108 periodically calculates the average of N consecutively captured images to generate the background image. While the N consecutively captured images may be slightly different to each other, e.g., having different lighting, foreground objects and the like, the differences between these images tend to disappear in the calculated background image when N is sufficiently large.

### III. FFC Detection

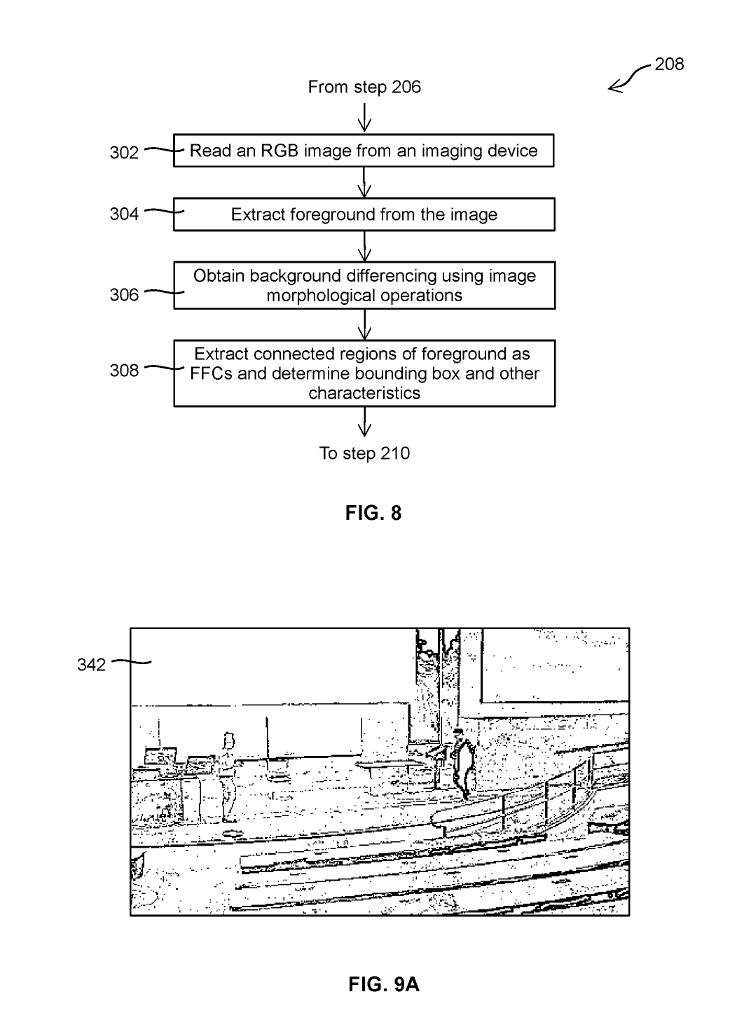

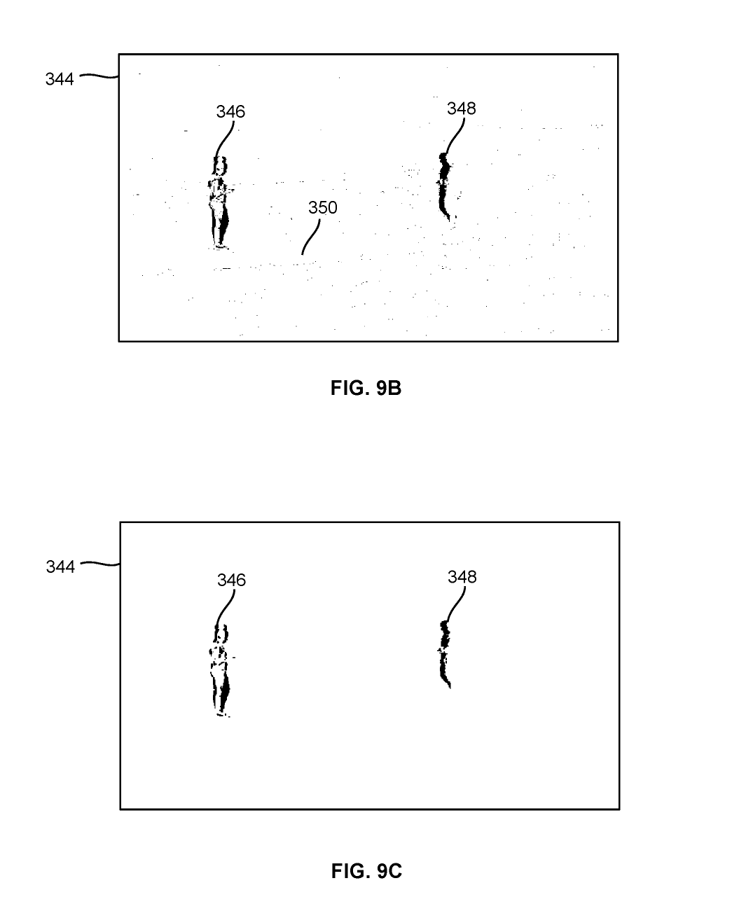

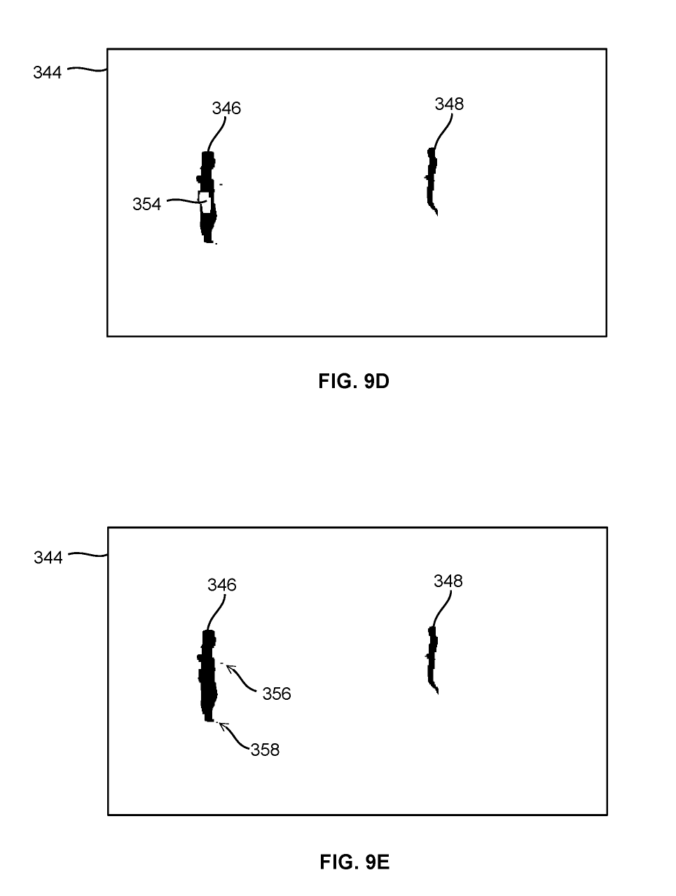

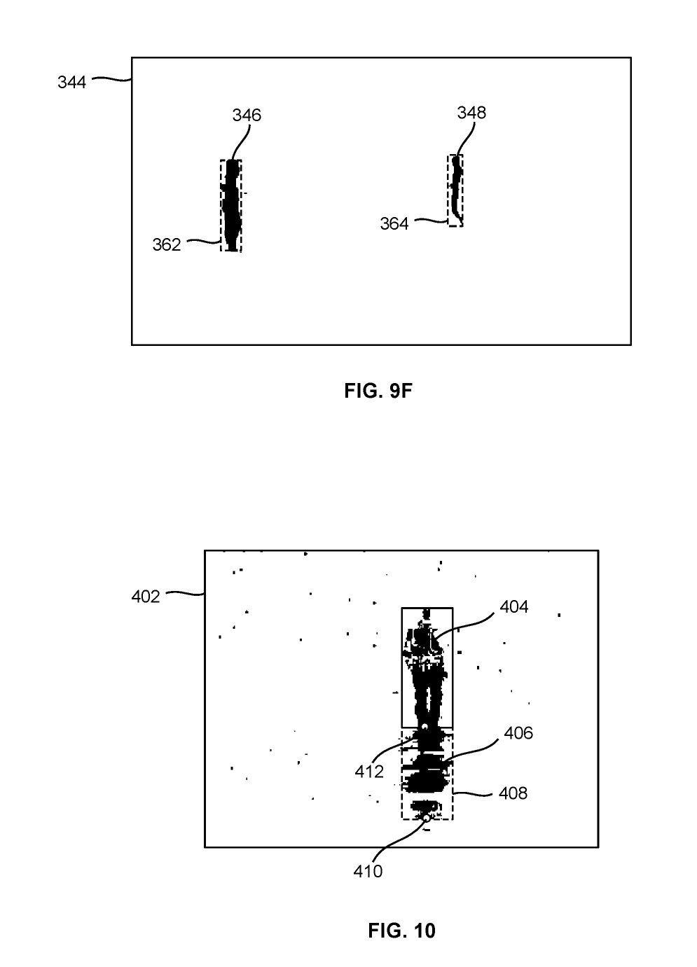

In implementing step 208 of detecting FFCs, the computer vision processing block 146 may use any suitable imaging processing methods to detect FFCs from captured images. For example, FIG. 8 is a flowchart showing the detail of step 208 in one embodiment, which will be described together with the examples of FIGS. 9A to 9F.

At step 302, a captured image is read into the computer vision processing block 146. In this embodiment, the capture image is an RGB color image. FIG. 9A is a line-drawn illustration of a captured color image having two facing individuals as two mobile objects.

At step 304, the captured image is converted to a greyscale image (current image) and a difference image is generated by subtracting the background image, which is also a greyscale image in this embodiment, from the current image on a pixel by pixel basis. The obtained difference image is converted to a binary image by applying a suitable threshold, e.g., pixel value being equal to zero or not.

FIG. 9B shows the difference image 344 obtained from the captured image 342. As can be seen, two images 346 and 348 of the mobile objects in the FOV of the imaging device have been isolated from the background. However, the difference image 344 has imperfections. For example, images 346 and 348 of the mobile objects are incomplete as some regions of the mobile objects appear in the image with colors or grey intensities insufficient for differentiating from the background. Moreover, the difference image 344 also comprises salt and pepper noise pixels 350.

At step 306, the difference image is processed using morphological operations to compensate imperfections. The morphological operations use Morphology techniques that process images based on shapes. The morphological operations apply a structuring element to the input image, i.e., the difference image in this case, creating an output image of the same size. In morphological operations, the value of each pixel in the output image is determined based on a comparison of the corresponding pixel in the input image with its neighbors. Imperfections are then compensated to certain extents.

In this embodiment, the difference image 344 is first processed using morphological opening and closing. As shown in FIG. 9C, salt and pepper noise is removed.

The difference image 344 is then processed using erosion and dilation operations. As shown in FIG. 9D the shapes of the mobile object images 346 and 348 are improved. However, the mobile object image 346 still contains a large internal hole 354.

After erosion and dilation operations, a flood fill operation is applied to the difference image 344 to close up any internal holes. The difference image 344 after flood fill operation is shown in FIG. 9E.

Also shown in FIG. 9E, the processed difference image 344 also comprises small spurious FFCs 356 and 358. By applying suitable size criteria such small spurious FFCs 356 and 358 are rejected as their sizes are smaller than a predefined threshold. Large spurious FFCs, on the other hand, may be retained as FFCs. However, they may be omitted later for not being able to be associated with any tag device. In some cases, a large spurious FFC, e.g., a shopping cart, may be associated with another FFC, e.g., a person, already associated with a tag device, based on similar motion between the two FFCs over time.

Referring back to FIG. 8, at step 308, the computer vision processing block 146 extracts FFCs 346 and 348 from processed difference image 344, each FFC 346, 348 being a connected region in the difference image 344 (see FIG. 9F). The computer vision processing block 146 creates bounding boxes 356 and 358 and their respective BBTPs (not shown) for FFCs 346 and 348, respectively. Other FFC characteristics as described above are also determined.

After extracting FFCs from the processed difference image, the process then goes to step 210 of FIG. 5A.

The above process converts the captured color images to greyscale images for generating greyscale difference images and detecting FFCs. Those skilled in the art appreciate that in an alternative embodiment, color difference images may be generated for FFC detection by calculating the difference on each color channel between the captured color image and the background color image. The calculated color channel differences are then weighted and added together to generate a greyscale image for FFC detection.

Alternatively, the calculated color channel differences may be enhanced by, e.g., first squaring the pixel values in each color channel, and then adding together the squared values of corresponding pixels in all color channels to generate a greyscale image for FFC detection.

### IV. Shadows

It is well known that shadow may be cast adjacent an object in some lighting conditions. Shadows of a mobile object captured in an image may interfere with FFC detection, the FFC centroid determination and BBTP determination. For example, FIG. 10 shows a difference image 402 having the image 404 of a mobile object, and the shadow 406 thereof, which is shown in the image 402 under the mobile object image 404. Clearly, if both the mobile object image 404 and the shadow 406 were detected as an FFC, an incorrect bounding box 408 would be determined, and the BBTP would be mistakenly determined at a much lower position 410, compared to the correct BBTP location 412. As a consequence, the mobile object would be mapped to a wrong location in the 3D coordinate system of the site, being much closer to the imaging device.

Various methods may be used to mitigate the impact of shadow in detecting FFC and in determining the bounding box, centroid and BBTP of the FFC. For example, in one embodiment, one may leverage the fact that the color of shadows are usually different than that of the mobile object, and filters different color channels of a generated color difference image to eliminate the shadow or reduce the intensity thereof. This method would be less effective if the color of the mobile object is poorly distinguishable from the shadow.

In another embodiment, the computer vision processing block 146 considers the shadow as a random distribution, and analyses shadows in captured images to differentiate shadows from mobile object images. For example, for an imaging device facing a well-lit environment, where the lighting is essentially diffuse and that all the background surfaces are Lambertian surfaces, the shadow cast by a mobile object consists of a slightly reduced intensity in a captured image comparing to that of the background areas in the image, as the mobile object only blocks a portion of the light that is emanating from all directions. The intensity reduction is smaller with the shadow point being further from the mobile object. Hence the shadow will have an intensity distribution scaled with the distance between shadow points and the mobile object while the background has a deterministic intensity value. As the distance from the mobile object to the imaging device is initially unknown, the intensity of the shadow can be represented as a random distribution. The computer vision processing block 146 thus analyses shadows in images captured by this imaging device using a suitable random process method to differentiate shadows from mobile object images.

Some imaging devices may face an environment having specular light sources and/or that the background surfaces are not Lambertian surfaces. Shadows in such environment may not follow the above-mentioned characteristics of the diffuse lighting. Moreover, lighting may change with time, e.g., due to sunlight penetration of room, electrical lights turned off or on, doors opened or closed, and the like. Light changes will also affect the characteristics of shadows.

In some embodiments, the computer vision processing block 146 considers the randomness of the intensities of both the background and the shadow in each color channel, and considers that generally the background varies slowly and the foreground, e.g., a mobile object, varies rapidly. Based on such considerations, the computer vision processing block 146 uses a pixel-wise high pass temporal filtering to filtering out shadows of mobile objects.

In some other embodiments, the computer vision processing block 146 determines a probability density function (PDF) of the background to adapt to the randomness of the lighting effects. The intensity of background and shadow components follows a mixture of gaussians (MoG) model, and a foreground, e.g., a mobile object, is then discriminated probabilistically. As there are a large number of neighboring pixels making up the foreground region, then a spatial MoG representation of the PDF of the foreground intensity can be calculated for determining how different it is from the background or shadow.

In some further embodiments, the computer vision processing block 146 weights and combines the pixel-wise high pass temporal filtering and the spatial MoG models to determine if a given pixel is foreground, e.g., belonging to a mobile object, with higher probability.

In still some further embodiments, the computer vision processing block 146 leverages the fact that, if a shadow is not properly eliminated, the BBTP of an FFC shifts from the correct location in the difference images and may shift with the change of lighting. With perspective mapping, such a shift of BBTP in the difference images can be mapped to a physical location shift of the corresponding mobile object in the 3D coordinate system of the site. The computer vision processing block 146 calculates the physical location shift of the corresponding mobile object in the physical world, and requests the tag device to make necessary measurement using, e.g., the IMU therein. The computer vision processing block 146 checks if the calculated physical location shift of the mobile object is consistent with the tag measurement, and compensates for the location shift using the tag measurement.

### V. Perspective Mapping

As described above, at step 210 of FIG. 5A, the extracted FFCs are mapped to the 3D physical-world coordinate system of the site 102.

In one embodiment, the map of the site is partitioned into one or more horizontal, planes L₁, . . . , Lₙ, each at a different elevation. In other words, in the 3D physical world coordinate system, points in each plane have the same z-coordinate. However, points in different planes have different z-coordinates. The FOV of each imaging device covers one or more horizontal planes.

A point (x_{w,i}, y_{w,i}, 0) on a plane Lᵢ at an elevation Zᵢ=0 and falling within the FOV of an imaging device can be mapped to a point (x_{c}, y_{c}) in the images captured by the imaging device:

$$\begin{matrix}[ \begin{matrix}{f}_{x} \\ {f}_{y} \\ {f}_{v}\end{matrix} ] = {H}_{i} [ \begin{matrix}{x}_{w , i} \\ {y}_{w , i} \\ 1\end{matrix} ] , & ( 1 ) \\ {x}_{c} = \frac{{f}_{x}}{{f}_{v}} , & ( 2 ) \\ {y}_{c} = \frac{{f}_{y}}{{f}_{v}} , & ( 3 )\end{matrix}$$

wherein

$${H}_{i} = [ \begin{matrix}{H}_{11 , i} & {H}_{12 , i} & {H}_{13 , i} \\ {H}_{21 , i} & {H}_{22 , i} & {H}_{23 , i} \\ {H}_{31 , i} & {H}_{32 , i} & {H}_{33 , i}\end{matrix} ] \qquad ( 4 )$$

is a 9-by-9 perspective-transformation matrix.

The above relationship between point (x_{w,i}, y_{w,i}, 0) in physical world and point (x_{c}, y_{c}) in a captured image may also be written as:

$$\{ \begin{matrix}{H}_{31 , i} {x}_{c} {x}_{w , i} + {H}_{32 , i} {x}_{c} {y}_{w , i} + {H}_{33 , i} {x}_{c} = {H}_{11 , i} {x}_{w , i} + {H}_{12 , i} {y}_{w , i} + {H}_{13 , i} , \\ {H}_{31 , i} {y}_{c} {x}_{w , i} + {H}_{32 , i} {y}_{c} {y}_{w , i} + {H}_{33 , i} {y}_{c} = {H}_{21 , i} {x}_{w , i} + {H}_{22 , i} {y}_{w , i} + {H}_{23 , i} .\end{matrix} \qquad ( 5 )$$

For each imaging device, a perspective-transformation matrix Hᵢ needs to be determined for each plane Lᵢ falling within the FOV thereof. The computer vision processing block 146 uses a calibration process to determine a perspective-transformation matrix for each plane in the FOV of each imaging device.

In particular, for a plane Lᵢ, 1≦i≦n falling within the FOV of an imaging device, the computer vision processing block 146 first selects a set of four (4) or more points on plane Lᵢ with known 3D physical-world coordinates, such as corners of a floor tile, corners of doors and/or window openings, of which no three points are in the same line, and sets their z-values to zero. The computer vision processing block 146 also identifies the set of known points from the background image and determines their 2D coordinates therein. The computer vision processing block 146 then uses a suitable optimization method such as a singular value decomposition (SVD) method to determine a perspective-transformation matrix Hᵢ for plane Lᵢ in the FOV of the imaging device. After determining the perspective-transformation matrix Hᵢ, a point on plane Lᵢ can be mapped to a point in an image, or a point in an image can be mapped to a point on plane Lᵢ by using equation (5).

The calibration process may be executed for an imaging device only once at the setup of the system 100, periodically such as during maintenance, as needed such as when repairing or replacing the imaging device. The calibration process is also executed after the imaging device is reoriented or zoomed and focused.

During mobile object tracking, the computer vision processing block 146 detects FFCs from each captured image as described above. For each detected FFC, the computer vision processing block 146 determines coordinates (x_{c}, y_{c}) of the BBTP of the FFC in the captured image, and determines the plane, e.g., Lₖ, that the BBTP of the FFC falls within, with the assumption that the BBTP of the FFC, when mapping to the 3D physical world coordinate system, is on plane Lₖ, i.e., the z-coordinate of the BBTP equals to that of plane Lₖ. The computer vision processing block 146 then calculates the coordinates (x_{w,k}, y_{w,k}, 0) of the BBTP in a 3D physical world coordinate system with respect to the imaging device and plane Lₖ (denoted as a “local 3D coordinate system”) using above equation (5), and translate the coordinates of the BBTP into a location (x_{w,k}+Δx, y_{w,k}+Δy, zₖ) in the 3D physical world coordinate system of the site (denoted as the “global 3D coordinate system”), wherein Δx and Δy are the difference between the origins of the local 3D coordinate system and the global 3D coordinate system, and zₖ is the elevation of plane Lₖ.

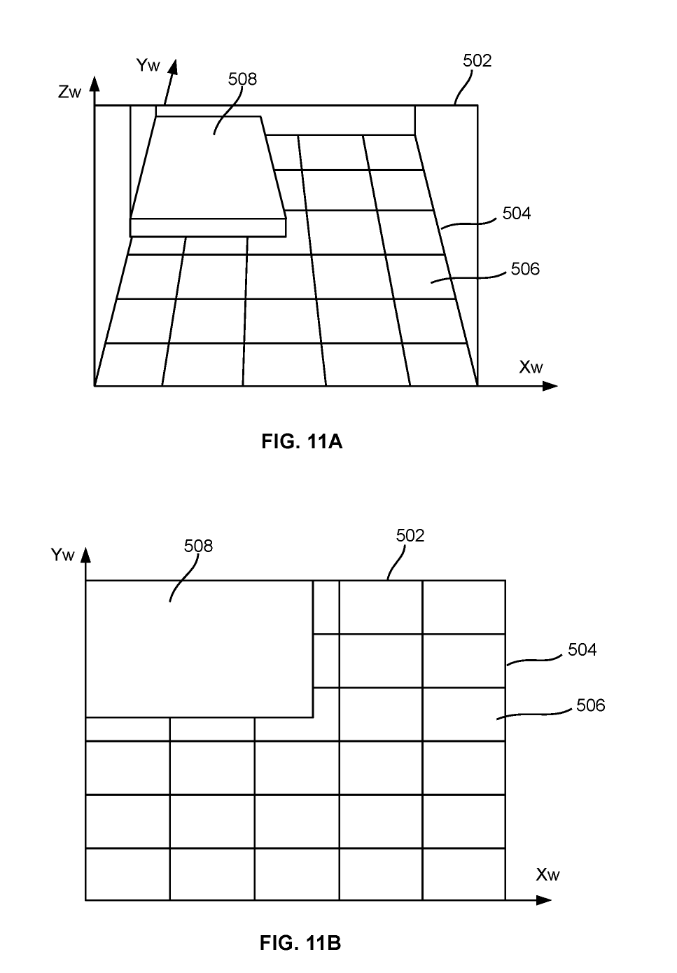

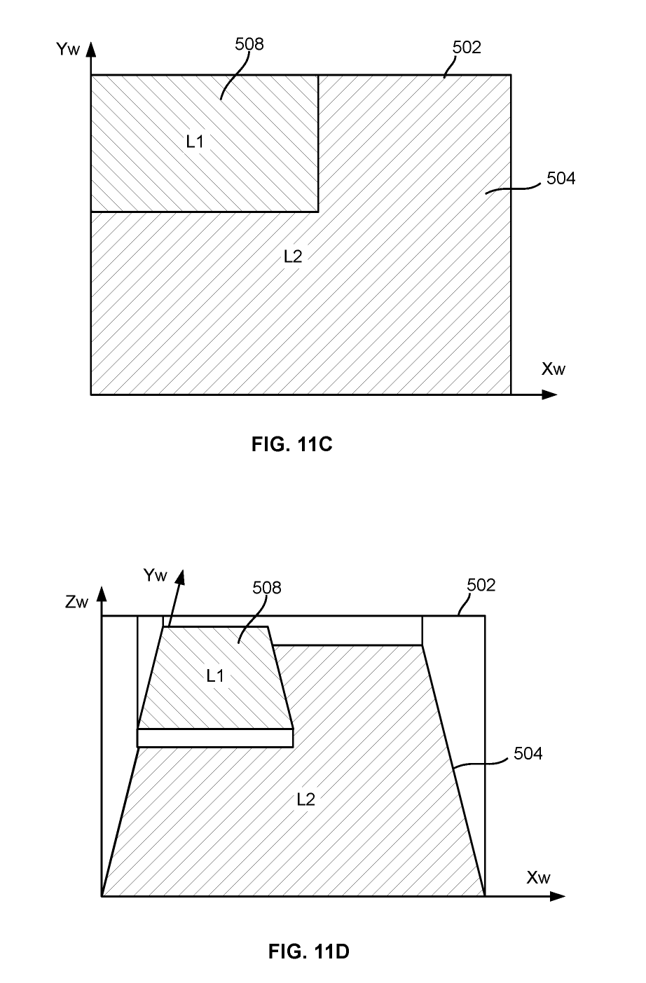

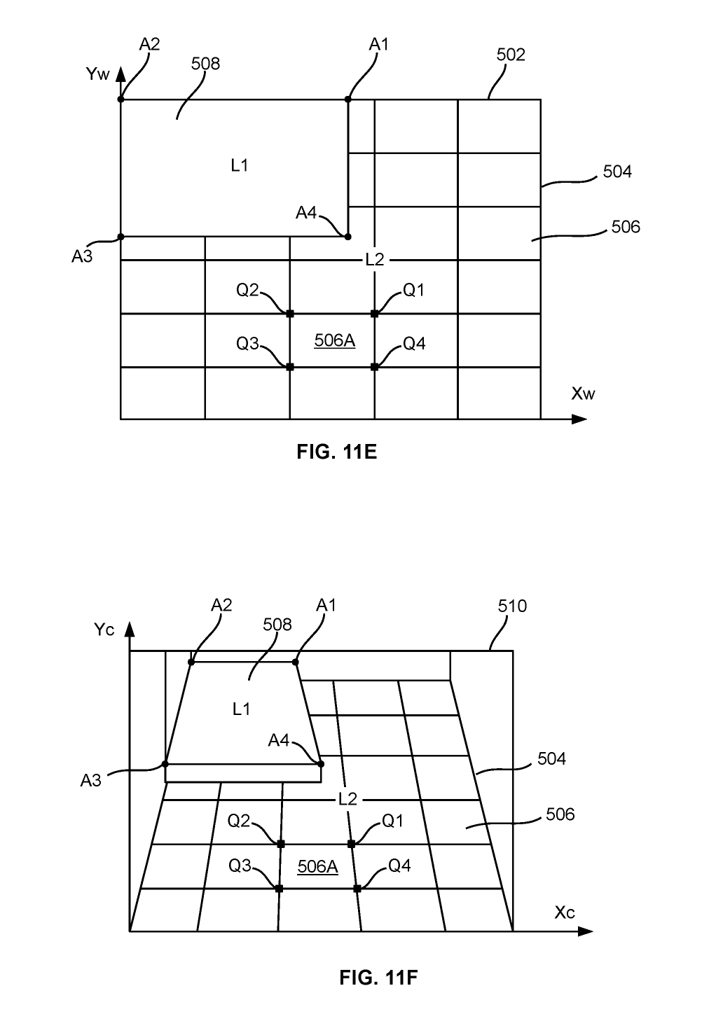

For example, FIG. 11A is a 3D perspective view of a portion 502 of a site 102 falling with the FOV of an imaging device, and FIG. 11B a plan view of the portion 502. For ease of illustration, the axes of a local 3D physical world coordinate system with respect to the imaging device is also shown, with Xw and Yw representing the two horizontal axes and Zw representing the vertical axis. As shown, the site portion 502 comprises a horizontal, planar floor 504 having a plurality of tiles 506, and a horizontal, planar landing 508 at a higher elevation than the floor 504.

As shown in FIGS. 11C and 11D, the site portion 502 is partitioned into two planes L1 and L2, with plane L2 corresponding to the floor 504 and plane L1 corresponding to the landing 508. Plane L1 has a higher elevation than plane L2.

As shown in FIG. 11E, during calibration of the imaging device, the computer vision processing block 146 uses the corners A1, A2, A3 and A4 of the landing 508, whose physical world coordinates (x_{w1}, y_{w1}, z_{w1}), (x_{w2}, y_{w2}, z_{w1}), (x_{w3}, y_{w3}, z_{w1}) and (x_{w4}, y_{w4}, z_{w1}), respectively, are known with z_{w1} also being the elevation of plane L1, to determine a perspective-transformation matrix H₁ for plane L1 in the imaging device. FIG. 11F shows a background image 510 captured by the imaging device.

As described above, the computer vision processing block 146 set z_{w1} to zero, i.e., set the physical world coordinates of the corners A1, A2, A3 and A4 to (x_{w1}, y_{w1}, 0), (x_{w2}, y_{w2}, 0), (x_{w3}, y_{w3}, 0) and (x_{w4}, y_{w4}, 0), respectively, determines their image coordinates (x_{c1}, y_{c1}), (x_{c2}, y_{c2}), (x_{c3}, y_{c3}) and (x_{c4}, y_{c4}), respectively, in the background image 510, and then determines a perspective-transformation matrix H₁ for plane L1 in the imaging device by using these physical world coordinates (x_{w1}, y_{w1}, 0), (x_{w2}, y_{w2}, 0), (x_{w3}, y_{w3}, 0) and (x_{w4}, y_{w4}, 0), and corresponding image coordinates (x_{c1}, y_{c1}), (x_{c2}, y_{c2}), (x_{c3}, y_{c3}) and (x_{c4}, y_{c4}).

Also shown in FIGS. 11E and 11F, the computer vision processing block 146 uses the four corners Q1, Q2, Q3 and Q4 of a tile 506A to determine a perspective-transformation matrix H₂ for plane L2 in the imaging device in a similar manner.

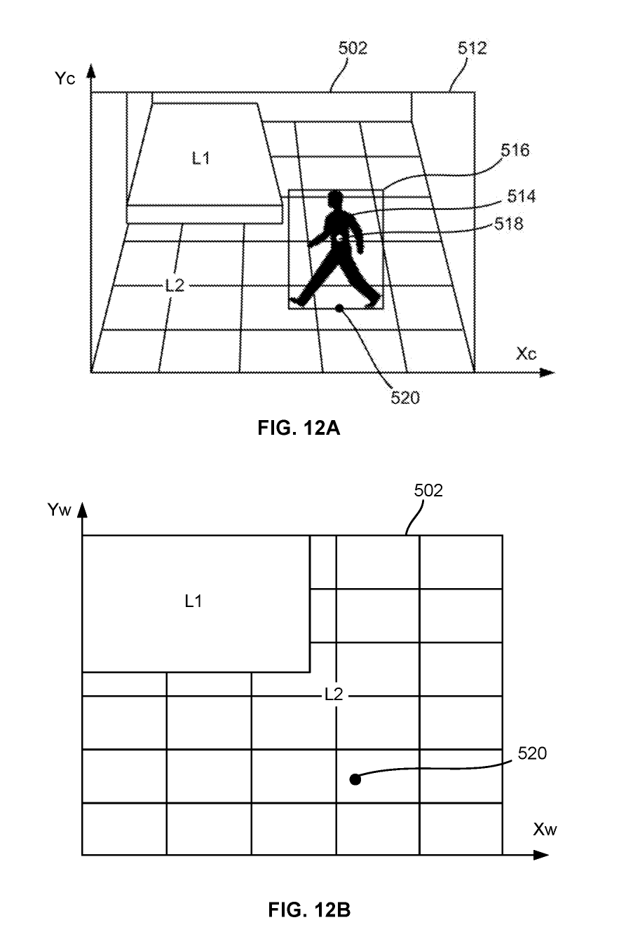

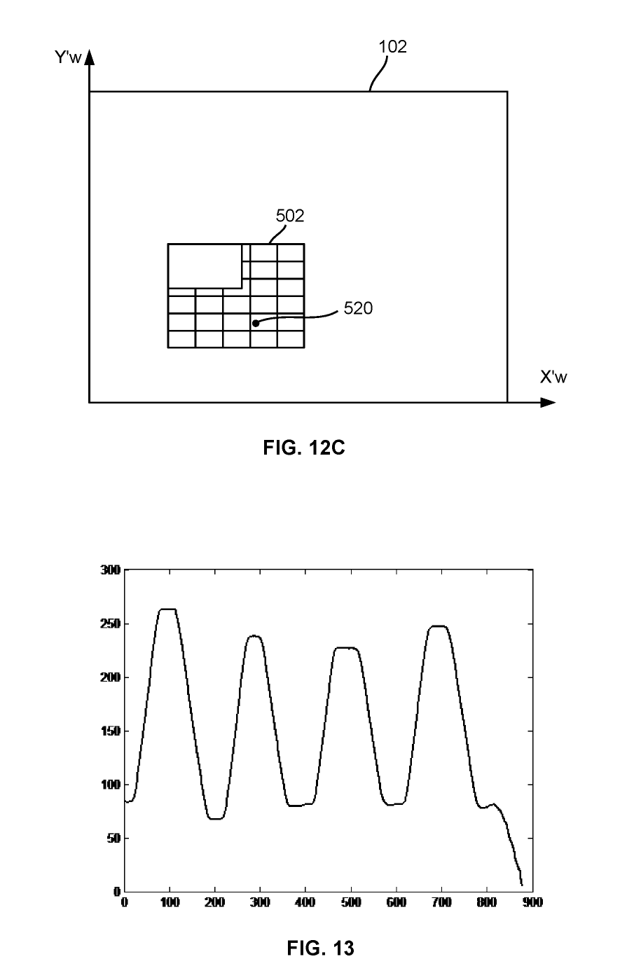

After determining the perspective-transformation matrices H₁ and H₂, the computer vision processing block 146 starts to track mobile objects in the site 102. As shown in FIG. 12A, the imaging device captures an image 512, and the computer vision processing block 146 identifies therein an FFC 514 with a bounding box 516, a centroid 518 and a BBTP 520. The computer vision processing block 146 determines that the BBTP 520 is within the plane L2, and then uses equation (5) with the perspective-transformation matrix H₂ and the coordinates of the BBTP 520 in the captured image 512 to calculate the x- and y-coordinates of the BBTP 520 in the 3D physical coordinate system of the site portion 502 (FIG. 12B). As shown in FIG. 12C, the computer vision processing block 146 may further translate the calculated x- and y-coordinates of the BBTP 520 to a pair of x- and y-coordinates of the BBTP 520 in the site 102.

### VI. FFC Tracking

The network arbitrator component 148 updates FFC-tag association and the computer vision processing block 146 tracks an identified mobile object at step 236 of FIG. 5B. Various mobile object tracking methods are readily available in different embodiments.

For example, in one embodiment, each FFC in captured image stream is analyzed to determine FFC characteristics, e.g., the motion of the FFC. If the FFC cannot be associated with a tag device without the assistance of tag measurements, the network arbitrator component 148 requests candidate tag devices to obtain required tag measurements over a predefined period of time. While the candidate tag devices are obtaining tag measurements, the imaging devices continue to capture images and the FFCs therein are further analyzed. The network arbitrator component 148 then calculates the correlation between the determined FFC characteristics and the tag measurements received from each candidate tag device. The FFC is then associated with the tag device whose tag measurements exhibit highest correlation with the determined FFC characteristics.

For example a human object in the FOV of the imaging device walks for a distance along the x-axis of the 2D image coordinate system, pauses, and then turns around and walks back retracing his path. The person repeats this walking pattern for four times. The imaging device captures the person's walking.

FIG. 13 shows a plot of the BBTP x-axis position in captured images. The vertical axis represents the BBTP's x-axis position (in pixel) in captured images, and the horizontal axis represents the image frame index. It can be expected that, if the accelerometer in the person's tag device records the acceleration measurement during the person's walking, the magnitude of the acceleration will be high when the person is walking, and when the person is stationary, the magnitude of the acceleration is small. Correlating the acceleration measurement with FFC observation made from captured images thus allows the system 100 to establish FFC-tag association with high reliability.

Mapping an FFC from the 2D image coordinate system into the 3D physical world coordinate system may be sensitive to noise and errors in analyzation of captured images and FFC detection. For example, mapping the BBTP and/or the centroid of an FFC to the 3D physical world coordinate system of the site may be sensitive to errors such as the errors in determining the BBTP and centroid due to poor processing of shadows; mobile objects may occlude each other; specular lighting results in shadow distortions that may cause more errors in BBTP and centroid determination. Such errors may cause the perspective mapping from a captured image to the 3D physical world coordinate system of the site noisy, and even unreliable in some situations.

Other mobile object tracking methods using imaging devices exploit the fact that the motions of mobile objects are generally smooth across a set of consecutively captured images, to improve the tracking accuracy.

With the recognition that perspective mapping may introduce errors, in one embodiment, no perspective mapping is conducted and the computer vision processing block 146 tracks FFCs in the 2D image coordinate system. The advantage of this embodiment is that the complexity and ambiguities of the 2D to 3D perspective mapping is avoided. However, the disadvantage is that the object morphing as the object moves in the camera FOV may give rise to errors in object tracking. Modelling object morphing may alleviate the errors caused therefrom, but it requires additional random variables for unknown parameters in the modelling of object morphing or additional variables as ancillary state variables, increasing the system complexity.

In another embodiment, the computer vision processing block 146 uses an extended Kalman filter (EKF) to track mobile objects using the FFCs detected in the captured image streams. When ambiguity occurs, the computer vision processing block 146 requests candidate tag devices to provide tag measurements to resolve the ambiguity. In this embodiment, the random state variables of the EKF are the x- and y-coordinates of the mobile object in the 3D physical world coordinate system following a suitable random motion model such as a random walk model if the mobile object is in a relatively open area, or a more deterministic motion model with random deviation around a nominal velocity if the mobile object is in a relatively directional area, e.g., as a hallway.

Following the EKF theory, observations are made on discrete time steps, each time step corresponds to a captured image. Each observation is the BBTP of the corresponding FFC in a captured image. In other words, the x- and y-coordinates of the mobile object in the 3D physical world coordinate system are mapped to the 2D image coordinate system, and the compared with the BBTP using EKF for predicting the motion of the mobile object.

Mathematically, the random state variables, collectively denoted as a state vector, for the n-th captured image of a set of consecutively captured images is:

sₙ=[x_{w,n},y_{w,n}]^{T}, (6)

where [•] represents a matrix, and [•]^{T} represents matrix transpose. The BBTP of corresponding FFC is thus the observation of sₙ in captured images.

In the embodiment that the motion of the mobile object is modelled as random walk, the movement of each mobile object is modelled as an independent first order Markov process with a state vector of sₙ. Each captured image corresponds to an iteration of the EKF, wherein a white or Gaussian noise is added to each component x_{w,n}, y_{w,n} of sₙ. The state vector sₙ is then modelled based on a linear Markov Gaussian model as:

sₙ=Asₙ₋₁+Buₙ, (7)

with
and uₙ being a Gaussian vector with the update covariance of

$${Q}_{u} = E [ {u}_{n} {u}_{n}^{T} ] = [ \begin{matrix}{σ}_{u}^{2} & 0 \\ 0 & {σ}_{u}^{2}\end{matrix} ] . \qquad ( 8 )$$

In other words, the linear Markov Gaussian model may be written as:

$$\begin{matrix}\{ \begin{matrix}{x}_{w , n} = {x}_{w , n - 1} + {u}_{x , n} \\ {y}_{w , n} = {y}_{w , n - 1} + {u}_{y , n}\end{matrix} & ( 9 ) \\ where & \\ [ \begin{matrix}{u}_{x , n} \\ {u}_{y , n}\end{matrix} ] ∼ N ( [ \begin{matrix}0 \\ 0\end{matrix} ] , [ \begin{matrix}{σ}_{u}^{2} & 0 \\ 0 & {σ}_{u}^{2}\end{matrix} ] ) , & ( 10 )\end{matrix}$$

i.e., each of u_{x,n} and u_{y,n} is a zero-mean normal distribution with a standard deviation of σᵤ.

Equation (7) or (9) gives the state transition function. The values of matrix A and B in Equation (7) depends on the system design parameters and the characteristics of the site 102. In this embodiment,

$$A = B = [ \begin{matrix}1 & 0 \\ 0 & 1\end{matrix} ] , \qquad ( 11 )$$

The state vector sₙ is mapped to a position vector [x_{c,n}, y_{c,n}]^{T} in the 2D image coordinate system of the capture image using perspective mapping (equations (1) to (3)), i.e.,

$$\begin{matrix}[ \begin{matrix}{f}_{x , n} \\ {f}_{y , n} \\ {f}_{v , n}\end{matrix} ] = H [ \begin{matrix}{x}_{w , n} \\ {y}_{w , n} \\ 1\end{matrix} ] , & ( 12 ) \\ {x}_{c , n} = \frac{{f}_{x , n}}{{f}_{v , n}} , & ( 13 ) \\ {y}_{c , n} = \frac{{f}_{y , n}}{{f}_{v , n}} , & ( 14 )\end{matrix}$$

Then, the observation, i.e., the position of the BBTP in the 2D image coordinate system, can be modelled as:

zₙ=h(sₙ)+wₙ, (15)

where zₙ=[z₁, z₂]^{T} is the coordinates of the BBTP with z₁ and z₂ representing the x- and y-coordinates thereof,

$$h ( {s}_{n} ) = [ \begin{matrix}{h}_{x} ( {s}_{n} ) \\ {h}_{y} ( {s}_{n} )\end{matrix} ] = [ \begin{matrix}{x}_{c , n} \\ {y}_{c , n}\end{matrix} ] = [ \begin{matrix}{f}_{x , n} / {f}_{v , n} \\ {f}_{y , n} / {f}_{v , n}\end{matrix} ] \qquad ( 16 )$$

is a nonlinear perspective mapping function, which may be approximated using a first order Talylor series thereof, and

$${w}_{n} = [ \begin{matrix}{w}_{x , n} \\ {w}_{y , n}\end{matrix} ] ∼ N ( [ \begin{matrix}0 \\ 0\end{matrix} ] , [ \begin{matrix}{σ}_{z}^{2} & 0 \\ 0 & {σ}_{z}^{2}\end{matrix} ] ) , \qquad ( 17 )$$

i.e., each of the x-component w_{x,n} and the y-component w_{y,n} of the noise vector wₙ is a zero-mean normal distribution with a standard deviation of σ_{z}.

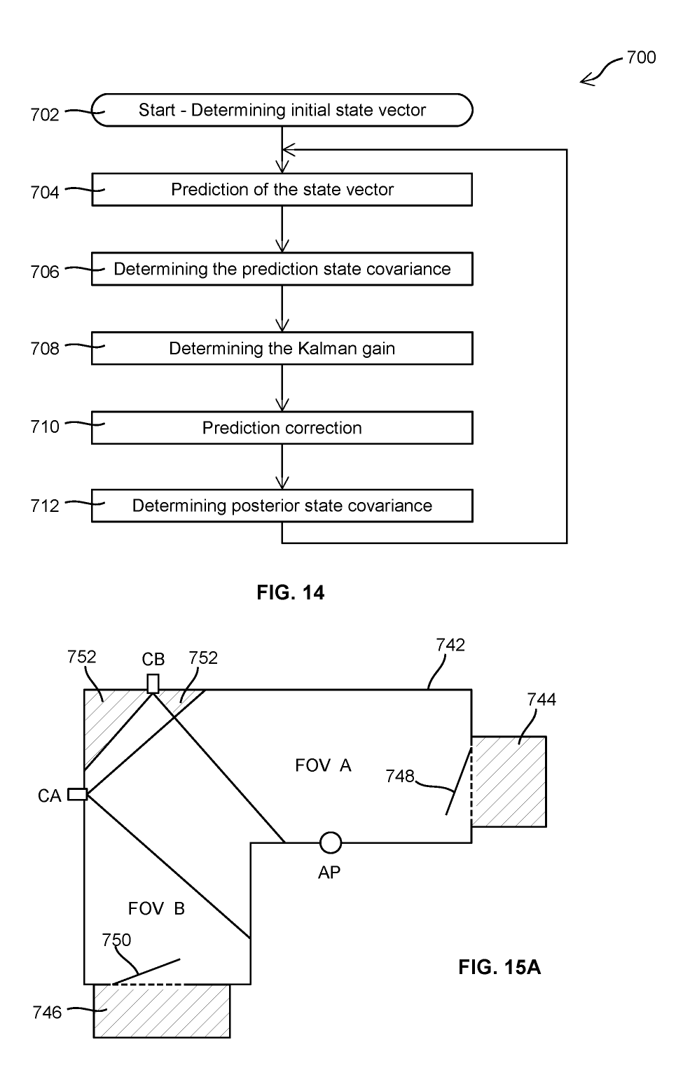

The EKF can then be started with the state transition function (7) and the observation function (15). FIG. 14 is a flowchart 700 showing the steps of mobile object tracking using EKF.

At step 702, to start the EKF, the initial state vector s(0|0) and the corresponding posteriori state covariance matrix, M(0|0), are determined. The initial state vector corresponds to the location of a mobile object before the imaging device captures any image. In this embodiment, if the location of a mobile object is unknown, its initial state vector is set to be at the center of the FOV of the imaging device with a zero velocity, and the corresponding posteriori state covariance matrix M(0|0) is set to a diagonal matrix with large values, which will force the EKF to disregard the initial information and base the first iteration entirely on the FFCs detected in the first captured image. On the other hand, if the location of a mobile object is unknown, e.g., via a RFID device at an entrance as described above, the initial state vector s(0|0) is set to the known location, and the corresponding posteriori state covariance matrix M(0|0) is set to a zero matrix (a matrix with all elements being zero).

At step 704, a prediction of the state vector is made:

s(n|n−1)=s(n−1|n−1). (18)

At step 706, the prediction state covariance is determined:

$$\begin{matrix}M ( n \vert n - 1 ) = M ( n - 1 \vert n - 1 ) + {Q}_{u} & ( 19 ) \\ where & \\ {Q}_{u} = [ \begin{matrix}{σ}_{u}^{2} & 0 \\ 0 & {σ}_{u}^{2}\end{matrix} ] . & ( 20 )\end{matrix}$$

At step 708, the Kalman gain is determined:

K(n)=M(n|n−1)H(n)^{T}(H(n)M(n|n−1)H(n)^{T}+Q_{w})⁻¹ (21)

where H(n) is the Jacobian matrix of h(s(n|n−1)),

$$H ( n ) = [ \begin{matrix}\frac{\partial {h}_{x} ( s ( n \vert n - 1 ) )}{\partial {x}_{w , n}} & \frac{\partial {h}_{x} ( s ( n \vert n - 1 ) )}{\partial {y}_{w , n}} \\ \frac{\partial {h}_{y} ( s ( n \vert n - 1 ) )}{\partial {x}_{w , n}} & \frac{\partial {h}_{y} ( s ( n \vert n - 1 ) )}{\partial {y}_{w , n}}\end{matrix} ] \qquad ( 22 )$$

At step 710, prediction correction is conducted. The prediction error is determined based on difference between the predicted location and the BBTP location in the captured image:

$${\tilde{z}}_{n} = [ \begin{matrix}{z}_{1 , n} \\ {z}_{2 , n}\end{matrix} ] - h ( s ( n \vert n - 1 ) ) . \qquad ( 23 )$$

Then, the updated state estimate is given as:

s(n|n)=s(n|n−1)+K(n)\tilde{z}ₙ. (24)

At step 712, the posterior state covariance is calculated as:

M(n|n)=(I−K(n)H(n))M(n|n−1), (25)

with I representing an identity matrix.

An issue of using the random walk model is that mobile object tracking may fail when the object is occluded. For example, if a mobile object being tracked is occluded in the FOV of the imaging device, the EKF would receive no new observations from consequent images. The EKF tracking would then stop at the last predicted state, which is the state determined in the previous iteration, and the Kalman gain will go instantly to zero (0). The tracking thus stops.

This issue can be alleviated by choosing a different 2D model of pose being a random walk model and using the velocity magnitude (i.e., the speed) as an independent state variable. The speed will also be a random walk but with a tendency towards zero (0), i.e., if no observations are made related to speed then it will exponentially decay towards zero (0).

Now consider the EKF update when the object is suddenly occluded such that there are no new measurements. In this case speed state will slowly decay towards zero with settable decay parameter, but generally with high probability. When the object emerges from the occlusion, it would not be too far from the EKF tracking point such that, with the restored measurement quality, accurate tracking can resume. The velocity decay factor used in this model is heuristically set based on the nature of the moving objects in the FOV. For example, if the mobile objects being tracked are travelers moving in an airport gate area, the change in velocity of bored travelers milling around killing time will be higher and less predictable than people walking purposively down a long corridor. As each imaging device is facing an area with known characteristics, model parameters can be customized and refined according to the known characteristics of the area and past experience.

Those skilled in the art appreciate that the above EKF tracking is merely one example of implementing FFC tracking, and other tracking methods are readily available. Moreover, as FFC tracking is conducted in the computer cloud 108, the computational cost is generally of less concern, and other advanced tracking methods, such as Bayesian filters, can be used. If the initial location of a mobile object is accurately known, then a Gaussian kernel may be used. However, if a mobile object is likely in the FOV but its initial location of is unknown, a particle filter (PF) may be used, and once the object becomes more accurately tracked, the PF can be switched to an EKF for reducing computational complexity. When multiple mobile objects are continuously tracked, computational resources can be better allocated by dynamically switching object tracking between PF and EKF, i.e., using EKF to track the mobile objects that have been tracked with higher accuracy, and using PF to track the mobile objects not yet being tracked, or being tracked but with low accuracy.

A limitation of the EKF as established earlier is that the site map is not easily accounted for. Neither are the inferences which are only very roughly approximated as Gaussian as required for the EKF.

In an alternative embodiment, non-parametric Bayesian processing is used for FFC tracking by leveraging the knowledge of the site.

In this embodiment, the location of a mobile object in room 742 is represented by a two dimensional probability density function (PDF) p_{x,y}. If the area in the FOV of an imaging device is finite with plausible boundaries, the area is discretized into a grid, and each grid point is considered to be a possible location for mobile objects. The frame rates of the imaging devices are sufficiently high such that, from one captured image to the next, a mobile object would appear therein either stay at the same grid point or move from a grid point to an adjacent grid point.

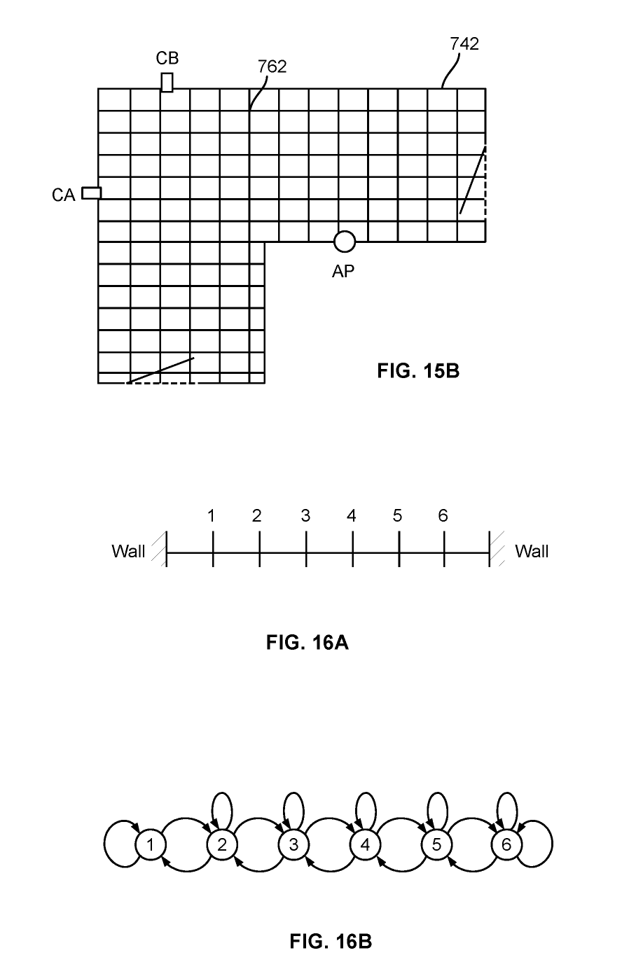

FIG. 15A shows an example of two imaging devices CA and CB with overlapping FOVs covering an L-shaped room 742. As shown, the room 742 is connected to rooms 744 and 746 via doors 748 and 750, respectively. Rooms 744 and 746 are uncovered by imaging devices CA and CB. Moreover, there exist areas 752 uncovered by both CA and CB. An access point (AP) is installed in this room 742 for sensing tag devices using RSS measurement.

When a mobile object having a tag device enters room 742, the RSS measurement indicates that a tag device/mobile object is in the room. However, before processing any captured images, the location of the mobile device is unknown.

As shown in FIG. 15B, the area of the room 742 is discretized into a grid having a plurality of grid points 762, each representing a possible location for mobile objects. In this embodiment, the distance between two adjacent grid points 762 along the x- or y-axis is a constant. In other words, each grid point may be expressed as: (iΔx, jΔy) with Δx and Δy being constants and i and j being integers. Δx and Δy are design parameters that depend on the application and implementation.

The computer vision processing block 146 also builds a state diagram of the grid points described the transition of a mobile object from one grid point to another. The state diagram of the grid points is generally a connected graph whose properties change with observations made from the imaging device and the tag device. A state diagram for room 742 would be too complicated to show herein. For ease of illustration, FIG. 16A shows an imaginary, one-dimensional room partitioned to 6 grid points, and FIG. 16B shows the state diagram for the imaginary room of FIG. 16A. In this example, the walls are considered reflective, i.e., a mobile object in grid point 1 can only choose to stay therein or move to grid point 2, and a mobile object in grid point 6 can only choose to stay therein or move to grid point 5.

Referring back to FIGS. 15A and 15B, as the room 742 is discretized into a plurality of grid points 762, the computer vision processing block 146 associates a belief probability with each grid point as the possibility that the mobile object to be tracked is at that point. The computer vision processing block 146 then considers that the motion of mobile objects follows a first order Markov model, and uses a Minimum Mean Square Error (MMSE) location estimate method to track the mobile object.

Let p_{i,j}^{t} denote the location probability density function (pdf) or probability mass function (pmf) that the mobile object is at the location (iΔx, jΔy) at the time step t. Initially, if the location of the mobile object is unknown, the location pdf p_{i,j}^{t} is set to be uniform over all grid points, i.e.,

$${p}_{i , j}^{0} = \frac{1}{XY} , for i = 1 , … , X , and j = 1 , … , Y \qquad ( 26 )$$

where X is the number of grid points along the x-axis and Y is the number of grid points along the y-axis.

Based on the Markov model, p_{i,j}^{t} is only dependent on the previous probability p_{i,j}^{t-1}, the current update and the current BBTP position z^{t}, p_{i,j}^{t} may be computed using a numerical procedure. The minimum variance estimate of the mobile object location is then based on the mean of this pdf.

From one time step to the next, the mobile object may stay at the same grid point or move to one of the adjacent grid points, each of which is associated with a transition probability. Therefore, the expected (i.e., not yet compared with any observations) transition of the mobile object from time step t to time step t+1, or equivalently, from time step t−1 to time step t, may be described by a transition matrix consisting of these transition probabilities:

pᵤ^{t}=Tp^{t-1}, (27)

where pᵤ^{t} is a vector consisting of expected location pdfs at time step t, p^{t-1} is a vector consisting of the location pdfs p_{i,j}^{t} at time step t−1, and T is the state transition matrix.

Matrix T describes the probabilities that mobile object transiting from one grid point to another. Matrix T describes boundary conditions, including reflecting boundaries and absorbing boundaries. A reflecting boundary such as a wall means that a mobile object has to turn back when approaching the boundary. An absorbing boundary such as a door means that a mobile object can pass therethrough, and the probability of being in the area diminishes accordingly.

When an image of the area 742 is captured and a BBTP is determined therein, the location of the BBTP is mapped via perspective mapping to the 3D physical world coordinate system of the area 742 as an observation. Such an observation may be inaccurate, and its pdf, denoted as p_{BBTP,i,j}^{t}, may be modelled as a 2D Gaussian distribution.

Therefore, the location pdfs p_{i,j}^{t}, or the matrix p^{t} thereof, at time step t may be updated from that at time step t−1 and the BBTP observation as:

p^{t}=ηp_{BBTP}^{t}Tpᵤ^{t-1}, (28)

where p_{BBTP}^{t} is a vector of p_{BBTP,i,j}^{t} at time step t, and n is a scaler to ensure the updated location pdf p_{i,j}^{t} can be added to one (1).

Equation (28) calculates the posterior location probability pdf p^{t} based on the BBTP data obtained from the imaging device. The peak or maximum of the updated pdf p_{i,j}^{t}, or p^{t} in matrix form, indicates the most likely location of the mobile object. In other words, if the maximum of the updated pdf p_{i,j}^{t} is at i=iₖ and j=jₖ, the mobile object is most likely at the grid point (iₖΔx, jₖΔy). With more images being captured, the mobile location pdf p_{i,j}^{t} is further updated using equation (28) to obtain updated estimate of the mobile object location.

With this method, if the BBTP is of high certainty then the posterior location probability pdf p^{t} quickly becomes a delta function, giving rise to high certainty of the location of the mobile object.

For example, if a mobile object at (iΔx, jΔy) is static from time step t=1 to time step t=k, then equation (28) becomes

$${p}_{i , j}^{t} = η {\prod }_{t = 1}^{k} {p}_{BBTP , i , j}^{t} {p}_{i , j}^{0} , \qquad ( 29 )$$

which becomes a “narrow spike” with the peak at (i,j) after several iterations, and the variance of the MMSE estimate of the object location diminishes.

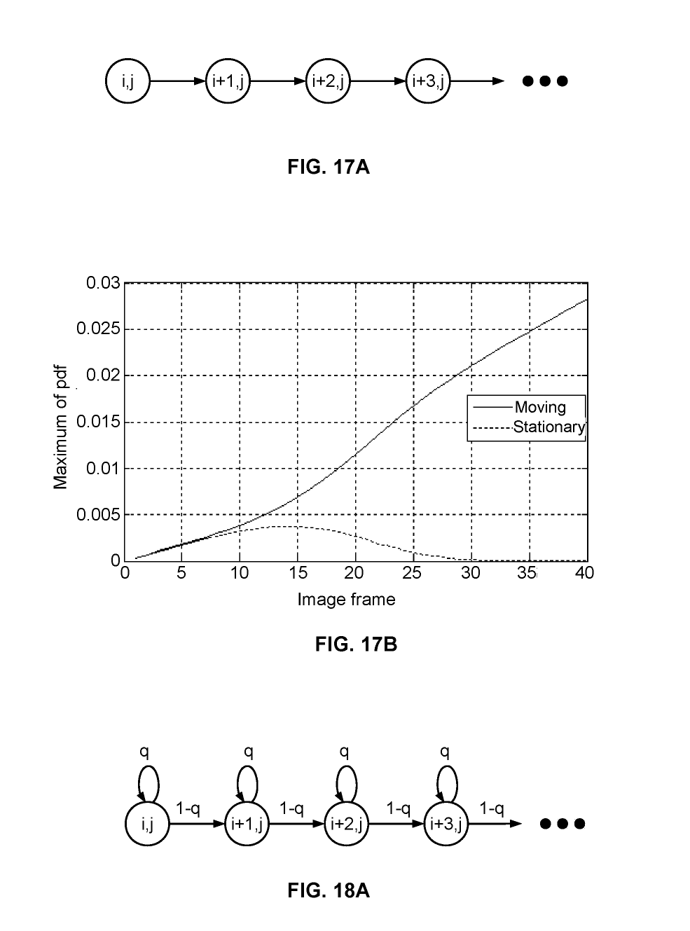

FIGS. 17A and 17B show a deterministic example, where a mobile object is moving to the right hand side along the x-axis in the FOV of an imaging device. FIG. 17A is the state transition diagram, showing that the mobile object is moving to the right with probability of one (1). The computer vision processing block 146 tests the first assumption that the mobile object is stationary and the second assumption that the mobile object is moving, by using a set of consecutively captured image frames and equation (28). The test results are show in FIG. 17B. As can be seen, while at first several image frames or iterations, both assumptions show similar likelihood, the assumption of a stationary object quickly diminishes to zero probability but the assumption of a moving object grows to a much higher probability. Thus, the computer vision processing block 146 can decide that the object is moving, and may request candidate tag devices to provide IMU measurements for establishing FFC-tag association.

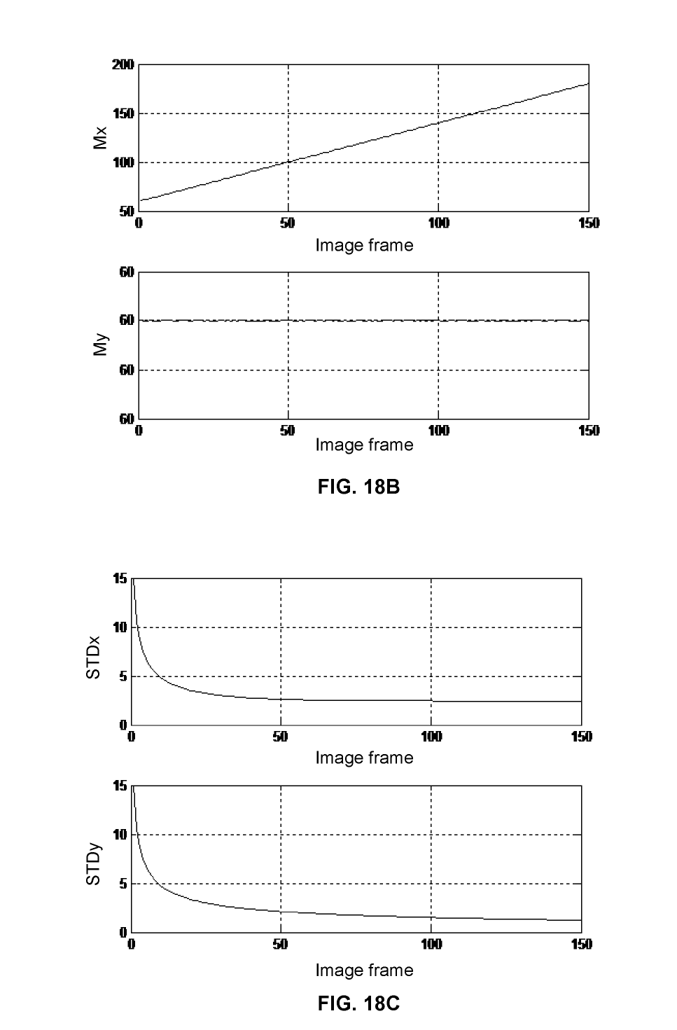

FIGS. 18A to 18E show another example, where a mobile object is slewing, i.e., moving with uncertainty, to the right hand side along the x-axis in the FOV of an imaging device. FIG. 18A is the state transition diagram, showing that, in each transition from one image to another, the mobile object may stay at the same grid point with a probability of q, and may move to the adjacent grid point on the right hand side with a probability of (1−q). Hence the average slew velocity is:

$${v}_{avg} = ( 1 - q ) \frac{Δ x}{Δ t} . \qquad ( 30 )$$

FIGS. 18B and 18C show the tracking results using equation (28) with q=0.2. FIG. 18B shows the mean of x- and y-coordinates of the mobile object, which accurately tracked the movement of the mobile object. FIG. 18C shows the standard deviation (STD) of x- and y-coordinates of the mobile object, denoted as STDx and STDy. As can be seen, both STDx and STDy start with a high value (because the initial location PDF is uniformly distributed). STDy quickly reduced to about zero (0) because, in this example, no uncertainty exists along the y-axis during mobile object tracking. STDx quickly reduced from a large initial value to a steady state with a low but non-zero probability due to the non-zero probability q.

Other grid based tracking methods are also readily available. For example, instead of using a Gaussian model for the BBTP, a different model designed with consideration of the characteristics of the site, such as its geometry, lighting and the like, and the FOV of the imaging device may be used to provide accurate mobile object tracking.

In above embodiment, the position (x, y) of the mobile object is used as the state variables. In an alternative embodiment, the position (x, y) and the velocity (vₓ, v_{y}) of the mobile object are used as the state variables. In yet another embodiment, speed and pose may be used as state variables.

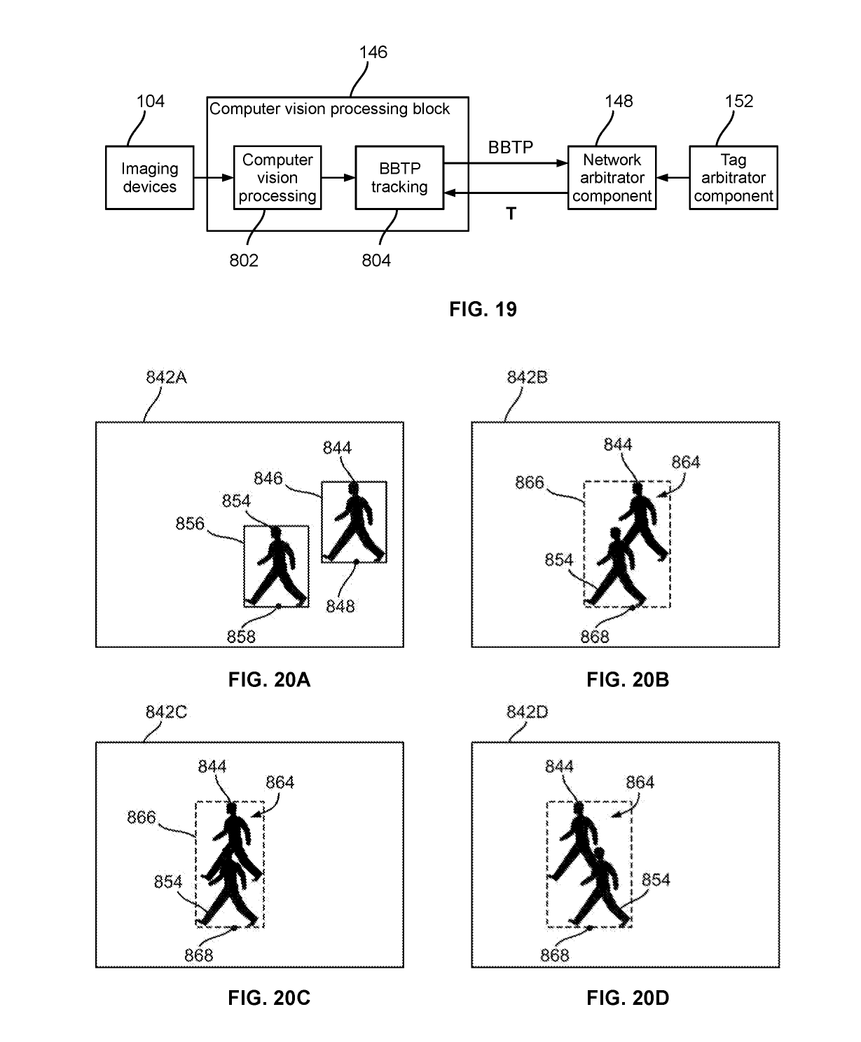

In above embodiments, the state transition matrix T is determined without assistance of any tag devices. In an alternative embodiment, the network arbitrator component 148 requests tag devices to provide necessary tag measurement for assistance in determining the state transition matrix T. FIG. 19 is a schematic diagram showing the data flow for determining the state transition matrix T. The computer vision processing block uses computer vision technology to process (block 802) images captured from imaging devices 104, and tracks (block 804) FFC using above described BBTP based tracking. The BBTPs are sent to the network arbitrator component 148, and the network arbitrator component 148 accordingly requests tag arbitrator components 146 to provide necessary tag measurements. A state transition matrix T is then generated based on obtained tag measurements, and is sent to the computer vision processing block 146 for mobile object tracking.

The above described mobile object tracking using a first order Markov model and grid discretization is robust and computationally efficient. Ambiguity caused by object merging/occlusion may be resolved using a prediction-observation method (described later). Latency in mobile object tracking (e.g., due to the computational load) is relatively small (e.g., several seconds), and is generally acceptable.

The computer vision processing structure 146 provides information regarding the FFCs observed and extracts attributes thereof, including observables such as the bounding box around the FFC, color histogram, intensity, variations from one image frame to another, feature points within the FFC, associations of adjacent FFCs that are in a cluster and hence are part of the same mobile object, optical flow of the FFC and velocities of the feature points, undulations of the overall bounding box and the like. The observables of the FFCs are stored for facilitating, if needed, the comparison with tag measurements.

For example, the computer vision processing structure 146 can provide a measurement of activity of the bounding box of an FFC, which is used to compare with similar activity measurement obtained the tag device 114. After normalization a comparison is made resulting in a numerical value for the likelihood indicating whether the activity observed by the computer vision processing structure 146 and tag device 114 are the same. Generally a Gaussian weighting is applied based on parameters that are determined experimentally. As another example, the position of the mobile object corresponding to an FFC in the site, as determined via the perspective mapping or transformation from the captured image, and the MMSE estimate of the mobile object position can be correlated with observables obtained from the tag device 114. For instance, the velocity observed from the change in the position of a person indicates walking, and the tag device reveals a gesture of walking based on IMU outputs. However, such as gesture may be weak if the tag device is attached to the mobile object in such a manner that the gait is weakly detected, or may be strong if the tag device is located in the foot of the person. Fuzzy membership functions can be devised to represent the gesture. This fuzzy output can be compared to the computer vision analysis result to determine the degree of agreement or correlation of the walking activity. In some embodiments, methods based on fuzzy logic may be used for assisting mobile object tracking.

In another example, the computer vision processing structure 146 determines that the bounding box of an FFC has become stationary and then shrunk to half the size. The barometer of a tag device reveals a step change in short term averaged air pressure commensurate with an altitude change of about two feet. Hence the tag measurement from the tag device's barometer would register a sit down gesture of the mobile object. However, due to noise and barometer drift as well as spurious changes in room air pressure the gesture is probabilistic. The system thus correlates the tag measurement and computer vision analysis result, and calculates a probability representing the degree of certainty that the tag measurement and computer vision analysis result match regarding the sitting activity.

With above examples, those skilled in the art appreciate that, the system determines a degree of certainty of a gesture or activity based on the correlation between the computer vision (i.e., analysis of captured images) and the tag device (i.e., tag measurements). The set of such correlative activities or gestures are then combined and weighted for calculating the certainty, represented by a probability number, that the FFC may be associated with the tag device.

Object Merging and Occlusion

Occlusion may occur between mobile objects, and between a mobile object and a background object. Closely positioned mobile objects may be detected as a single FFC.

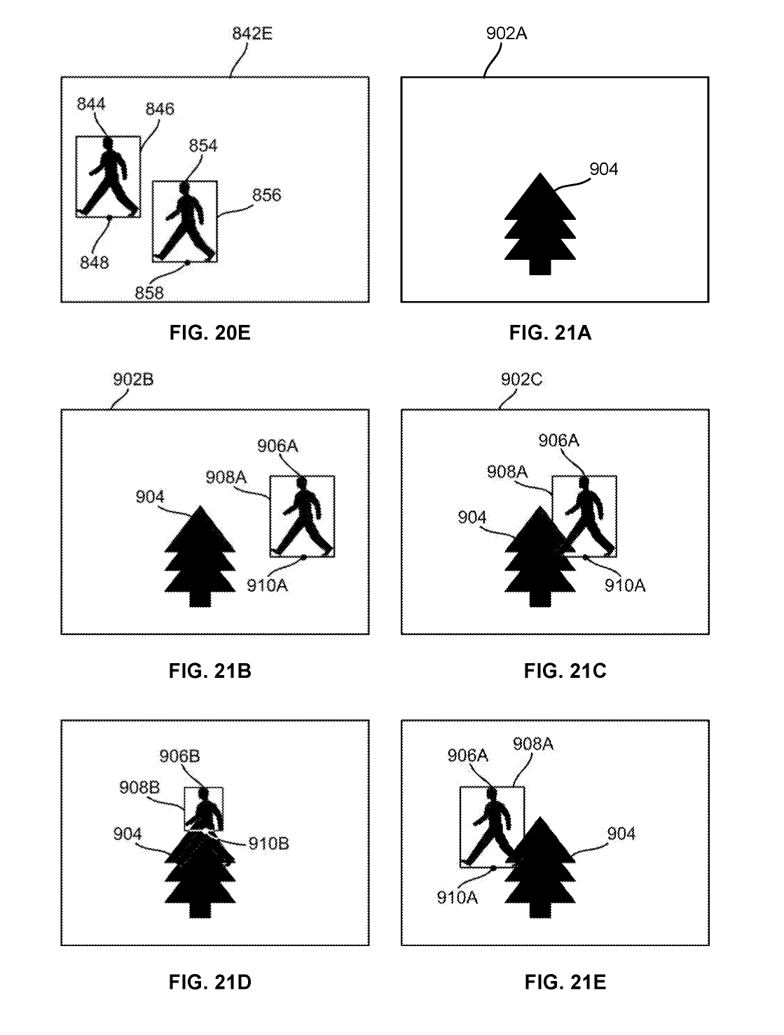

FIGS. 20A to 20E show an example of merging/occlusion of two mobile objects 844 and 854. As shown in FIG. 20A, the two mobile objects 844 and 854 are sufficiently apart and they show in a captured image 842A as separate FFCs 844 and 854, having their own bounding box 846 and 856 and BBTPs 848 and 858, respectively.

As shown in FIGS. 20B to 20D, when mobile objects 844 and 854 are moving close to each other, they are detected as a single FFC 864 with a bounding box 866 and a BBTP 868. The size of the single FFC 854 may vary depending the occlusion between the two mobile objects and/or the distance therebetween. Ambiguity may occur as it may appear that the two previously detected mobile objects 844 and 854 disappear with a new mobile object 864 appearing at the same location.

As shown in FIG. 20E, when the two mobile objects have moved apart with sufficient distance, two FFCs are again detected. Ambiguity may occur as it may appear that the previously detected mobile object 864 disappears with two new mobile objects 844 and 854 appearing at the same location.

FIGS. 21A to 21E show an example that a mobile object is occluded by a background object.

FIG. 21A shows a background image 902A having a tree 904 therein as a background object.

A mobile object 906A is moving towards the background object 904, and passes the background object 904 from behind. As shown in FIG. 21B, in the captured image 902B, the mobile object 906A is not yet occluded by the background object 904, and the entire image of mobile object 906 is detected as an FFC 906A with a bounding box 908A and a BBTP 910A. In FIG. 21C, the mobile object 906A is slightly occluded by the background object 904 and the FFC 906A, bounding box 908A and BBTP 910A are essentially the same as those detected in the image 902B (except position difference).

In FIG. 21D, the mobile object is significantly occluded by the background object 904. The detected FFC 906B is now significantly smaller that the FFC 906A in images 902B and 902C. Moreover, the BBTP 910B is at a much higher position than 910A in images 902B and 902C. Ambiguity may occur as it may appear that the previously detected mobile object 906A disappears and a new mobile object 906B appears at the same location.

As shown in FIG. 21E, when the mobile object 906A walks out of the occlusion of the background object 904, a “full” FFC 906A much larger than FFC 906B is detected. Ambiguity may occur as it may appear that the previously detected mobile object 906B disappears and a new mobile object 906A appears at the same location.

As described before, the frame rate of the imaging device is sufficiently high, and the mobile object movement is therefore reasonably smooth. Then, ambiguity caused by object merging/occlusion can be resolved by a prediction-observation method, i.e., predicting the action of the mobile object and comparing the prediction with observation obtained from captured images and/or tag devices.

For example, the mobile object velocity and/or trajectory may be used as random state variables, and above described tracking methods may be used for prediction. For example, the system may predict the locations and time instants that a mobile object may appear during a selected period of future time, and monitor the FFCs during the selected period of time. If the FFCs appear to largely match the prediction, e.g., the observed velocity and/or trajectory highly correlated with the prediction (e.g., their correlation higher than a predefined or dynamically set threshold), then the FFCs are associated with the same tag device even if in some moments/images abnormity of FFC occurred, such as size of the FFC significantly changed, BBTP significantly moved off the trajectory, FFC disappeared or appeared, and the like.

If the ambiguity cannot be resolved solely from captured images, tag measurements may be requested to obtain further observation to resolve the ambiguity.

### VII. Some Alternative Embodiments

In an alternative embodiment, the system 100 also comprises a map of magnetometer abnormalities (magnetometer abnormality map). The system may request tag devices having magnetometers to provide magnetic measurements and compare with the magnetometer abnormality map for tracking resolving ambiguity occurred during mobile object tracking.

In above embodiments, tag devices 114 comprise sensors for collecting tag measurements, and tag devices 114 transmit tag measurements to the computer cloud 108. In some alternative embodiments, at least some tag devices 114 may comprise a component broadcasting, continuously or intermittently, a detectable signal. Also, one or more sensors for detecting such detectable signal are deployed in the site. The one or more sensors detect the detectable signal and obtain measurements of one or more characteristics of the tag device 114, and transit the obtained measurements to the computer cloud 108 for establishing FFC-tag association and resolving ambiguity. For example, in one embodiment, each tag device 114 may comprise an RFID transmitter transmitting an RFID identity, and one or more RFID readers are deployed in the site 102, e.g., at one or more entrances, for detecting the RFID identity of the tag devices in proximity therewith. As another example, each tag device 114 may broadcast a BLE beacon. One or more BLE access points may be deployed in the site 102, detecting the BLE beacon of a tag device, and determine an estimated location using RSS. The estimated location, although inaccurate, may be transmitted to the computer cloud for establishing FFC-tag association and resolving ambiguity.

### VIII. Visual Assisted Indoor Location System (VAILS)

In an alternative embodiment, a Visual Assisted Indoor Location System (VAILS) is modified from the above described systems and used for tracking mobile objects in a site being a complex environment such as an indoor environment.

VIII-1. VAILS System Structure

Similar to the systems described above, the VAILS in this embodiment uses imaging devices, e.g., security camera, and, if necessary, tag devices for tracking mobile objects in an indoor environment such as a building. Again, the mobile objects are entities moving or stationary in the indoor environment. At least some mobile objects are each associated with a mobile tag device such that the tag device generally undergoes the same activity as the mobile object it is associated therewith. Hereinafter, such mobile objects associated with tag devices are sometimes denoted as tagged objects, and objects with no tag devices are sometimes denoted as untagged objects. While untagged objects may exist in the system, both tagged and untagged objects may be jointly tracked for higher reliability.

While sharing many common features with the systems described above, VAILS faces more tracking challenges such as identifying mobile objects more often entering and exiting the FOV of an imaging device and more often being occluded by background objects (e.g., poles, walls and the like) and/or other mobile objects, causing ambiguity.

In this embodiment, VAILS maintains a map of the site, and builds a birds-eye view of a building floor-space view generally, by recording the locations of mobile objects onto the map. Conveniently, the system comprises a birds-eye view processing sub-module (as a portion of a camera view processing and birds-eye view processing module, described below) for maintaining the birds-eye view of the site (denoted the “birds-eye view (By)” hereinafter for ease of description) and for updating the locations of mobile objects therein based on the tracking results. Of course, such a birds-eye view module may be combined with any other suitable module(s) to form a single module have the combined functionalities.

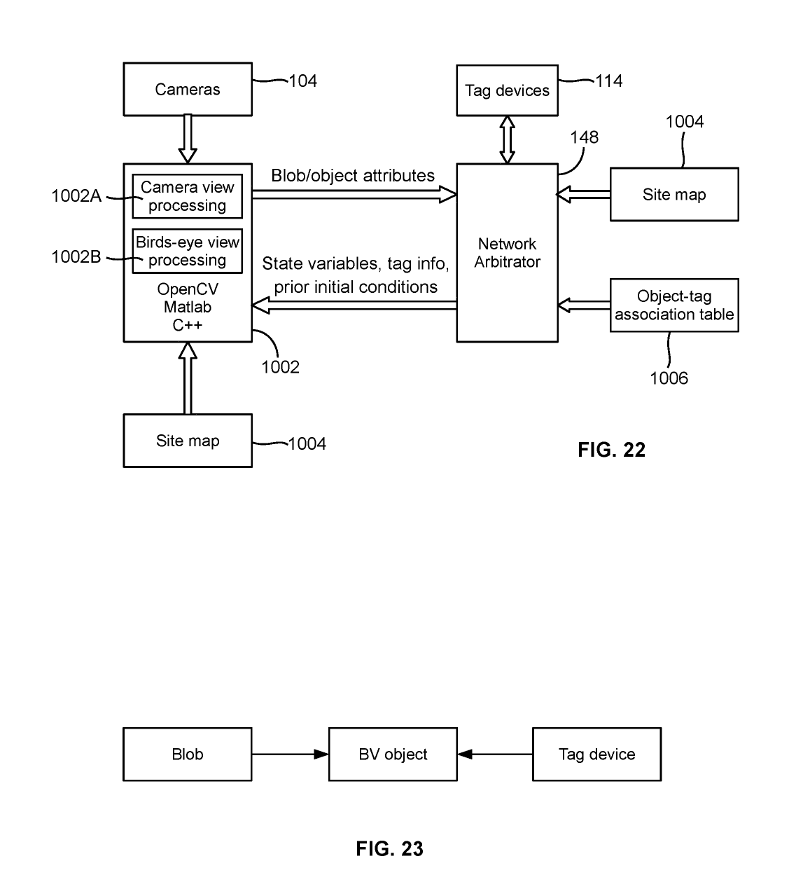

The software and hardware structures of VAILS are similar to those of the above described systems. FIG. 22 shows a portion of the functional structure of VAILS, corresponding to the computer cloud 108 of FIG. 2. As shown, the computer vision processing module 108 of FIG. 2 is replaced with a camera view processing and birds-eye view processing (CV/BV) module 1002, having a camera view processing submodule 1002A and a birds-eye view processing submodule 1002B. The submodules are implemented using suitable programming languages and/or libraries such as the OpenCV open-source computer vision library offered by opencv.org, MATLAB® offered by MathWorks, C++, and the like. Those skilled in the art appreciate that MATLAB® may be used for prototyping and simulation of the system, and C++ and/or OpenCV may be used for implementation in practice. Hereinafter, the term “computer vision processing” is equivalent to the phrase “camera view processing” as the computer vision processing is for processing camera-view images.

In some alternative embodiments, the camera view processing and birds-eye view processing submodules 1002A and 1002B may be two separate modules.

The camera view processing submodule 1002A receives captured image streams (also denoted as camera views hereinafter) from imaging devices 104, processes captured image streams as described above, and detects FFCs therefrom. The FFCs may also be denoted as camera view (CV) objects or blobs hereinafter.

The birds-eye view processing sub-module 1002B uses the site map 1004 to establish a birds-eye view of the site and to map each detected blob into the birds-eye view as a BV object. Each BV object thus represents a mobile object in the birds-eye view, and may be associated with a tag device. In other words, blobs are in captured images (i.e., in camera view) and BV objects are in the birds-eye view of the site.

As shown in FIG. 23, a blob is associated with a tag device via a BV object.

Of course, some BV objects may not be associated with any tag devices if their corresponding mobile object do not have any tag devices associated therewith.

Referring back to FIG. 22, the blob and/or BV object attributes are sent from the CV/BV module 1002 to the network arbitrator 148 for processing and solving any possible ambiguity.

Similar to the description above, the network arbitrator 148 may request tag devices 114 to report observations, and use observations received from tag devices 114 and the site map 1004 to solve ambiguity and associate CV objects with tag devices. The CV object/tag device associations are stored in a CV object/tag device association table 1006. Of course, the network arbitrator 148 may also use the established CV object/tag device associations in the CV object/tag device association table 1006 for solving ambiguity. As will be described in more detail later, the network arbitrator 148 also leverages known initial conditions in establishing or updating CV object/tag device associations.

After processing, the network arbitrator 148 sends necessary data, including state variables, tag device information, and known initial conditions (described later) to the CV/BV module 1002 for updating the birds-eye view.

In this embodiment, the data representing the birds-eye view and camera view are stored and processed in a same computing device. Such an arrangement avoids frequent data transfer (or, in some implementations, file transfer) between the birds-eye view and camera views that may otherwise be required. The CV/BV module 1002 and the network arbitrator 148, on the other hand, may be deployed and executed on separate computing devices for improving the system performance and for avoiding heavy computational load to be otherwise applied to a single computing device. As the data transfer between the CV/BV module 1002 and the network arbitrator 148 is generally small, deploying the two modules 1002 and 148 to separate computing devices would not lead to high data transfer requirement. Of course, in embodiments that multi-core or multi-processor computing devices are used, the CV/BV module 1002 and the network arbitrator 148 may be deployed on a same multi-processor computing device but executed as separate threads for improving the system performance.

One important characteristic of an indoor site is that the site is usually divided into a number of subareas, e.g., rooms, hallways, separated by predetermined structural components such as walls. Each subarea has one or more entrances and/or exits.

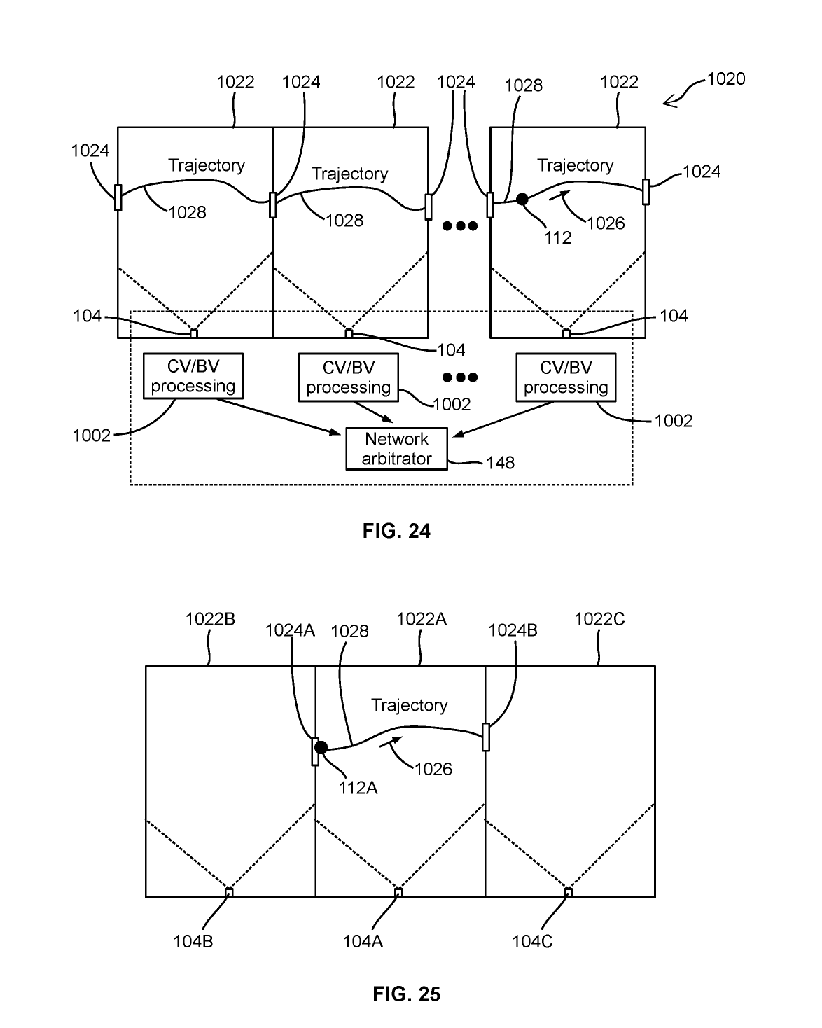

FIG. 24 is a schematic illustration of an example site 1020, which is divided into a number of rooms 1022, with entrances/exits 1024 connecting the rooms 1022. The site configuration, including the configuration of rooms, entrances/exits, predetermined obstacles and occlusion structures, is known to the system and is recorded in the site map. Each subarea 1022 is equipped with an imaging device 104. The FOV of each imaging device 104 is generally limited with the respective subarea 1022.

A mobile object 112 may walk from one subarea 1022 to another through the entrances/exits 1024, as indicated by the arrow 1026 and trajectory 1028. The cameras 104 in the subareas 1022 capture image streams, which are processed by the CV/BV processing module 1002 and the network arbitrator 148 for detecting the mobile object 112, mapping the detected mobile object 112 into a birds-eye view as a BV object, and determining the trajectory 1028 for tracking the mobile object 112.

When a “new” blob appears in the images captured by an imaging device 104, the system uses initial conditions that are likely related to the new blob to try to associate the new blob in the camera view with a BV object in the birds-eye view and with a mobile object (in the real world). Herein, the initial conditions include data already known by the system prior to the appearance of the new blob. Initial conditions may include data regarding tagged mobile devices, and may also include data regarding untagged devices.

For example, as shown in FIG. 25, a mobile object 112A enters room 1022A from the entrance 1024A and moves along the trajectory 1028 towards the entrance 1024B.

The mobile object 112A, when entering room 1022A, appears as a new blob (also referred using numeral 112A for ease of description) in the images captured by the imaging device 104A of room 1022A. As the new blob 112A appears at the entrance 1024A, it is likely that the corresponding mobile object originated from the adjacent room 1022B, sharing the same entrance 1024A with room 1022B.

As the network arbitrator 148 is tasked with overall process control and tracking the object using the camera view and tag device observations as input, the network arbitrator 148 in this embodiment has tracked the object outside of the FOV of the imaging device 104A (i.e., in room 1022B). Thus, in this example, when the mobile object 112A enters the FOV of the imaging device 104A, the network arbitrator 148 checks if there exists known data prior to the appearance of the new blob 112A regarding a BV object in room 1022B disappearing from the entrance 1024A. If the network arbitrator 148 finds such data, the network arbitrator 148 collects the found data as a set of initial conditions and sends them as an IC packet to the CV/BV processing module 1002, or in particular the camera view processing submodule 1002A, and requests the camera view processing submodule 1002A to track the mobile object 112A, which is now shown in the FOV of the imaging device 104A as a new blob 112A in room 1022A.

The CV/BV module 1002, or more particularly, the camera view processing submodule 1002A, continuously processes the image streams captured by the imaging device 104A for detecting blobs (in this example, the new blob 112A) and pruning detected blobs for to establishing a blob/BV object, or a blob/BV object/tag device association for the new blob 112A. For example, the blob 112A may exhibit in the camera view of imaging device 104A as a plurality of sub-blobs repeatedly separating and merging (fission and fusion) due to the imperfection of image processing. Such fission and fusion can be simplified by pruning. The knowledge of the initial conditions allows the camera view processing submodule 1002A to further prune and filter the blobs.

The pruned graph of blobs is then recorded in an internal blob track file (IBTF). The data in the IBTF records the history of each blob (denoted as a blob track), which may be used to construct a timeline history diagram such as FIG. 34 (described later), and is searchable by the birds-eye view processing submodule 1002B or network arbitrator 148. However, the IBTF contains no information that cannot be abstracted directly from the camera-view image frames directly. In other words, the IBTF does not contain any information from the network arbitrator 148 as initial conditions, nor any information from the birds-eye view fed back to the camera view. As described above, the camera view processing submodule 1002A processes captured images using background/foreground differentiation, morphological operations and graph based pruning, and detects foreground blobs representing mobile objects such as human objects, robots and the like. The camera view stores all detected and pruned blob tracks in the IBTF. Thus, the camera view processing submodule 1002A operates autonomously without feedback from the network arbitrator 148 acts as an autonomous sensor, which is an advantage in at least some embodiments. On the other hand, a disadvantage is that the camera view processing submodule 1002A does not benefit from the information of the birds-eye view processing submodule 1002B or network arbitrator 148.

The network arbitrator 148 tracks the tagged objects in a maximum likelihood sense, based on data from the camera view and tag sensors. Moreover, the network arbitrator 148 has detailed information of the site stored in the site map of the birds-eye view processing submodule 1002B. In the example of FIG. 25, the network arbitrator 148 puts together the initial conditions of the tagged object 112A entering the FOV of imaging device 104A, and requests the CV/BV processing module 1002 to track the object 112A. That is, the tracking request is sent from the network arbitrator 148 via the initial conditions.

The birds-eye view processing submodule 1002B parses the initial conditions and search for data of object 112A in the IBTF to start tracking thereof in room 1022A. When the birds-eye view processing submodule 1002B finds a blob or a set of sub-blobs that match the initial conditions, the birds-eye view processing submodule 1002B extracts the blob track data from the IBTF and places extracted blob track data into an external blob track file (EBTF). An EBTF record is generated for each request from the network arbitrator 148. In the example of FIG. 25, there is only one EBTF record as there is only one unambiguous object entering the FOV of imaging device 104A. However, if the birds-eye view processing submodule 1002B determines ambiguities resulting from other blob tracks then they can also be extracted into the EBTF.

In this embodiment, the system does not comprise any specific identifier to identify whether a mobile object is a human, a robot or another type of object, although in some alternative embodiments, the system may comprise such an identifier for facilitating object tracking.

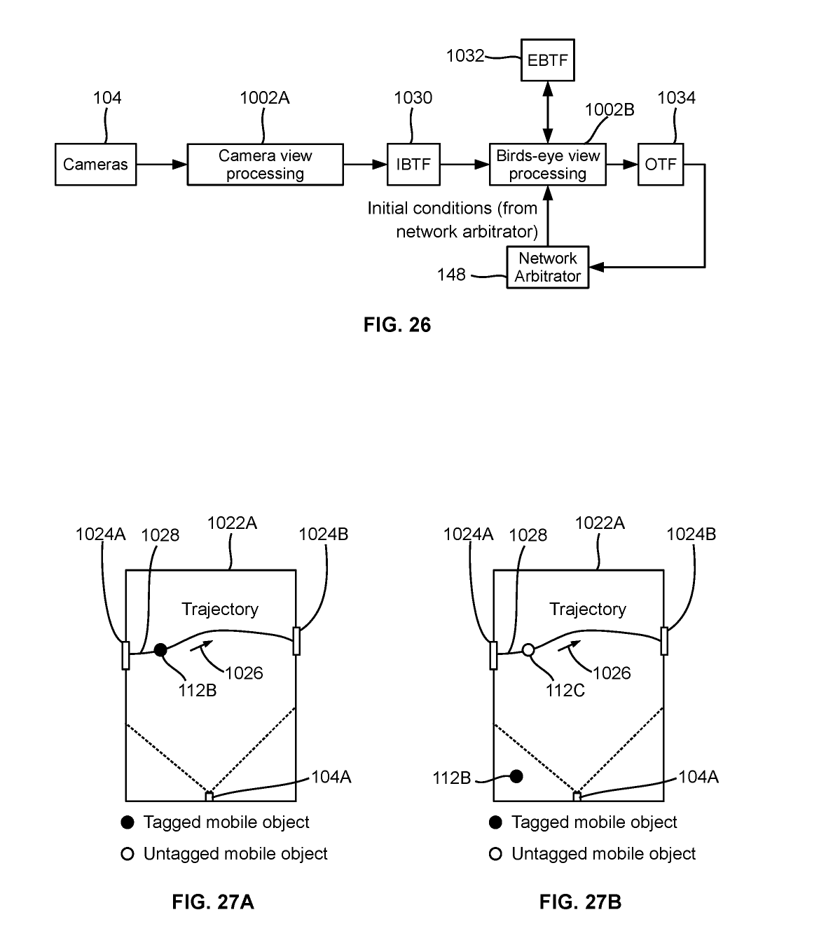

The birds-eye view processing module 1002B processes the request from the network arbitrator 148 to track the blob identified in the initial conditions passed from the network arbitrator 148. The birds-eye view processing module 1002B also processes the IBTF with the initial conditions and the EBTF. The birds-eye view processing module 1002B computes the perspective transformation of the blob in the EBTF and determines the probability kernel of where the mobile object is. The birds-eye view processing module 1002B also applies constraints of the subarea such as room dimensions, locations of obstructions, walls and the like, and determines the probability of the object 112A exiting the room 1022A coincident with a blob annihilation event in the EBTF. The birds-eye view processing module 1002B divides the subarea into a 2D floor grid as describe before, and calculates a 2D floor grid probability as a function of time, stored in an object track file (OTF). The OTF is then made available to the network arbitrator 148. The data flow between the imaging device 104A, camera view processing submodule 1002A, IBTF 1030, birds-eye view processing submodule 1002B, the network arbitrator 148, EBTF 1034 and OTF 1034 is shown in FIG. 26.

The above described process is an event driven process and is updated in real time. For example, when the network arbitrator 148 requires an update, the birds-eye view processing submodule 1002B then assembles a partial EBTF based on the accrued data in the IBTF, and provides an estimate of location of the mobile object to the network arbitrator 148. The above described processes can track mobile objects with a latency of a fraction of a second.

Referring back to FIG. 25, the camera view processing submodule 1002A detects and processes the blob 112A as the mobile object 112A moves in room 1022A from entrance 1024A to entrance 1024B. The birds-eye view processing module 1002B records the mobile object's trajectory 1028 in the birds-eye view.

In the example of FIG. 25, there are no competing blobs in the image frames captured by the imaging device 104A and the image processing technology used by the system is sufficiently accurate to avoid blob fragmentation, the IBTF thus consists only a creation event and an annihilation event joined by a single edge that has one or more image frames (see FIG. 31, described later). Also, as the initial conditions from the network arbitrator 148 is unambiguous regarding the tagged object 112A, the IBTF has a single blob coincident with the initial conditions, meaning no ambiguity. The EBTF is therefore the same as the IBTF.

The birds-eye view processing submodule 1002B converts the blob in the camera view into a BV object in the birds-eye view, and calculates a floor grid probability, based on the subarea constraint, and the location of the imaging device (hence the computed H matrix, described later). The probability of the BV object location, or in other words, the mobile object location in the site, is updated as described before.

The OTF comprises a summary description of the trajectory of each object location PDF as a function of time. The OTF is interpreted by the network arbitrator 148, and registers no abnormalities or potential ambiguities. The OTF is used for generating the initial conditions for the next adjoining imaging device FOV subarea.

The example of FIG. 25 shows an ideal scenario in which there exist no ambiguities in the initial conditions from the network arbitrator 148, and there exist no ambiguities in the camera view blob tracking. Hence the blob/BV object/tag device association probability remains at 1 throughout the entire period that the mobile object 112A moves from entrance 1024A to entrance 1024B until the mobile object exits from entrance 1024B.

When the mobile object disappears at entrance 1024B, the system may use the data of the mobile object 112 at the entrance 1024B, or the data of the mobile object 112 in room 1022A, for establishing a blob/BV object/tag device association for a new blob appearing in room 1022C at the entrance 1024B.

As another example, if a new blob appearing in a subarea, e.g., a room, but not adjacent any entrance or exit, the new blob may be a mobile object previously being stationary for a long time but now starting to move. Thus, previous data of mobile objects in that room may be used as initial conditions for the new blob.

VIII-2. Initial Conditions

By determining and using initial conditions for a new blob appearing in the FOV of an imaging device, the network arbitrator 148 is then able to solve ambiguities that may occur in mobile object tracking. Such ambiguities may arise in many situations, and may not be easily solvable without initial conditions.

Using FIG. 25 as an example, when the imaging device 104A captures a moving blob 112A in room 1022A, and the system detects a tag device in room 1022A, it may not be readily determinative to associate the blob 112A with the tag device due to possible ambiguities. In fact, there exist several possibilities.

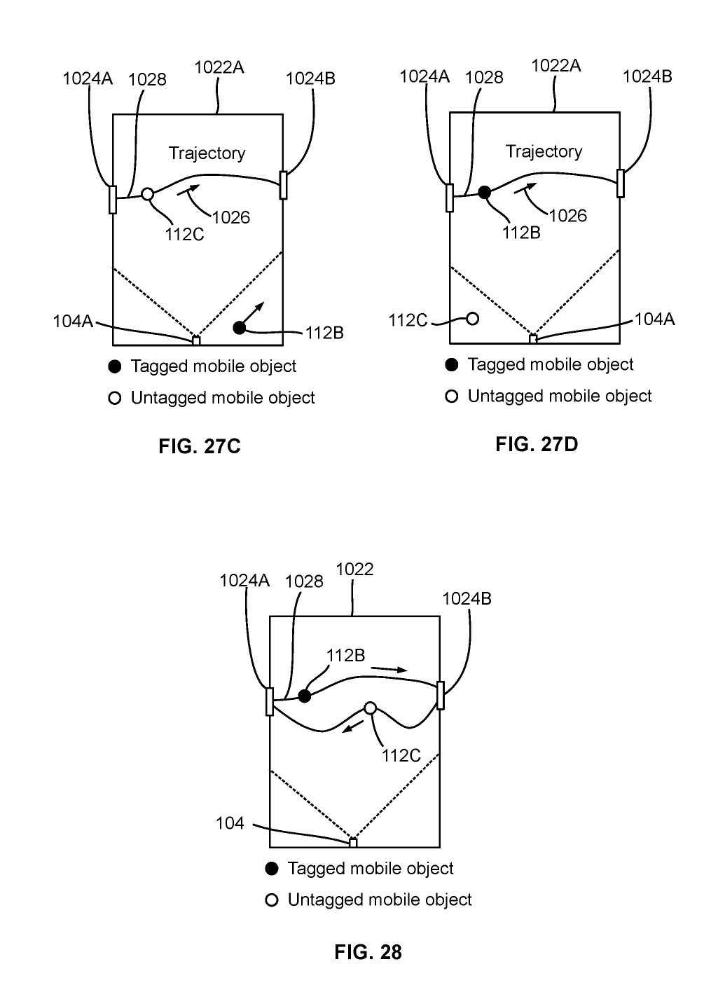

As shown in FIG. 27A, one possibility is that there is indeed only one tagged mobile object 112B in room 1022A moving from entrance 1024A to the exit 1024B. However, as shown in FIG. 27B, a second possibility is that an untagged mobile object 112C is moving in room 1022A from entrance 1024A to the exit 1024B, but there is also a stationary, tagged mobile object 112B in room 1022A outside the FOV of the imaging device 104A.

The possibility of FIG. 27B may be confirmed by requesting the tag device to provide motion related observations. If the tag device reports no movement, then, the detected blob 112A must be an untagged mobile object 112C in the FOV of the imaging device 104A, and there is also a tagged device 112B in the room 1022A, likely outside the FOV of the imaging device 104A.

On the other hand, if the tag device reports movement, then, FIG. 27B is untrue. However, the system may still not be unable to confirm whether FIG. 27A is true, as there exists another possibility as shown in FIG. 27C.

As shown in FIG. 27C, there may be an untagged mobile object 112C in room 1022A moving from entrance 1024A to the exit 1024B, and a tagged mobile object 112B outside the FOV of the imaging device 104A and moving.

Referring back to FIG. 25B, the ambiguity between FIGS. 27A and 27C may be solved by using the initial conditions likely related to blob 112A that the system has previously determined in adjacent room 1022B. For example, if the system determines that the initial conditions obtained in room 1022B indicate that, immediately before the appearance of blob 112A, an untagged mobile object disappeared from room 1022B at the entrance 1024A, the system can easily associate the new blob 112A with the untagged mobile object that has disappeared from room 1022B, and the tag device must be associated with a mobile object not detectable in images captured by the imaging device 104A.

It is worth to note that there still exists another possibility that a tagged mobile object 112B is moving in room 1022A from entrance 1024A to exit 1024B, and there is also a stationary, untagged mobile object 112C in room 1022A outside the FOV of the imaging device 104A. FIG. 27D may be confirmed if previous data regarding an untagged mobile object is available; otherwise, the system would not be able to determine if there is any untagged mobile object undetectable from the image stream of the imaging device 104A, and simply ignore such possibilities.

FIG. 28 shows another example, in which a tagged mobile object 112B moves in room 1022 from the entrance 1024A on the left-hand side to the right-hand side towards the entrance 1024B, and an untagged object 112C moves in room 1022 from the entrance 1024B on the right-hand side to the left-hand side towards the entrance 1024A. The system knows that there is only one tag device in room 1022.

The imaging device 104 in room 1022 detects two blobs 112B and 112C, one of which has to be associated with the tag device. Both blobs 122B and 112C show walking motion with some turnings.

Many information and observations may be used to associate the tag device with one of the two blobs 112B and 112C. For example, the initial conditions may show that a tagged mobile object enters from the entrance 1024A on the left-hand side, and an untagged mobile object enters from the entrance 1024B on the right-hand side, indicating that blob 112B shall be associated with the tag device, and blob 112C corresponds to an untagged device. The accelerometer/rate gyro of the IMU may provide observations showing periodic activity matching the pattern of the walking activity of the blob 112B, indicating the same as above. Further, short term trajectory estimation based on IMU observations over time may be used to detect turns, which may then be used to compare with camera view detections to establish above described association. Moreover, if the room 1022 is also equipped with a wireless signal transmitter near the entrance 1024B on the right-hand side, and the tag device comprises a sensor for RSS measurement, the RSS measurement may also indicate an increasing RSS over time, indicating the blob 112B approaching the entrance 1024B is a tagged mobile object. With these example, those skilled in the art appreciate that, during the movement of blobs 112B and 112C in the FOV of the imaging device 104, the system can obtain sufficient motion related information and observations to determine that blobs 112B and 112C, respectively, are tagged and untagged mobile objects with high likelihood.

In some embodiments, if the tag device is able to provide observations, e.g., IMU observations, with sufficient accuracy, a trajectory may be obtained and compared with the camera view detections to establish above described association.

On the other hand, it may be difficult to obtain the trajectory with sufficient accuracy using captured images due to the limited optical resolution of the imaging device 104 and the error introduced in mapping the blob in captured image to the birds-eye view. In many practical scenarios, the images captured by an imaging device may only be used to reliably indicate which mobile object is in front of others.

By using relevant initial conditions, image streams captured by one or more imaging devices, and observations from tag devices, the system establishes blob/BV object/tag device associations, tracks tagged mobile objects in the site, and, if possible, tracks untagged mobile objects. An important target of the system is to track and record summary information regarding the locations and main activities of mobile objects, e.g., which subareas and when the mobile objects have been to. One may then conclude a descriptive scenario story such as the tagged object #123 entered room #456 from port #3 at time t1 and exited port #5 at time t2. Its main activity was walking”. The detailed trajectory of a mobile object and/or quantitative details of the trajectory may not be required in some alternative embodiments.

When ambiguity exists, the initial conditions from the network arbitrator 148 may not be sufficient to affirmatively establish a blob/BV object/tag device association. In other words, the probability of such a blob/BV object/tag device association is less than 1. In this situation, the birds-eye view processing submodule 1002B then starts extracting the EBTF from the IBTF immediately, and considers observations for object/tag device activity correlation.

For example, if the camera view processing module 1002A detects that a blob exhibits a constant velocity indicative of a human walking, the birds-eye view processing submodule 1002B then begins to fill the OTF with the information obtained by the camera view processing submodule 1002A, which is the information observed by the imaging device. The network arbitrator 148 analyzes the (partial) OTF and determines an opportunity for object/tag device activity correlation. Then, the network arbitrator 148 requests the tag device to provide observations such as the accelerometer data, RSS measurement, magnetometer data and the like. The network arbitrator 148 also generates additional, processed data such as walking/stationary activity classifier based on tag observations, e.g., the IMU output. The tag observations and the processed data generated by the network arbitrator based on tag observations have been described above. Below lists some of the observations again for illustration purposes:
walking activity—network arbitrator processed gesture;
walking pace (compared to undulations of camera-view bounding box);
RSS multipath activity commensurate with BV object velocity calculated based on the perspective mapping of a blob in the camera view to the birds-eye view;
RSS longer term change commensurate with the RSS map (i.e., a map of the site showing RSS distribution therein);
rate gyro activity indicative of walking; and
magnetic field variations indicative of motion (no velocity may be estimated therefrom).

The network arbitrator 148 sends object activity data, which is the data describing object activities, and may be tag observations or above described data generated by the network arbitrator 148 based on tag observations received tag observations, to the birds-eye view processing submodule 1002B.

The birds-eye view processing submodule 1002B then calculates numeric activity correlations between the object activity data and the camera view observations, e.g., data of blobs. The calculated numeric correlations are stored in the OTF, forming correlation metrics.

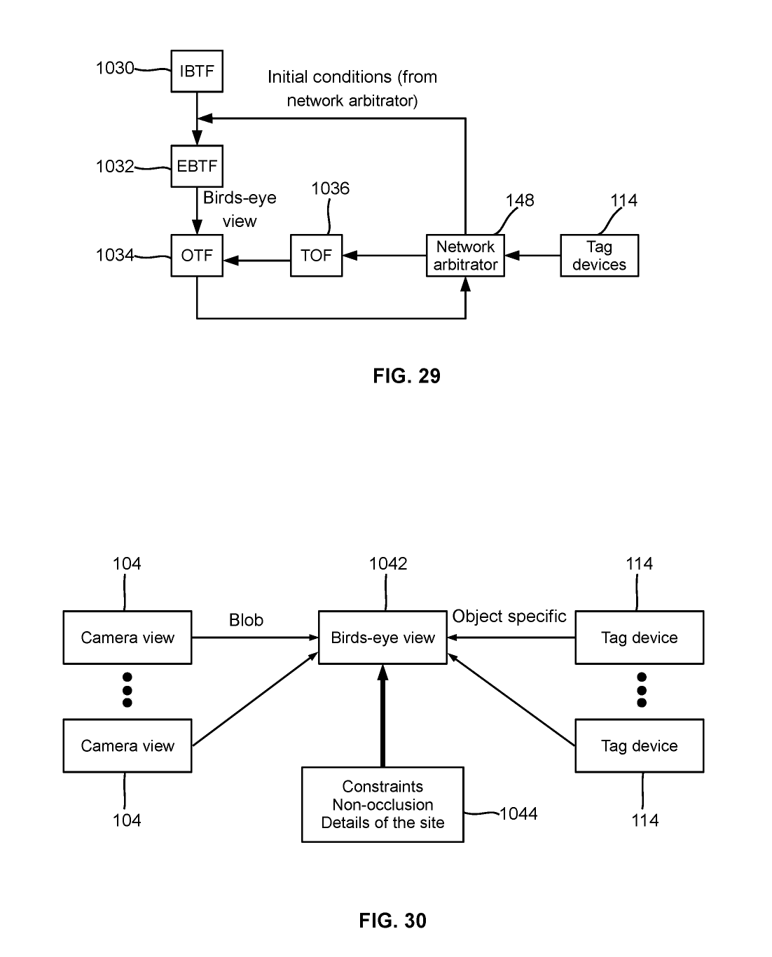

The network arbitrator 148 uses these correlation metrics and weights them to update the blob/BV object/tag device association probability. With sufficient camera view observations and tag observations, ambiguity can be resolved and the blob/BV object/tag device association may be confirmed with an association probability larger than a predefined probability threshold. FIG. 29 shows the relationship between the IBTF 1030, EBTF 1032, OTF 1034, Tag Observable File (TOF) 1036 for storing tag observations, network arbitrator 148 and tag devices 114.

With above description, those skilled in the art appreciate that the camera view processing submodule 1002A processes image frames captured by the imaging devices to detect blobs and to determine the attributes of detected blobs.

The birds-eye view processing submodule 1002B does not directly communicate with the tag devices. Rather, the birds-eye view processing submodule 1002B calculates activity correlations based on the object activity data provided by the network arbitrator 148. The network arbitrator 148 checks the partial OTF, and, based on the calculated activity correlations, determines if the BV object can be associated with a tag device.

Those skilled in the art also appreciate that the network arbitrator 148 has an overall connection diagram of the various subareas, i.e., the locations of the subareas and the connections therebetween, but does not have the details of each of the subareas. The details of the subareas are stored in the site map, and, if available, the magnetometer map and the RSS map. These maps are fed to the birds-eye view processing submodule 1002B.

When relevant magnetometer and/or RSS data is available from the tag devices, the network arbitrator 148 can relay these data as tag observations (stored in the TOF 1036) to the birds-eye view processing submodule 1002B. As the birds-eye view processing submodule 1002B knows the probability of the tag device being in a specific location, it can update the magnetometer and/or RSS map accordingly.

Generally, the system can employ many types of information for tracking mobile objects, including the image streams captured by the imaging devices in the site, tag observations and initial conditions regarding mobile objects appearing in the FOV of each imaging device. In some embodiments, the system may further exploit additional constraints for establishing blob/BV object/tag device association and tracking mobile objects. Such additional constraints include, but not limited to, realistic object motion constraints. For example, the velocity and acceleration of a mobile object relative to a floor space cannot realistically exceed certain predetermined limits. There may establish justifiable assumption of no object occlusion in birds-eye view. In some embodiments, there may exist a plurality of imaging devices with overlapping FOVs, e.g., monitoring a common subarea; the image streams captured by these imaging devices thus may be collectively processed to detect and track mobile objects with higher accuracy. The site contains barriers or constraints, e.g., walls, at known locations that mobile objects cannot realistically cross, and the site contains ports or entrances/exits at known locations allowing mobile objects to move from one subarea to another.

The above described constraints may be more conveniently processed in the birds-eye view than in the camera view. Therefore, as shown in FIG. 29, the birds-eye view 1042 may be used as a hub for combining data obtained from one or more imaging devices or camera views 104, observations from one or more tag devices 104, and the constraints 1044, for establishing blob/BV object/tag device association. Some data such as camera view observations of imaging device 104 and tag observations of tag devices 114 may be sent to the birds-eye view 1042 via intermediate components such as the camera view processing submodule 1002A and the network arbitrator 148, respectively. However, such intermediate components are omitted in FIG. 30 for ease of illustration.

With the information flow shown in FIG. 30, in a scenario of FIG. 27A where the initial conditions indicate a tagged mobile object 112B entering the entrance 1024A with steady walking activity, no ambiguity arises. The camera view information, i.e., the blob 112B, and the tag device observations can be corroborated with each other directly without the aid of the additional constraints. In other words, the camera view produces a single blob of very high probability and with no issue of blob association from one image frame to another. A trajectory of the corresponding mobile object is determined and mapped into the birds-eye view as an almost deterministic path with small trajectory uncertainty. The CV/BV module checks the mapped trajectory to ensure that its correctness (e.g., the trajectory does not cross a wall). After determining the correctness of the trajectory, a BV object is assigned to the blob, and a blob/BV object/tag device association is then established.

As there is no issue with the correctness and uniqueness of the established association, the CV/BV module then informs the network arbitrator to establish the probability of the blob/BV object association. The network arbitrator checks the initial conditions likely related to the blob, and calculates the probability of the blob/BV object/tag device association. If the calculated association probability is sufficiently high, e.g., higher than a predefined probability threshold, then the network arbitrator does not request for any further tag observations from tag devices.

If, however, the calculated association probability is not sufficiently high, then the network arbitrator requests observations from the tag device. As described before, the requested observations are those most suitable for increasing the association probability with minimum energy expenditure incurred to the tag device. In this example, the requested tag observations may be those suitable for confirming walking activity consistent with camera view observations (e.g., walking activity observed from the blob 112B).

After receiving the tag observations, the received tag observations are sent to the CV/BV module for re-establishing the blob/BV object/tag device association. The association probability is also re-calculated and compared with the probability threshold to determine whether the re-established associated is sufficiently reliable. This process may be repeated until a sufficiently high association probability is obtained.

FIG. 31 is a more detailed version of FIG. 30, showing the function of the network arbitrator 148 in the information flow. As shown, initial conditions 1046 are made available to the camera views 104, birds-eye view 1042 and network arbitrator 148. The network arbitrator 148 handles all communications with the tag devices 114 based on the need of associating the tag devices 114 with BV objects. Tag information and decisions made by the network arbitrator 148 are sent to the camera views 104 and the birds-eye view 1042. The main output 1048 of the network arbitrator 148 is the summary information regarding the locations and main activities of mobile objects, i.e., the scenario stories, which may be used as initial conditions for further mobile object detection and tracking, e.g., for detecting and tracking mobile objects entering an adjacent subarea. The summary information is updated every time when an object exits a subarea.

VIII-3. Camera View Processing

It is common in practice that a composite blob of a mobile object may comprise a plurality of sub-blobs as a cluster. The graph in the IBTF thus may comprise a plurality of sub-blobs. Many suitable image processing technologies, such as morphological operations, erosion, dilation, flood-fill, and the like, can be used to generate such a composite blob from a set of sub-blobs, which, on the other hand, implies that the structure of a blob is dependent on the image processing technology being used. While under ideal conditions a blob may be decomposed into individual sub-blobs, such decomposition is often practically impossible unless other information, such as clothes color, face detection and recognition, and the like, are available. Thus, in this embodiment, sub-blobs are generally considered hidden with inference only from the uniform motion of the feature points and optical flow.

In some situations, the camera view processing submodule 1002A may not have sufficient information from the camera view to determine that a cluster of sub-blobs are indeed associated with one mobile object. As there is no feedback from the birds-eye view processing module 1002B to the camera view processing submodule 1002A, the camera view processing submodule 1002A cannot use the initial conditions to combine a cluster of sub-blobs into a blob.

The birds-eye view processing module 1002B, on the other hand, may use initial conditions to determine if a cluster of sub-blobs shall be associated with one BV object. For example, the birds-eye view processing module 1002B may determine that the creation time of the sub-blobs is coincident with the timestamp of the initial conditions. Also the initial conditions may indicate a single mobile object appearing in the FOV of the imaging device. Thus, the probability that the sub-blobs in the captured image frame are associated with the same mobile object or BV object is one (1).

In some embodiments, a classification system is used for classifying different types of blobs with a classification probability indicating the reliability of blob classification. The different types of blobs include, but not limited to, the blobs corresponding to:
Blob type 1: single adult human object, diffuse lighting, no obstruction;
Blob type 2: single adult human object, diffuse lighting, with obstruction;
Blob type 3: single adult human object, non-diffuse lighting, no obstruction;
Blob type 4: single adult human object, diffuse lighting, partial occlusion but recoverable;
Blob type 5: two adult humans in one object, diffuse lighting, ambiguous occlusion; and
Blob type 6: two adult humans in one object, specular lighting, ambiguous occlusion.

Other types of blobs, e.g., those corresponding to child objects may also be defined. Each of the above types of blobs may be processed using different rules. In some embodiments, the classification system may further identify non-human objects such as robots, carts, wheelchairs and the like, based on differentiating the shapes thereof.

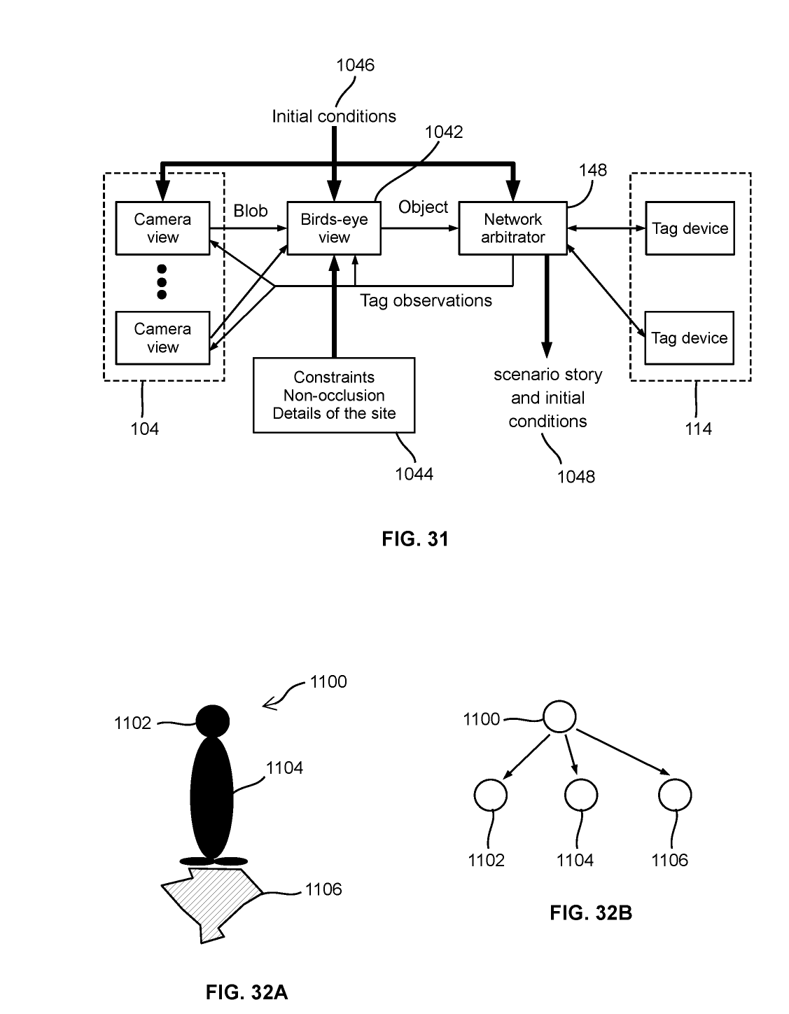

FIG. 32A shows an example of a blob 1100 of above described type 3, i.e., a blob of a single adult human object under non-diffuse lighting and with no obstruction. The type 3 blob 1100 comprises three (3) sub-blobs or bloblets, including the head 1102, the torso 1104 and the shadow 1106. FIG. 32B illustrates the relationship between the type 3 blob 1100 and its sub-blobs 1102 to 1106.

With the classification system, the camera view processing submodule 1002A can then combine a cluster of sub-blobs into a blob, which facilitates the camera view pruning of the graph in the IBTF.

The camera view processing submodule 1002A sends classified sub-blobs and their classification probabilities to the birds-eye view processing module 1002B for facilitating mobile object tracking.

For example, the initial conditions from the network arbitrator 148 indicate a single human object, and the birds-eye view processing submodule 1002B, upon reading the initial conditions, expects a human object to appear in the FOV of the imaging device at an expected time (determined from the initial conditions).

At the expected time, the camera view processing submodule 1002A detects a cluster of sub-blobs appearing at an entrance of a subarea. With the classification system, the camera view processing submodule 1002A combines a cluster of sub-blobs into a blob, and determines that the blob may be a human object with a classification probability of 0.9, a probability higher than a predefined classification probability threshold, then the birds-eye view processing submodule 1002B determines that the camera view processing submodule 1002A has correctly combined the cluster of sub-blobs in the camera view as one blob, and the blob shall be associated with the human object indicated by the initial conditions.

On the other hand, if in the above example, the initial conditions indicate two human objects, the birds-eye view processing submodule 1002B then determines that the camera view processing submodule has incorrectly combined the cluster of sub-blobs into one blob.

The birds-eye view processing submodule 1002B records its determination regarding the correctness of the combined cluster of sub-blobs in the OTF.

When the camera view processing submodule 1002A combines the cluster of sub-blobs into one blob, it also stores information it derived about the blob in the IBTF. If the camera view processing submodule has incorrectly combined the cluster of sub-blobs into one blob, the derived information may also be wrong. To prevent the incorrect information from populating to subsequent calculation and decision making, the birds-eye view processing submodule 1002B applies uncertainty metrics to the data in the OTF to allow the network arbitrator 148 to use the uncertainty metrics for weighting the data in the OTF in object tracking. With proper weighting, the data obtained by the network arbitrator 148 from other sources, e.g., tag observations, may reduce the impact of OTF data that has less certainty (i.e., more likely to be wrong), and reduce the likelihood that the wrong information in OTF data populates to consequent calculation and decision making.

In an alternative embodiment, feedback is provided from the birds-eye view processing submodule 1002B to the camera view processing submodule 1002A to facilitate the combination of sub-blobs. For example, if the birds-eye view processing submodule 1002B determines from the initial conditions that there is only one mobile object appearing at an entrance, it feeds back this information to the camera view processing submodule 1002A, such that the camera view processing submodule 1002A can combine the cluster of sub-blobs appearing at the entrance as one blob, even if the cluster of sub-blobs appear in the camera view, from the CV perspective, are more likely projected to be two or more blobs.

Multiple blobs may also merge into one blob due to mobile objects overlapping therebetween in the FOV of the imaging device, and a previously merge blob may be separated when previously overlapped mobile objects are separated.

Before describing blob merging and separating (also called fusion and fission), it is note that each blob detected in an image stream comprises two basic blob events, i.e., blob creation and annihilation. A blob creation event corresponds to an event that a blob emerging in the FOV of an imaging device, such as from a side of the FOV of the imaging device, from an entrance or from an obstruction in the FOV of the imaging device, and the like.

A blob annihilation event corresponds to an event that a blob disappears in the FOV of an imaging device, such as exiting from a side of the FOV of the imaging device (implying moving into an adjacent subarea or leaving the site), disappearing behind an obstruction in the FOV of the imaging device, and the like.

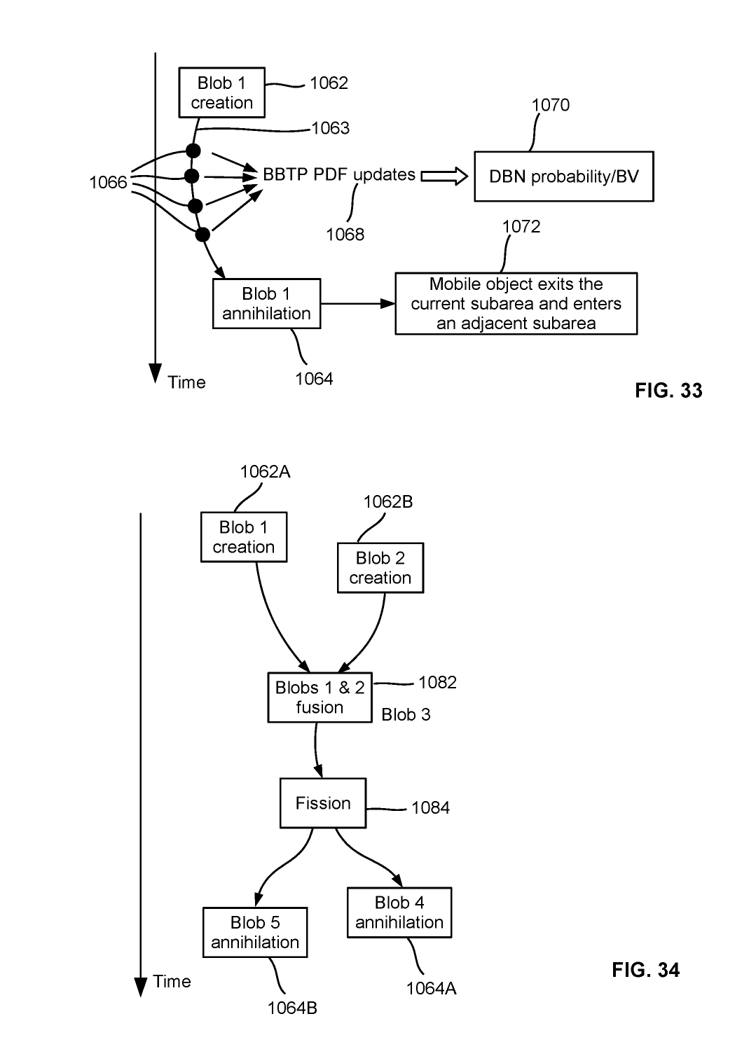

FIG. 33 shows a timeline history diagram of a life span of a blob. As shown, the life span of the blob comprises a creation event 1062, indicating the first appearing of the blob in the captured image stream, and an annihilation event 1064, indicating the disappearance of the blob from the captured image stream, connected by an edge 1063 representing the life of the blob. During the life span of the blob, the PDF of the BBTP of the blob is updated at discrete time instants 1066, and the BBTP PDF updates 1068 are passed to the birds-eye view for updating a Dynamic Bayesian Network (DBN) 1070. The BTF comprises all blobs observed and tracked prior to any blob/BV object/tag device association. All attributes of the blobs generated by the camera view processing submodule are stored in the BTF.

When the blob annihilation event occurs, it implies that (block 1072) the corresponding mobile object has exited the current subarea and entered an adjacent subarea (or left the site).

A blob event instantaneous occurs in an image frame, and may be represented as a node in a timeline history diagram. A blob transition from one event to another is generally across a plurality of image frames, and is represented as an edge in the timeline history diagram.

A blob may have more events. For example, a blob may have one or more fusion events, occurred when the blob is merged into another blob, and one or more fission events, occurring when two or more previously merged blobs are separated.

For example, FIG. 34 shows a timeline history diagram of the blobs of FIG. 28, which shows that blobs 1 and 2 are created (events 1062A and 1062B, respectively) at entrances 1024A and 1024B, respectively, to the room 1022 in the FOV of the imaging device 104. After a while, a fusion event 1082 of blobs 1 and 2 occurs, resulting in blob 3. Another while later, blob 3 fissions into blobs 4 and 5 (fission event 1084). At the end of the timeline, blob 4 and 5 are annihilated (annihilation events 1064A and 1064B, respectively) as they exit the FOV of the imaging device 104 through entrances 1024B and 1024A, respectively. The camera view processing submodule 1002A produces the blob-related event nodes and edges, including the position and attributes of the blobs generated in the edge frames, which are passed to a DBN. The DBN puts the most likely story together in the birds-eye view.

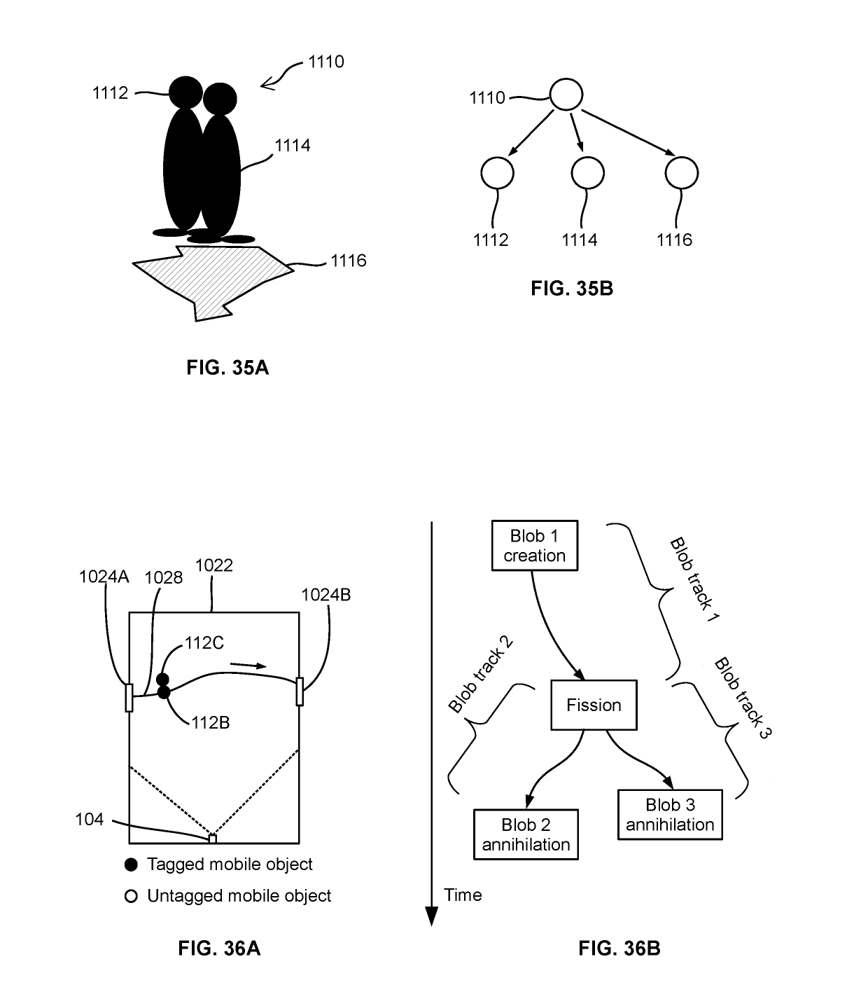

FIG. 35A shows an example of a type 6 blob 1110 corresponding to two persons standing close to each other. The blob 1110 comprises three sub-blobs, including two partially overlapping sub-blobs 1112 and 1114 corresponding to the two persons, and a shadow blob 1116. FIG. 35B illustrates the relationship between the type 6 blob 1110 and its sub-blobs 1112 to 1116. Similar to the example of FIG. 33A, the blob 1110 may be decomposed into individual sub-blobs of two human blobs and a shadow blob under ideal conditions.

The type 6 blob 1110 and other types of blobs, e.g., type 5 blobs, that are merged from individual blobs, may be separated in a fission event. On the other hand, blobs of individual mobile objects may be merged to a merged blob, e.g., a type 5 or type 6 blob in a fusion event. Generally, fusion and fission events may occur depending on the background, mobile object activities, occlusion, and the like.

Blob fusion and fission may cause ambiguity in object tracking. FIG. 36A shows an example of such an ambiguity. As shown, two tagged objects 112B and 112C simultaneously enter the entrance 1024A of room 1022 and move in the FOV of imaging device 104 across the room 1022, and exit from the entrance 1024B.

As the mobile objects 112B and 112C are tagged objects, the initial conditions from the network arbitrator 148 indicate two objects entering room 1022. On the other hand, the camera view processing submodule 1002A only detects one blob from image frames captured by the imaging device 104. Therefore, ambiguity occurs.

As the ambiguity is not immediately resolvable when the mobile objects 112B and 112C enter the room 1022, the camera view processing submodule 1002A combines detected cluster of sub-blobs into one blob.

If mobile objects 112B and 112C are moving in room 1022 at the same speed, then they still exhibit, in the camera view, as a single blob and ambiguity cannot be resolved. The IBTF then indicates a blob track graph that appears to be moving at a constant rate of walking. A primitive blob tracking would not classify the blob as two humans. The birds-eye view processing submodule 1002B analyzes the IBTF based on the initial conditions, and maps the blob cluster graph from the IBTF to the EBTF. As the ambiguity cannot be resolved, the blob cluster is thus mapped as a single BV object, and stored in the OTF. In this case, the network arbitrator 148 would not request any tag measurements as the data in the OTF does not indicate any possibility of disambiguation, only the initial conditions indicating ambiguity.

When the mobile objects 112B and 112C exit room 1022 into an adjacent, next subarea, the network arbitrator 148 assembles data thereof as initial conditions for passing to the next subarea. As will be described later, if the mobile objects 112B and 112C are separated in the next subarea, they may be successfully identified, and their traces in room 1022 may be “back-tracked”. In other words, the system may delay ambiguity resolution until the identification of mobile objects is successful.

If, however, the mobile objects 112B and 112C are moving in room 1022 at different speeds, the single blob eventually separates into two blobs.

The single blob is separated when the mobile object traces separate, wherein one trace extends ahead of the other. It is possible that there exists a transition period of separation, in which the single blob may be separated into more than a plurality of sub-blobs, which, together with the inaccuracy of the BBTP of the single blob, cause the camera view processing submodule 1002A to fail to group the sub-blobs into two blobs. However, such a transition period is temporary and can be omitted.

With the detection of two blobs, the IBTF now comprises three blob tracks, i.e., blob track 1 corresponding to the previous single blob, and blob tracks 2 and 3 corresponding to the current two blobs, as shown in the timeline history diagram of FIG. 36B.

The initial conditions indicate the two ambiguous objects 112B and 112C at the entrance 1024A of room 1022, and the birds-eye view processing submodule 1002B processes the IBTF to generate the floor view for blob tracks or edges 1, 2 and 3. Based on the graph and the floor grid, as blob tracks 2 and 3 start at a location in room 1022 in proximity with the end location of blob track 1, the birds-eye view processing submodule 1002B associates blob track 1 with blob track 2 to form a first blob track graph, and also associates blob track 1 with blob track 3 to form a second blob track graph, both associations being consistent to the initial conditions and having high likelihoods.

It is worth to note that, if one or both of blob tracks 2 and 3 start at a location in room 1022 far from the end location of blob track 1, the association of blob tracks 1 and 2 and that of blob tracks 1 and 3 would have low likelihood.

Back to the example, with the information from the camera view processing submodule 1002A, the birds-eye view processing submodule 1002B determines activities of walking associated with the first and second blob track graphs, which is compared with tag observations for resolving ambiguity.

The network arbitrator 148 requests the tag devices to report tag observations, e.g., the mobile object velocities, when the mobile objects 112B and 112C are in the blob tracks 2 and 3, and uses the velocity observations for resolving ambiguity. The paces of the mobile objects may also be observed in camera view and by the tag devices, and are used for resolving ambiguity. The obtained tag observations such a velocities and paces are stored in the OTF.

In some embodiments, the network arbitrator 148 may request tag devices to provide RSS measurement and/or magnetic field measurement. The obtained RSS and/or magnetic field measurements are sent to the birds-eye view processing submodule 1002B,

As the birds-eye view processing submodule 1002B has the knowledge of the traces of mobile objects 112B and 112C, it can correlate the magnetic and RSS measurements with the RSS and magnetic maps, respectively. As the tagged objects are going through the same path with one behind the other, the RSS and/or magnetic correlations for the two objects 112B and 112C exhibit similar pattern with a delay therebetween. The ambiguity can then be resolved and the blobs can be correctly associated with their respective BV objects and tag devices.

The power spectrum of the RSS can also be used for resolving ambiguity. The RSS has a bandwidth roughly proportional to the velocity of the tag device (and thus the associated mobile object). As the velocity is accurately known from the camera view (calculated based on, e.g., optical flow and/or feature point tracking), the RSS spectral power bandwidths may be compared with the object velocity for resolving ambiguity.

As the mobile object moves, the magnetic field strength will fluctuate and the power spectral bandwidth will change. Thus, the magnetic field strength may also be used for resolving ambiguity in a similar manner. All of these correlations and discriminatory attributes are processed by the birds-eye view processing submodule 1002B and sent to the network arbitrator 148.

As described above, the camera view processing submodule 1002A tries to combine sub-blobs that belong to the same mobile object, by using background/foreground processing, morphological operations and/or other suitable imaging processing techniques. The blobs and/or sub-blobs are pruned, e.g., by eliminating some sub-blobs that are likely not belonging to any blob, to facilitate blob detection and sub-blob combination. The camera view processing submodule 1002A also uses optical flow methods to combine a cluster of sub-blobs into one blob. However, sub-blobs may not be combined if there is potential ambiguity, and thus the BTF (IBTF and EBFT) may comprise multiple blob tracks for the same object.

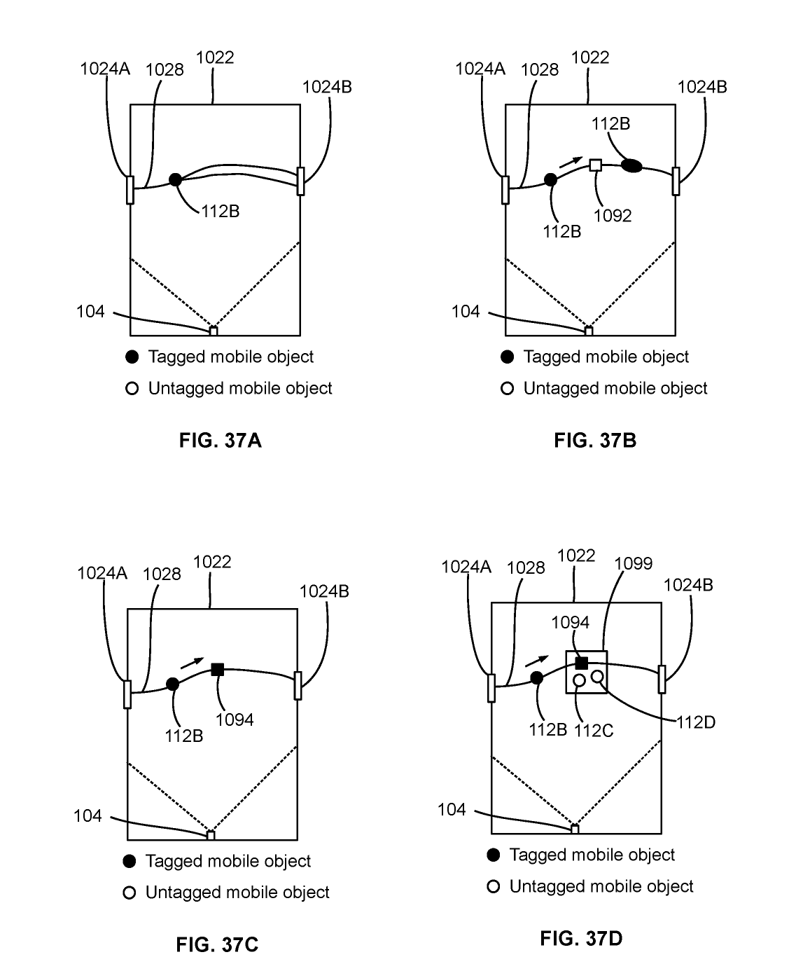

FIG. 37A illustrates an example, in which a blob 112B is detected by the imaging device 104 appearing at entrance 1024A of room 1022, moving towards entrance 1024B along the path 1028, but splitting (fission) into two sub-blobs that move along slightly different path and both exit the room 1022 from entrance 1024B.

In this example, three tracks are detected and included in the BTF, with one track from the entrance 1024A to the fission point, and two tracks from the fission point to entrance 1024B.

Initial conditions play an important role in this example in solving the ambiguity. If the initial conditions indicate two mobile objects appearing at entrance 1024A, the two tracks after the fission point are then associated with the two mobile objects.

However, if, in this example, the initial conditions indicate a single object appearing at entrance 1024A, as objects cannot be spontaneously created within the FOV of the imaging device 104, the birds-eye view processing submodule interprets the blob appearing at the entrance 1024A as a single mobile object.

The first blob track from the entrance 1024A to the fission point is analyzed in the BV frame. The bounding box size that should correspond to the physical size of the object is calculated and verified for plausibility. In this example we are assuming a diffuse light for simplicity such that the shadows are not an issue, and the processing of shadows is omitted as shadows can be treated as described above.

Immediately after the fission point, there appear two bounding boxes (i.e., two CV objects or two FFCs). If the two bounding boxes are then moving at different velocity or along two paths significantly apart from each other, the two CV objects are then associated with two mobile objects. Tag observations may be used to determine which one of the two mobile objects is the tagged object. However, if the two CV objects are moving at substantially the same velocity along two paths close to each other, the ambiguity cannot be solved. In other words, the two CV objects may be indeed a single mobile object but appearing as two CV objects due to the inaccuracy in image processing, or the two CV objects are two mobile objects but are close to each other and cannot be distinguished with sufficient confidentiality. The system thus considers them as one (tagged) mobile object. If, after exiting from the entrance 1024B, the system observes two significantly different movements, the above described ambiguity occurred in room 1022 can then be solved.

With above examples, those skilled in the art appreciate that ambiguity in most situations can be resolved for by using camera view observations and the initial conditions. If the initial conditions are affirmative, the ambiguity may be resolved with probability of one (1). If, however, the initial conditions are probabilistic, the ambiguity is resolved with a probability less than one (1). The mobile object is tracked with a probability less than one (1) and is conditioned on the possibility of the initial conditions. For example, mobile object tracking may be associated with the following Bayesian probabilities:

Pr(blob tracks 1, 2 and 3 being associated)=Pr(initial conditions indicating one person),

where Pr(A) represents the probability that A is correct; or

Pr(blob tracks 2 and 3 being separately associated with blob track 1)=Pr(initial conditions indicating two persons).

During object tracking, a blob may change in size or shape, an example of which is shown in FIG. 37B.

In this example, there is a cart 1092 in room 1022 that has been stationary for a long time and therefore become part of the background in camera view. A tagged person 112B enters from the left entrance 1024A and moves across the room 1022 along the path 1028. Upon reaching the cart 1092, the person 112B pushes the cart 1092 to the right entrance 1024B and exit therefrom.

During tracking of the person 112B, the camera view processing submodule 1002A determines a bounding box for the person's blob, which, however, suddenly becomes much larger when the person 112B starts to push the cart 1092 therewith.

Accordingly, the information carried in the edge of the blob track graph is characterized by a sudden increase in the size of the blob bounding box, which causes a blob track abnormality in birds-eye view processing. A blob track abnormality may be considered a pseudo-event not detected in the camera view processing but rather in the subsequent birds-eye view processing.

In the example of FIG. 37B, the initial conditions indicate a single person entering entrance 1024A. Although the camera view processing indicates a single blob crossing the room 1022, the birds-eye view processing analyzes the bounding box of the blob and determines that the bounding box size of the blob at the first portion of the trace 1028 (between the entrance 1024A and the cart 1092) does not match that at the second portion of the trace 1028 (between the cart 1092 and the entrance 1024B). A blob track abnormality is then detected.

Without further information, the birds-eye view processing/network arbitrator can determine that the mobile object 112B is likely associated with an additional object that was previously part of the background in captured image frames.

The association of the person 112B and the cart 1092 can be further confirmed if the cart 1092 comprises a tag device that wakes up as it is being moved by the person (via accelerometer measuring a sudden change). The tag device of the cart 1092 immediately registers itself with the network arbitrator 148, and then the network arbitrator 148 starts to locate this tag device. Due to the coincidence of the tag device waking up and the occurrence of the blob track abnormality, the network arbitrator 148 can determine that the mobile object 112B is now associated with the cart 1092 with a moderate level of probability. Furthermore, the tag device of the cart 1092 can further detects that it is being translated in position (via magnetic field measurement, RSS measurement, accelerometer and rate gyro data indicating vibrations due to moving, and the like), and thus the cart 1092 can be associated with the mobile object 112B during the second portion of the trace 1028.

If feedback can be provided to the camera view processing submodule 1002A, the camera view processing submodule 1002A may analyze the background of captured images and compare the background in the images captured after the cart 1092 is pushed with that in the images captured before the cart 1092 is pushed. The difference can show that the cart object 1092 that is moved.

FIG. 37C shows another example, in which a tagged person 112B enters from the left entrance 1024A and moves across the room 1022 along the path 1028. During moving, the person 112B sits down for a while at location 1094, and then stands up and walks out from entrance 10246.

Accordingly, in the camera view, the person 112B appears as a moving blob from the entrance 1024A where a new track of blob 1126 is initiated. Periodic oscillating of the bounding box confirms the object walking. Then, the walking stops and the blob 112B becomes stationary (e.g., for a second). After that, the blob 112B remains stationary but the height thereof shrinks. When the person 1126 stands up, the corresponding blob 1126 increases to its previous height. After a short period, e.g., a second, the blob again exhibits walking motion (periodic undulations) and moves at a constant rate towards the entrance 1024B.

While in this embodiment the change of the height of the blob in FIG. 37C does not cause ambiguity, in some alternative embodiments, the system may need to confirm the above-described camera observation using tag observations.

IMU tag observations, e.g., accelerometer and rate gyro outputs, exhibit a motion pattern consistent to the camera view observation. In particular, tag observations reveal a walking motion, and then a slight motion activity (when the person 112B is sitting down and when the person 112B is standing up). Then, the IMU tag observations again reveal a walking motion. Such a motion pattern can be used to confirm the camera view observation.

In some embodiments wherein the tag device comprise other sensors such as a barometer, the output of the barometer can detect the change in altitude from standing and sitting (except that the tag device is coupled to the person at an elevation close to the floor, or that the tag device is carried in a handbag that is put on a table when the person 112B sits down). As usually the person 112B will sit down for at least several seconds or even much longer, the barometer output, while noisy, can be filtered with a time constant, e.g., several seconds, to remove noise and detect altitude change, e.g., of about half meter. Thus, the barometer output can be used for detecting object elevation changes, such as a person sitting down, and for confirming the camera view observation.

RSS measurement can also be used for indicating object in stationary by determining that the RSS measurement does not change in a previously detected manner or does not change at all. Note that the RSS measurement does not change when the tagged person is walking along an arc and maintaining a constant distance to the wireless signal transceiver. However, this rarely occurs, and even if it occurs, alternative tag observations can be used.

In the example of FIG. 37C, the site map may contain information regarding the location 1094, e.g., a chair pre-deployed and fixed at a location 1094. Such information may also be used for confirming the camera view observation.

FIG. 37D shows yet another example. Similar to FIG. 37C, a tagged person 1126 enters from the left entrance 1024A and moves across the room 1022 along the path 1028. Accordingly, in the camera view, the person 1126 appears as a moving blob from the entrance 1024A where a new track of blob 112B is initiated. Periodic oscillating of the bounding box confirms the object walking.

When the person 112B arrives at location 1094, the person 112B sits down. Unlike the situation of FIG. 37C, in FIG. 37D, two untagged persons 112C and 112D are also sitting at location 1094 (not yet merged into the background). Therefore, the blob of person 1126 merges with those of persons 112C and 112D.

After a short while, person 112B stands up and walks out from entrance 1024B. The camera view processing submodule detects the fission of the merged blob, and the birds-eye view processing submodule can successfully detect the moving of person 1126 by combining camera view observations and tag observations.

However, if an untagged person, e.g., person 112C also stands up and walks with person 1126, unresolvable ambiguity occurs as the system cannot detect the motion of the untagged person 112C. Only the motion of the tagged person 112B can be confirmed. This example shows the limitations in tracking untagged mobile objects.

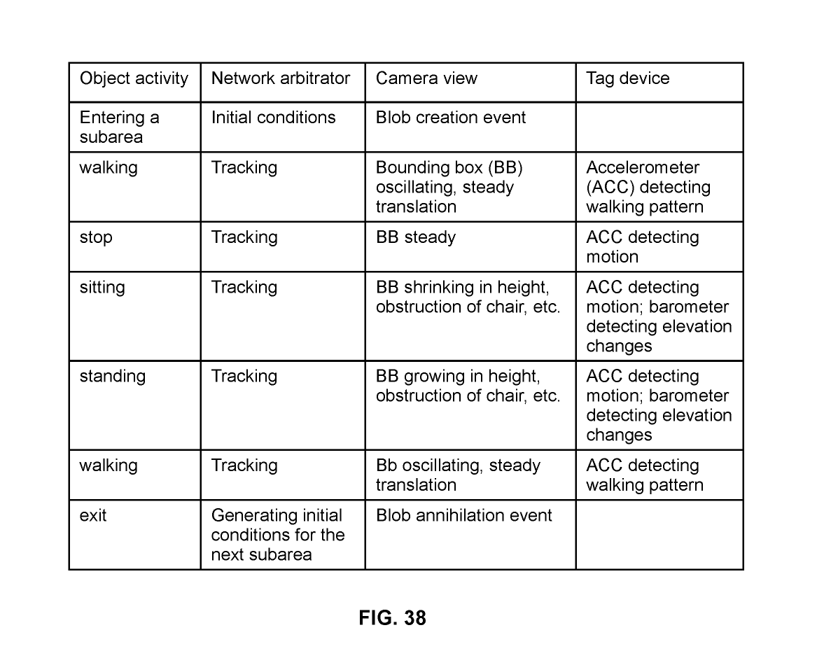

FIG. 38 shows a table listing the object activities and the performances of the network arbitrator, camera view processing and tag devices that may be triggered by the corresponding object activities.

VIII-4. Tracking Blobs in Image Frames

Tracking blobs in image frames may be straightforward in some situations such as FIG. 27A in which the association of the blob, the BV object and the tag device based on likelihood is obvious as there is only one mobile object 112B in the FOV of the imaging device 104A. During the movement of the mobile object 112B, each image frame captured by the imaging device 104A has a blob that is “matched” with the blob of the previous image frame only with a slight position displacement. As in this scenario blobs cannot spontaneously appear or disappear, the only likely explanation of such a matched blob is that the blobs in the two frames are associated, i.e., representing the same mobile object, with probability of 1.

However, in many practical scenarios, some blobs in consecutive frames may be relatively displaced by a large amount, or are significantly different in character. As described earlier, blobs typically are not a clean single blob outlining the mobile object. Due to ambiguities of distinguishing foreground from background, image processing techniques such as background differencing, binary image mapping and morphological operations may typically result in more than one sub-blob. Moreover, sub-blobs are dependent on the background, i.e., the sub-blob region becomes modulated by the background. Therefore, while a mobile object cannot suddenly disappear or appear, the corresponding blob can blend ambiguously with the background, and disappear and capriciously and subsequently appear again.

A practical approach for handling blobs is to “divide and conquer”. More particularly, the sub-blobs are tracked individually and associated to a blob cluster if some predefined criteria are met. Often, sub-blobs originate from a fission process. After a few image frames, the sub-blobs undergo a fusion process and become one blob. When the system determines such fission-fusion, the sub-blobs involved are combined as one blob. Test results show that, by considering the structure of the graph of the sub-blobs, this approach is effective in combining sub-blobs.

Some image processing techniques such as the binary and morphological operations may destroy much of the information regarding a blob. Therefore, an alternative is to calculate the optical flow from one image frame to the next. The blob associated with a moving object exhibits a nonzero optical flow while the background has a zero flow. However, this requires the imaging device to be stationary and constant, without zooming or panning. Also the frame rate must be sufficiently high such that the object motion is small during the frame interval, comparing to the typical feature length of the object. A drawback of the optical flow approach is that when a human is walking, the captured images show parts of the human are stationary while other parts are moving. Swinging arms can even exhibit an optical flow in the opposite direction.

Although initial conditions may reveal that the object is a walking human, and may allow determination of parts of the human based on the optical flow, such algorithms are complex and may not be robust. An alternative method is to use feature point tracking, i.e., to track feature points, e.g., corners of a blob. Depending on the contrast of the humans clothing over the background, suitable feature points can be found and used.

Another alternative method is to determine the boundary of the object, which may be applied to a binary image after morphological operations. To avoid merely getting boundaries around sub-blobs, snakes or active contours based on a mixture of penalty terms may be used to generate the outline of the human, from which the legs, arms and head can be identified. As the active contour has to be placed about the desired blob, the system avoids forming too large a blob with limited convergence and errors in background/foreground separation that may result in capricious active contours.

Other suitable, advanced algorithms may alternatively be used to track the sub-blob of a person's head, and attempt to place a smaller bounding box about each detected head sub-blob. After determining the bounding box of a head and knowing that the human object is walking or standing, the nominal distance from the head to the ground is thus approximately known. Then the BBTP of the blob can be determined. A drawback of this algorithm is that it may not work well if the human face is not exposed to the imaging device. Of course, this algorithm will fail if the mobile object is not a human.

In this embodiment, the VAILS uses the standard method of morphological operations on a binary image after background differencing. This method is generally fast and robust even though it may omit much of the blob information. This method is further combined with a method of determining the graph of all of the related sub-blobs for combining same. When ambiguities arise, the blob or sub-blob track, e.g., the trajectory being recorded, is terminated, and, if needed, a new track may be started, and maintained after being stable. Then the birds-eye view processing connects the two tracks to obtain the most likely mobile object trajectory.

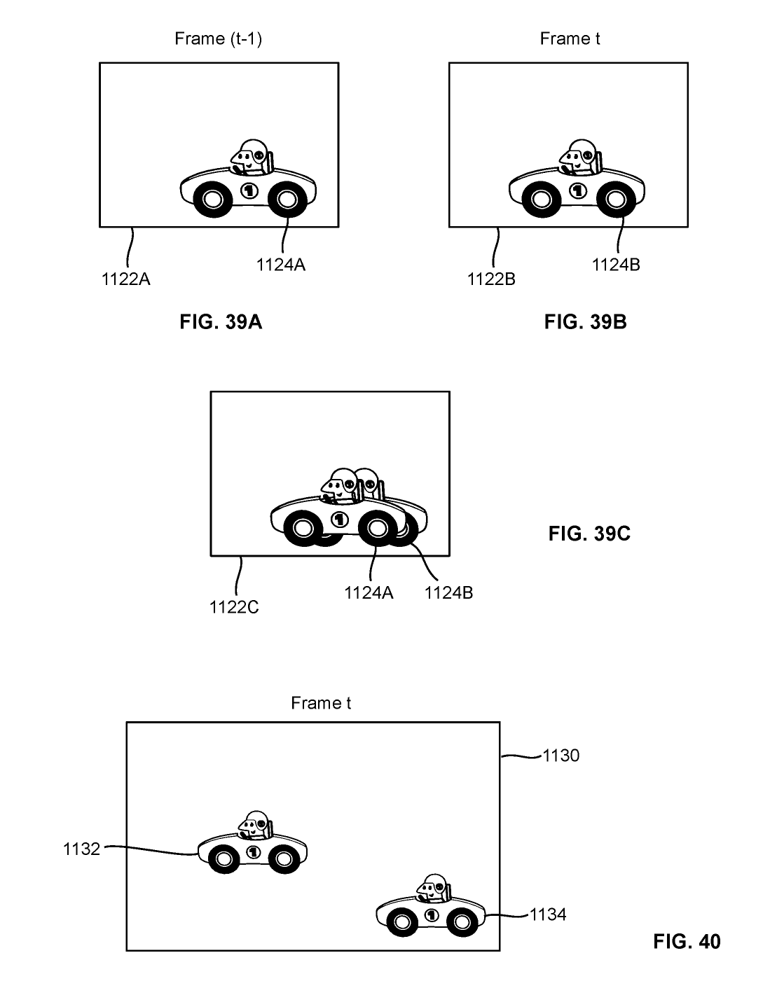

In forming the blob tracks, it is important to note that the system has to maximize the likelihood of association. For example, FIGS. 39A and 39B show two consecutive image frames 1122A and 1122B, each having two detected blobs 1124A and 1124B. Assuming that the system does not known any information of the mobile object(s) corresponding to the blobs 1124A and 1124B, to determine whether or not the blobs 1124A and 1124B correspond to the same mobile object, the system uses a likelihood overlap integral method. With this method, the system correlates the two blobs 1124A and 1124B in the consecutive frames 1122A and 1122B to determine an association likelihood. In particular, the system incrementally displaces the blob 1124A in the first frame 1122A, and correlates the displaced blob 1124A with the blob 1124B in the second frame 1122B until a maximum correlation or “match” is obtained. The F is essentially a normalized overlap integral (see FIG. 39C) in which the equivalence of the correlation coefficient emerges.

The system determines a measurement of the likelihood based on the numerical calculation of the cross-correlation coefficient at the location of the maximum blob correlation. Practically the calculated cross-correlation coefficient is a positive number smaller than or equal to one (1).

In calculating the maximum correlation of the two blobs 1124A and 1124B, the system actually treats the blobs as spatial random process, as the system does not know any information of the mobile object(s) corresponding to the blobs 1124A and 1124B. A numerical calculation of correlation is thus used in this embodiment for determining the maximum correlation. In this embodiment, images 1122A and 1122B are binary images, and the blob correlation is calculated using data of these binary images. Alternatively, images 1122A and 11226 may be color images, and the system may calculate blob correlation using data of each color channel of the images 1122A and 11226 (thus each color channel being considered an independent random field).

In another embodiment, the system may correlate derived attributes of the blobs, e.g., feature points. In particular, the system first uses the well-known Lucas Kanade method to first establish association of the feature points, and then establishes the object correlation from frame to frame.

The above described methods are somewhat heuristic, guided by the notion of correlation of random signals but after modification and selection of the signal (i.e., blob content) in heuristic ways. Each of the methods has its own limitation and a system designer selects a method suitable for meeting the design goals.

The above described likelihood overlap integral method as illustrated in FIGS. 39A to 39C has an implied assumption that the blob is time invariant, or at least changes slowly with time. While this assumption is generally practical, in some situations where the blob is finely textured, the changes in the blob can be large in every frame interval, and the method may fail. For example, if the object is a human with finely pitched checkered clothing, then a direct correlation over the typical 33 ms (milliseconds) frame interval will result in a relatively small overlap integral. A solution is that the system may pre-process the textured blob with a low pass spatial filter or even conversion to binary with morphological steps such that the overlap integral will be more invariant. However, as the system does not know ahead of time what object texture or persistence the blob has, there is a trade-off of blob preprocessing before establishing the correlation or overlap integral.

While difficulty and drawbacks exist, a system designer can still choose a suitable method such that some correlation can be determined over some vector of object attributes. The outcome of the correlation provides a quantitative measure of the association but also provides a measure of how the attributes change from one frame to the next. An obvious example in correlating the binary image is the basic incremental displacement of the blob centroid. If color channels are used, then additionally the system can track the hue of the object color, which varies as the lighting changes with time. The change in displacement is directly useful. After obtaining, together with the correlation, a measurement of how much the mobile object has moved, the system can then determine how reliable the measurement is, and use this measurement with the numerical correlation to determine a measurement of the association likelihood.

If the camera view processing submodule does not have any knowledge of the blob motion from frame to frame, an appropriate motion model may simply be a first order Markov process. Then, blobs that have small displacements between frames would have a higher likelihood factor, and whether the blob completely changes direction from frame to frame is irrelevant. On the other hand, if initial conditions indicate that the mobile object is a human with steady walking perpendicular to the axis of the imaging device, then the system can exploit incremental displacement in a specific direction. Moreover, if the mobile object velocity is limited, and will not vary instantaneously, a second order Markov model can be used, which that tracks the mobile object velocity as a state variable. Such a second order Markov model is useful in blob tracking through regions in which the blob is corrupted by, e.g., background clutter. A Kalman filter may be used in this situation.

The birds-eye view processing (described later) benefits from the blob velocity estimate. The system passes the BBTP and the estimate of velocity from the camera view to the birds-eye view.

The system resolves potential ambiguity of blobs to obtain the most likely BV object trajectory in birds-eye view. The system considers the initial conditions having high reliability. Consequently, in an image frame such as the image frame 1130 of FIG. 40, potential ambiguity can be readily resolved as each car 1132, 1134 has its own trajectory. More particularly, ambiguity is resolved based on Euclidean distance of the differential displacement, and if needed, based the tracking of the car velocities as the car trajectories are smooth.

A problem in using the likelihood overlap integral method that the system has to deal with is that some attributes, e.g., size, orientation and color mix, of blobs in consecutive frames may not be constant, causing the overlap or correlation integral to degrade. The system deals with this problem by allowing these attributes to change within a predefined or adaptively determined range to tolerate correlation integral degradation.

In some embodiments, tolerating correlation integral degradation is acceptable if the variation of the blob attributes is small. In some alternative embodiments, the system correlates the binary images of the blobs that have been treated with a sequence of morphological operations to minimize the variation caused by changes in blob attributes.

Other methods are also readily available. For example, in some embodiments, the system does not use background differencing for extracting foreground blobs. Rather, the system purposely blurs captured images and then uses optical flow technology to obtain blob flow relative to the background. Optical flow technology, in particular, works well for the interior of the foreground blob that is not modulated by the variation of the clutter in the background. In some alternative embodiments, feature point tracking is used for tracking objects with determined feature points.

The above described methods, including the likelihood overlap integral method (calculating block correlation), optical flow or feature point tracking, allow the system to estimate the displacement increment over one image frame interval. In practical use, mobile objects are generally moving slowly, and the imaging devices have a sufficiently high frame rate. Therefore, a smaller displacement increment in calculating blob correlations gives rise to higher reliability of resolving ambiguity. Moreover, the system in some embodiments can infer a measurement of the blob velocity, and track the blob velocity as a state variable of a higher order Markov process of random walk, driven by white (i.e., Gaussian) acceleration components. For example, a Kalman filter can be used for tracking the blob velocity, as most mobile objects inevitably have some inertia and thus the displacement increments are correlated from frame to frame. Such a statistic model based estimation based method is also useful in tracking mobile objects that are temporarily occluded and causes no camera view observation.

Generally, blob tracking may be significantly simplified if some information of the mobile object being tracked can be omitted. One of the simplest blob tracking methods with most omitted mobile object information is the method(s) tracking blobs using binary differenced, morphologically processed images. If more details of the mobile objects are desired, more or all attributes of mobile objects and their corresponding blobs have to be retained and used with deliberate modelling.

VIII-5. Interrupted Blob Trajectories

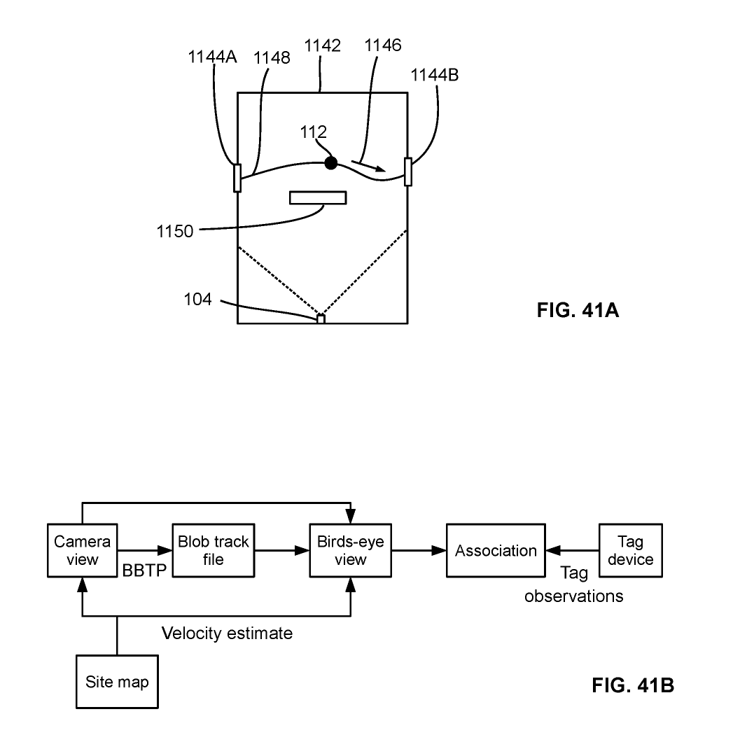

Mobile objects may be occluded by obstructions in a subarea, causing fragments of the trajectory of the corresponding blob. FIGS. 41A and 41B show an example. As shown, a room 1142 is equipped with an imaging device 104, and has an obstruction 1150 in the FOV of the imaging device 104. A mobile object 112 is moving in a room 1142 from entrance 1144A towards entrance 1144B along a path 1148. A portion of the path 1148 is occluded by the obstruction 1150.

With the initial conditions of the mobile object 112 at the entrance 1144A, the system tracks the object's trajectory (coinciding with the path 1148) until the mobile object is occluded by the obstruction 1150, at which moment the blob corresponding to the mobile object 112 disappears from the images captured by the imaging device 104, and the mobile object tracking is interrupted.

When the mobile object 112 comes out of the obstruction 1150, and re-appears in the captured images, the mobile object tracking is resumed. As a consequence, the system records two trajectory segments in the blob-track file.

The system then maps the two trajectory segments in the birds-eye view, and uses a statistic model based estimation and, if needed, tag observations to determine whether the two trajectory segments shall be connected. As the obstruction is clearly defined in the site map, processing the two trajectory segments in the birds-eye view would be easier and more straightforward. As shown in FIG. 41B, the two trajectory segments or blob tracks are stored in the blob-track file as a graph of events and edges.

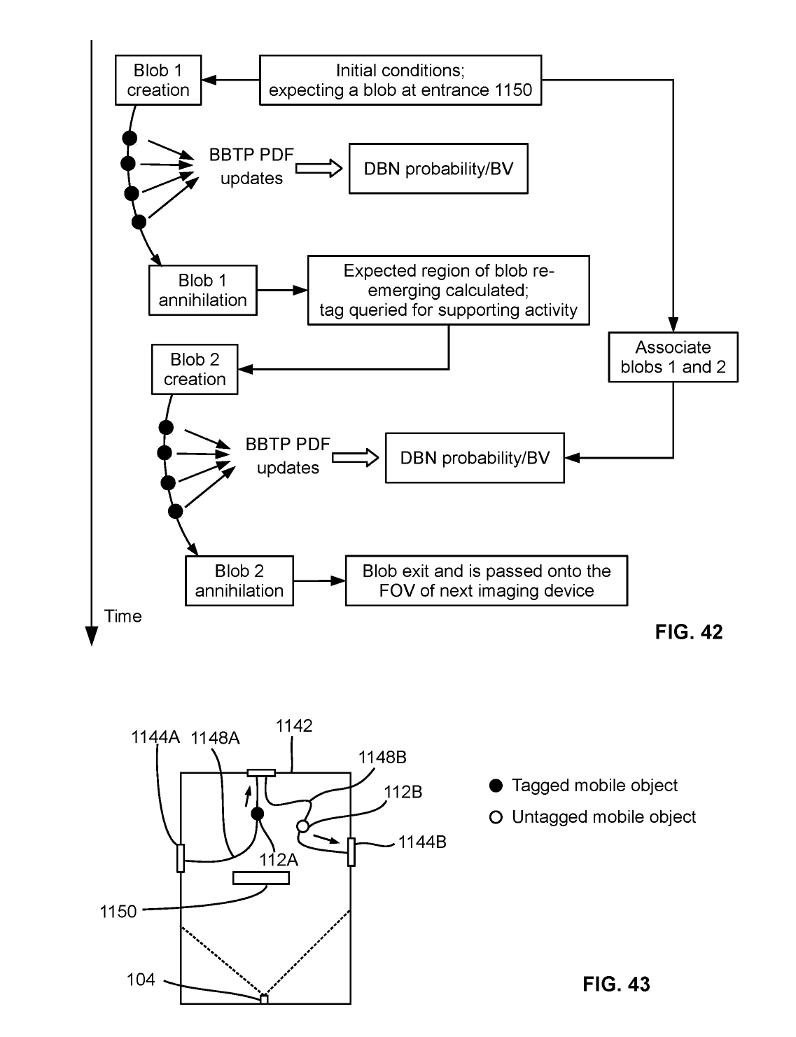

FIG. 42 is the timeline history diagram of FIG. 41A, showing how the two trajectory segments are connected. As shown, when blob 1 (the blob observed before the mobile object 112 is occluded by the obstruction 1150) is annihilated and blob 2 (the blob observed after the mobile object 112 came out of the obstruction 1150) is created, the system determines whether or not blobs 1 and 2 shall be associated by calculating an expected region of blob re-emerging, and checking if blob 2 appears in the expected region. If blob 2 appears in the expected region, the system then associates blobs 1 and 2, and connects the two trajectory segments.

In determining whether or not blobs 1 and 2 shall be associated, the system, if needed, may also request tag device(s) to provide tag observations for resolving ambiguity. For example, FIG. 43 shows an alternative possibility that may give rise to same camera view observations. The system can correctly decide between FIGS. 41A and 43 by using tag observations.

VIII-6. Birds-Eye View Processing

In the VAILS, a blob in a camera view is mapped into the birds-eye view for establishing the blob/BV object/tag device association. The BBTP is used for mapping the blob into the birds-eye view. However, the uncertainty of the BBTP impacts the mapping.

As described above, the BBTP, bounding box track point, of a blob is a point in the captured images that the system estimates as the point that the object contacts the floor surface. Due to the errors introduced in calculation, the calculated BBTP is inaccurate, and the system thus determines an ambiguity region or a probability region associated with the BBTP for describing the PDF of the BBTP location distribution. In ideal case that the BBTP position has no uncertainty, the ambiguity region is reduced to a point.

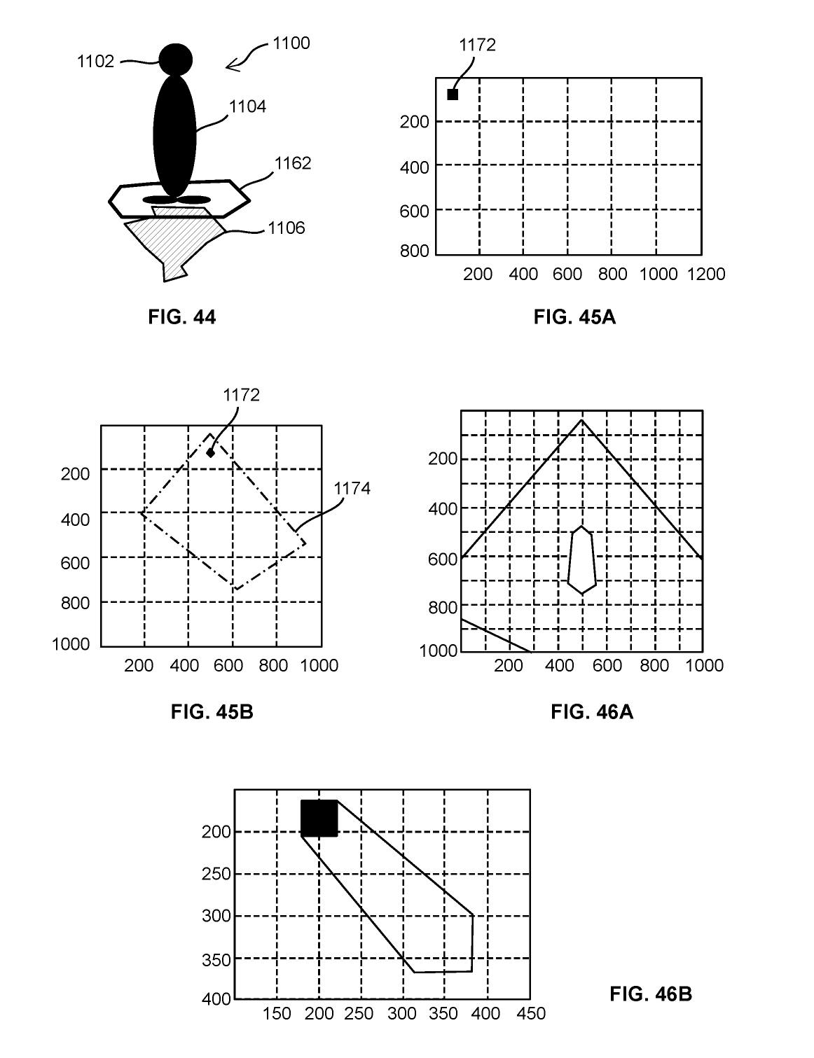

FIG. 44 shows an example of a blob 1100 with a BBTP ambiguity region 1162 determined by the system. The ambiguity region 1162 in this embodiment is determined as a polygon in the camera view with a uniformly distributed BBTP position probability therewithin. Therefore, the ambiguity region may be expressed as an array of N vertices.

The vertex array of the ambiguity region is mapped into the birds-eye view floor space using above-described perspective mapping. As the system only needs to calculate the mapping of the vertices, mapping such a polygonal ambiguity region can be done efficiently, resulting in an N-point polygon in the birds-eye view.

FIGS. 45A and 45B show a BBTP 1172 in the camera view and mapped into the birds-eye view, respectively, wherein the dash-dot line 1174 in FIG. 45B represents the room perimeter.

FIGS. 46A and 46B show an example of an ambiguity region of a BBTP identified in the camera view and mapped into the birds-eye view, respectively. In this example, the imaging device is located at the corner of a 3D coordinate system at xW=0 and yW=0 with a height of zW=12 m. The imaging device has an azimuth rotation of azrot=pi/4 and a down tilt angle of downtilt=pi/3. For example, the object monitored by the imaging device could have a height of zO=5 m. Ambiguity mapped into BV based on outline contour of blob results from the 3D box object. The slight displacement shown is a result of the single erosion step taken of the blob.) One would decompose/analyze the blob to get a smaller BBTP polygon uncertainty region.

The PDF of the BBTP location is used for Bayesian update. In this embodiment, the PDF of the BBTP location is uniformly distributed within the ambiguity region, and is zero (0) outside the ambiguity region. Alternatively, the PDF of the BBTP location may be defined as Gaussian or other suitable distribution for taking into account random factors such as the camera orientation, lens distortion and other random factors. These random factors may also be mapped into the birds-eye view as a Gaussian process by determining the mean and covariance matrix thereof.

In this embodiment, the VAILS uses a statistic model based estimation method to track the BBTP of a BV object. The statistic model based estimation, such as a Bayesian estimation, used in this embodiment is similar to that described above. The Bayesian object prediction is a prediction of the movement of the BBTP of a BV object for the next frame time (i.e., the time instant the next image frame to be captured) based on information of the current and historical image frames as well as available tag observations. The Bayesian object prediction works well even if nothing is known regarding the motion of the mobile object (except the positions of the blob in captured images). However, if a measurement of the object's velocity is available, the Bayesian object prediction may use the object's velocity in predicting the movement of the BBTP of a BV object. The object's velocity may be estimated by the blob Kalman filter tracking of the velocity state variable, based on the optical flow and feature point motion of the camera view bounding box. Other mobile object attributes, such as inertia, maximum speed, object behavior (e.g., a child likely behaving differently than an attendant pushing someone in a wheelchair), and the like. As described above, after object prediction, blob/BV object/tag device association is established, and the prediction result is feedback to computing vision process. The detail of the birds-eye view Bayesian processing is described later.

VIII-7. Updating Posterior Probability of Object Location

Updating posterior probability of object location is based on the blob track table in the computer cloud 108, which is conducted after the blob/BV object/tag device association is established. The posterior object location pdf is obtained by multiplying the current object location pdf by the blurred polygon camera view observation pdf. Other observations such as tag observations and RSS measurement may also be used for updating posterior probability of object location.

VIII-8. Association Table Update

The blob/BV object/tag device association is important to mobile object tracking. An established blob/BV object/tag device association is the association of a tagged mobile object associated with a set of blobs through the timeline or history. Based on such an association, the approximate BV object location can be estimated based on the mean of the posterior pdf. The system records the sequential activities of the tagged mobile object, e.g., “entered door X of the room Y at time T, walked through central part of room and left at time T2 through entrance Z”. Established blob/BV object/tag device association are stored in an association table. The update of the association table and the Bayesian object prediction update are in parallel and co-dependent. In one alternative embodiment, the system may establish multiple blob/BV object/tag device associations as candidate associations for a mobile object, track the candidate associations, and eventually select the most likely one as the true blob/BV object/tag device association for the mobile object.

VIII-9. DBN Update

The VAILS in this embodiment uses a dynamic Bayesian network (DBN) for calculating and predicting the locations of BV objects. Initially, the camera view processing submodule operates independently to generate a blob-track file. The DBN then starts with this blob-track file, transforms the blob therein into a BV object and tracks the trajectory probability. The blob-track file contains the sequence of likelihood metrics based on the blob correlation coefficient.

As described before, each blob/BV object/tag device association is associated with an association probability. If the association probability is smaller than a predefined threshold, object tracking is then interrupted. To prevent object tracking interruption due to temporarily lowered association probability, a state machine with suitable intermediate states may be used to allow an association probability to temporarily lower for a short period of time, e.g., for several frames, and increase to above the predefined threshold.

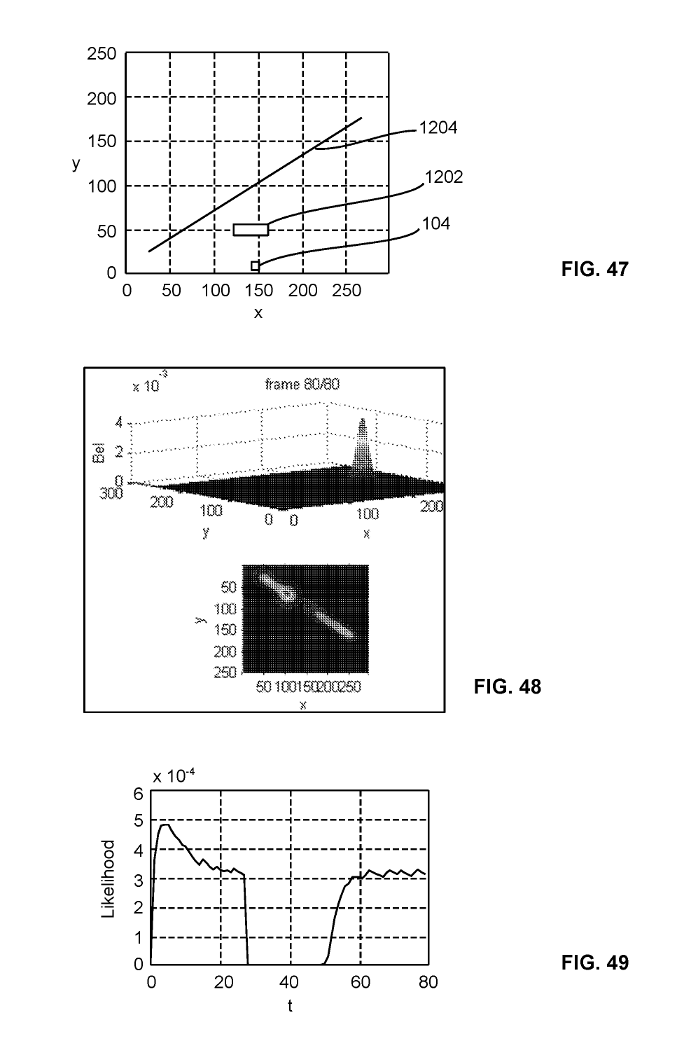

FIG. 47 shows a simulation configuration having an imaging device 104 and an obstruction 1202 in the FOV of the imaging device 104. A mobile object moves along the path 1204. FIG. 48 shows the results of the DBN prediction.

Tracking of a first mobile object may be interrupted when the first mobile object is occluded by an obstruction in the FOV. During the occlusion period, the probability diffuses outward. Mobile object tracking may be resumed after the first mobile object comes out of the obstruction and re-appears in the FOV.

However if there is an interfering source such as a second mobile object also emerging from a possible location that the first mobile object may re-appear, the tracking of the first mobile object may be mistakenly resumed to tracking the second mobile object. Such a problem is due to the fact that, during occlusion, the probability flow essentially stops and then diffuses outward, becoming weak when tracking is resumed. FIG. 49 shows the prediction likelihood over time in tracking the mobile object of FIG. 47. As shown, the prediction likelihood drops to zero during occlusion, and only restores to a low level after tracking is resumed.

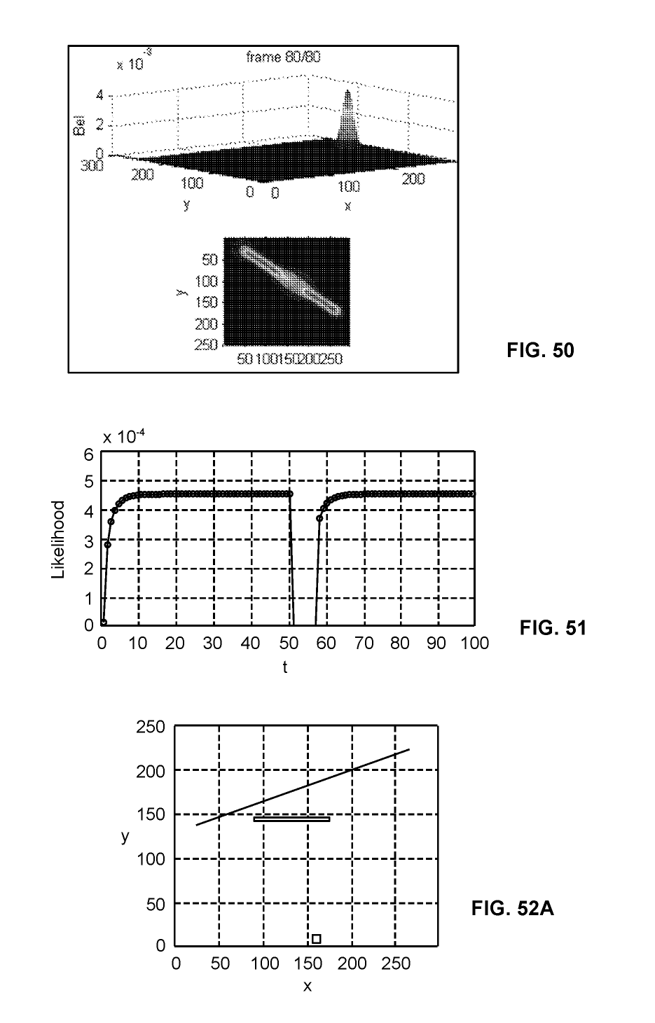

If velocity feedback is available, it may be used to improve the prediction. FIG. 50 shows the results of the DBN prediction in tracking the mobile object of FIG. 47. The prediction likelihood is shown in FIG. 51, wherein the circles indicate camera view observations are made, i.e., images are captured, at the corresponding time instants. As can be seen, after using velocity feedback in DBN prediction, the likelihood after resuming tracking only exhibits a small drop. On the other hand, if the prediction likelihood after resuming tracking drops significantly below a predefined threshold, a new tracking is started.

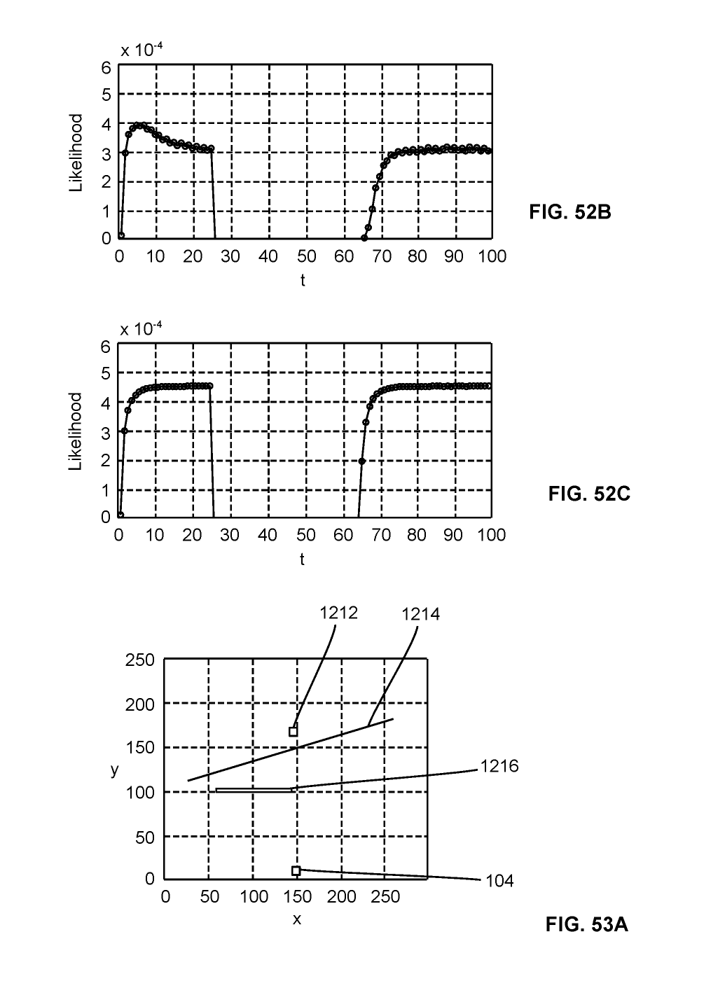

FIGS. 52A to 52C show another example of a simulation configuration, the simulated prediction likelihood without velocity feedback, and the simulated prediction likelihood with velocity feedback, respectively.

To determine if it is the same object when the blob re-emerges or it is a different object, the system calculates the probability of the following two possibilities:

A—assuming the same object: considering the drop in association likelihood and considering querying the tag device to determine if a common tag device corresponding to both blobs.

B—assuming different objects: what is the likelihood that a new object can be spontaneously generated at the start location of the trajectory after the tracking is resumed? What is the likelihood that the original object vanished?

Blob-track table stores multiple tracks, and the DBN selects the most likely one.

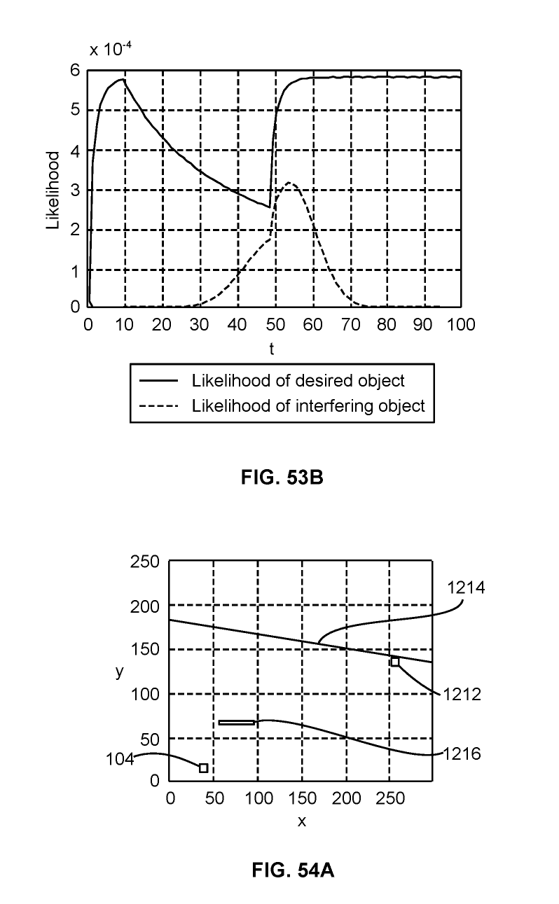

FIG. 53A shows a simulation configuration for simulating the tracking of a first mobile object (not shown) with an interference object 1212 nearby the trajectory 1214 of the first mobile object and an obstruction 1216 between the imaging device 104 and the trajectory 1214. The camera view processing submodule produces a bounding box around each of the first, moving object and the stationary interference object 1212, and the likelihood of the two bounding boxes are processed.

The obstruction 1216 limits the camera view measurements, and the nearby stationary interference 1212 appears attractive as the belief will be spread out when the obstruction is ended. The likelihood is calculated based on the overlap integration and shown in FIG. 42. The calculated likelihood is shown in FIG. 53B.

At first the likelihood of the first object builds up quickly but then starts dropping as the camera view measurements stops due to the obstruction. However, the velocity is known and therefore the likelihood of the first object doesn't decay rapidly. Then the camera view observations resume after the obstruction and the likelihood of the first object jumps back up.

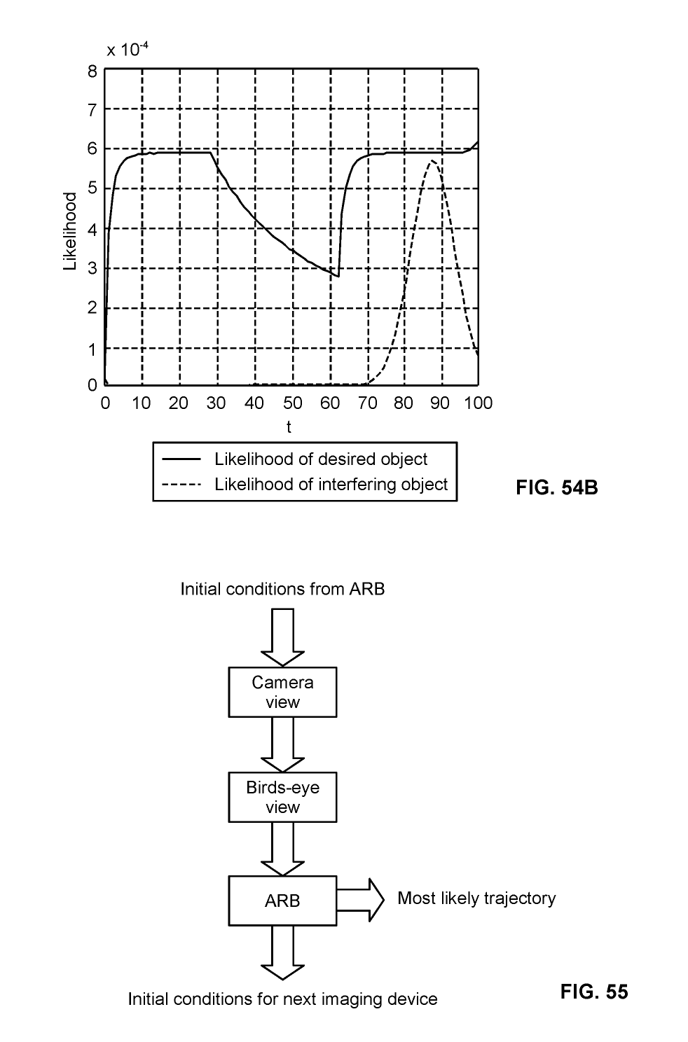

FIGS. 54A and 54B show another simulation example.

VIII-10. Network Arbitrator

Consider the simple scenario of FIG. 25. The initial conditions originate from the network arbitrator, which evaluates the most likely trajectory of the mobile object 112A as it goes through the site consisting of multiple imaging devices 104B,A,C. The network arbitrator attempts to output the most likely trajectory of the mobile object from the time the mobile object enters the site to the time the mobile object exits the site, which may last for hours. The mobile object moves from the FOV of one imaging device to that of the next. As the mobile object enters the FOV of an imaging device, the network arbitrator collects initial conditions relevant to the CV/BV processing module and sends the collected initial conditions thereto. The CV/BV processing module is then responsible for object tracking. When the mobile object leaves the FOV of the current imaging device, the network arbitrator again collects relevant initial conditions for the next imaging device and sends to the CV/BV processing module. This procedure repeats until the mobile object eventually leaves the site.

In the simple scenario of FIG. 25, the object trajectory is simple and unambiguous such that the object's tag device does not have to be queried. However, if an ambiguity regarding the trajectory or regarding the blob/BV object/tag device association arises, then the tag device will be queried. In other words, if the object trajectory seems dubious or confused with another tag device, the network arbitrator handles requests for tag observations to resolve the ambiguity. The network arbitrator has the objective of minimizing the energy consumed by the tag device subject to the constraint of the acceptable likelihood of the overall estimated object trajectory.

The network arbitrator determines the likely trajectory based on a conditional Bayesian probability graph, which may have high computational complexity.

FIG. 55 shows the initial condition flow and the output of the network arbitrator. As shown, initial conditions come from network arbitrator and is used in camera view to acquire and track the incoming mobile object as a blob. The blob trajectory is stored in the blob-track file and is passed to the birds-eye view. The birds-eye view does a perspective transformation of the blob track and does a sanity check on the mapped object trajectory to ensure that all constraints are satisfied. Such constraints includes, e.g., that the trajectory cannot pass through building walls, pillars, propagate at enormous velocities, and the like. If constraints are violated then the birds-eye view will distort the trajectory as required, which is conducted as a constrained optimization of likelihood. Once the birds-eye view constraints are satisfied, the birds-eye view reports to the network arbitrator, and the network arbitrator puts the trajectory into the higher level site trajectory likelihood.

The network arbitrator is robust to handle errors to avoid failures, such as prediction having no agreement with camera view or with tag observation, camera view observations and/or tag observations stopped due to various reasons, a blob being misconstrued as a different object and the misconstruing being propagated into another subarea of the site, invalid tag observations, and the like.

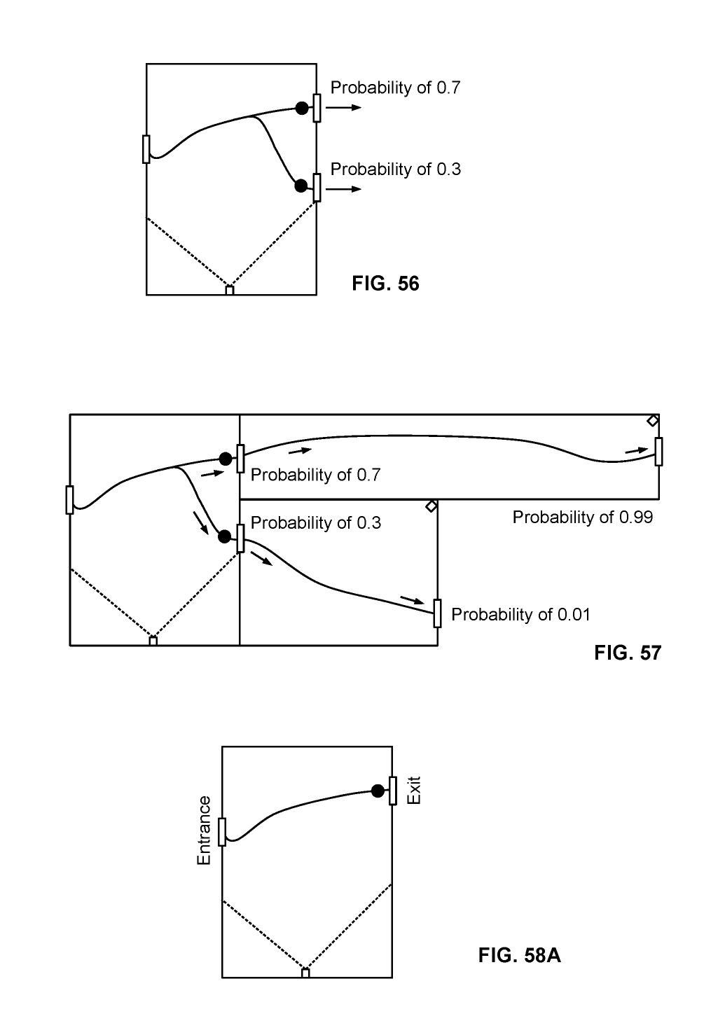

The network arbitrator resolves ambiguities. FIG. 56 shows an example, wherein the imaging device reports that a mobile object exits from an entrance on the right-hand side of the room. However, there are two entrances on the right-hand side, and ambiguity arises in that it is uncertain which of the two entrances the mobile object takes to exit from the room.

The CV/BV processing module reports both possible paths of room-leaving to the network arbitrator. The network arbitrator processes both paths using camera view and tag observations until the likelihood of one of the paths attains a negligibly low probability, and is excluded.

FIG. 57 shows another example, wherein the network arbitrator may delay the choice among candidate routes (e.g., when the mobile object leaves the left-hand side room) if the likelihoods of candidate routes are still high, and make a choice when one candidate route exhibits sufficiently high likelihood. In FIG. 57, the upper route is eventually selected.

Those skilled in the art appreciate that many graph theory and algorithms, such as the Viterbi algorithm, are readily available for selecting the most likely route from a plurality of candidate routes.

If a tag device reports RSS measurements of a new set of WiFi access point transmissions, then a new approximate location can be determined and the network arbitrator may request the CV/BV processing module to look for a corresponding blob among the detected blobs in the subarea of the WiFi access point.

VIII-11. Tag Device

Tag devices are designed to reduce power consumption. For example, if a tag device is stationary for a predefined period of time, the tag device then automatically shut down with a timing clock and the accelerometer remaining in operation. When the accelerometer senses sustained motion, i.e., not merely a single impulse disturbance, then the tag device is automatically turned on and establishes communication with the network arbitrator. The network arbitrator may use the last known location of the tag device as the current location thereof, and later updates its location with incoming information, e.g., new camera view observations, new tag observations and location prediction.

With suitable sensors therein, tag devices may obtain a variety of observations. For example,
RSS of wireless signals: the tag device can measure the RSS of one or more wireless signals, indicate if the RSS measurements are increasing, decreasing, and determine the short term variation thereof;
walking step rate: which can be measured and compared directly with the bounding box in camera view;
magnetic abnormalities: the tag device may comprise a magnetometer for detecting magnetic field with a magnitude, e.g., significantly above 40 μT;
measuring temperature for obtaining additional inferences; for example, if the measured temperature is below a first predefined threshold, e.g., 37° C., then the tag device is away from the human body, and if the measured temperature is about 37° C., then the tag device is on the human body. Moreover, if the measured temperature is below a second predefined threshold, e.g., 20° C., then it may indicates that the associated mobile object is in outdoor; and
other measurement, e.g., the rms sound level.

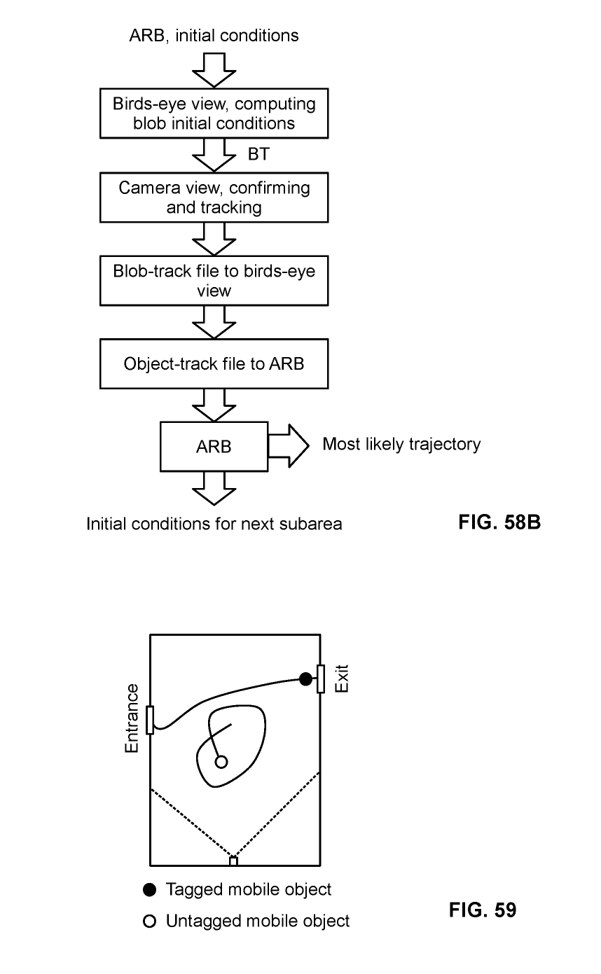

FIG. 58B shows the initial condition flow and the output of the network arbitrator in a mobile object tracking example of FIG. 58A. A single mobile object moves across a room. The network arbitrator provides the birds-eye view with a set of initial conditions of mobile object entering the current subarea. The birds-eye view maps the initial conditions into the location that the new blob is expected. After a few image frames the camera view affirms to the birds-eye view that it has detected the blob and the blob-track file is initiated. The birds-eye view tracks the blob and updates the object-track file. The network arbitrator has access to the object-track file and can provide an estimate of the tagged object at any time. When the blob finally vanishes at an exit point, this event is logged in the blob-track file and the birds-eye view computes the end of the object track. The network arbitrator then assembles initial conditions for the next subarea. In this simple example, there is no query to the tag device as the identity of the blob was never in question.

Tagged object may be occluded by untagged object. FIG. 59 shows an example, and the initial condition flow and the output of the network arbitrator are the same as FIG. 58B. In this example, the initial conditions are such that the tagged object is known when it walks through the left-hand side entrance, and that the untagged object is also approximately tracked. As the tracking progresses, the tagged object occasionally becomes occluded by the untagged object. The camera view will give multiple tracks for the tagged object. The untagged object is continuously trackable with feature points and optical flow. That is, the blob events of fusion and fission are sortable for the untagged object. In the birds-eye view, the computation of the blob-track file to object-track file will request a sample of activity from the tag through the network arbitrator. In this scenario the tag will reveal continuous walking activity, which, combined with the prior existence of only one tagged and one untagged object, forces the association of the segmented tracks of the object-track file with high probability. When the tagged object leaves the current subarea, the network arbitrator assembles initial conditions for the next subarea.

In this example, for additional confirmation, the tag device can be asked if it is undergoing a rotation motion. The camera view senses the untagged object has gone through about 400 degrees of turning while the tagged object only 45 accumulated. However, as the rate gyros require significantly more power than other sensors, such as request will not be sent to the tag device if the ambiguity can be resolved using other tag observations, e.g., observation from the accelerometer.

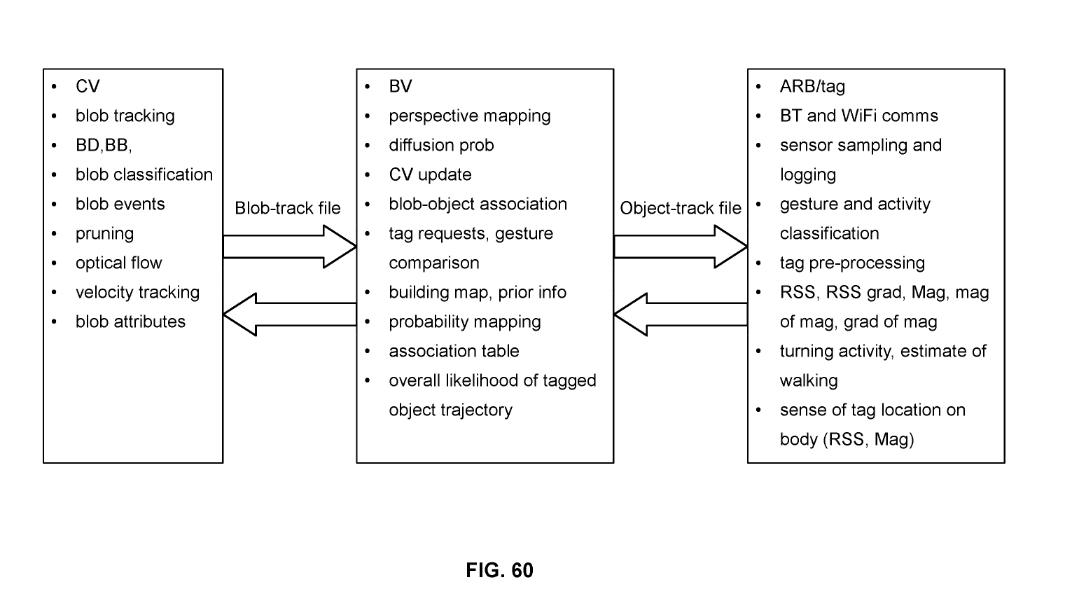

FIG. 60 shows the relationship between the camera view processing submodule, birds-eye view processing submodule, and the network arbitrator/tag devices.

VIII-12. Birds-Eye View (BV) Bayesian Processing

In the following the Bayesian update of the BV is described. The Bayesian update is basically a two-step process. The first step is a prediction of the object movement for the next frame time, followed by update based on a general measurement. It would be basic diffusion if nothing is known of the motion of the object. However, if an estimate of the blob velocity is available, and that the association of the blob and object is assured, then the estimate of the blob velocity is used. This velocity estimate is obtained from the blob Kalman filter tracking of the velocity state variable, based on the optical flow and feature point motion of the camera view bounding box with known information of the mobile object.

(i) Diffuse Prediction Probability Based on Arbitrary Building Wall Constraints

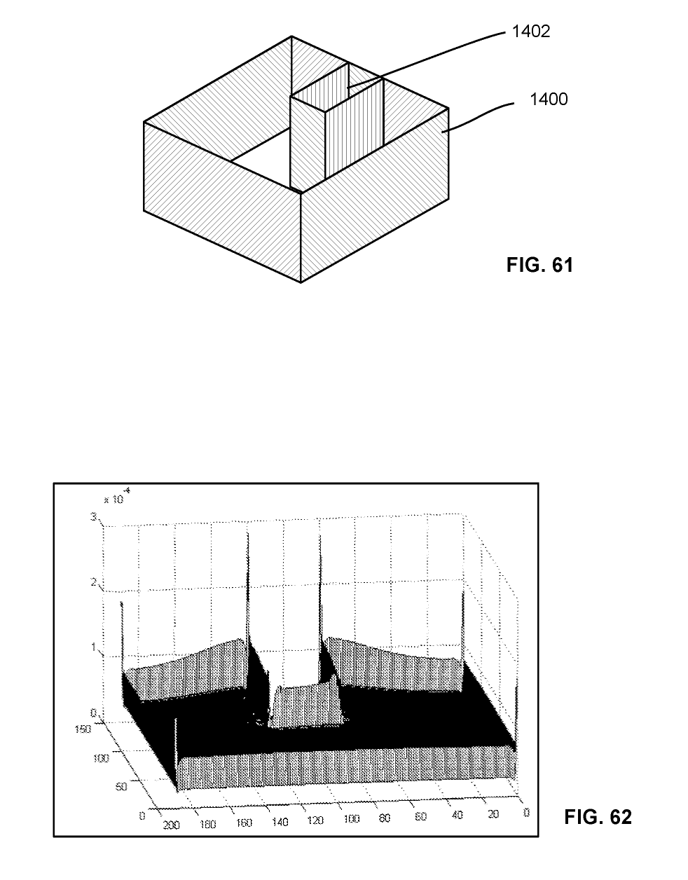

In this embodiment, the site map has constraints of walls with predefined wall lengths and directions. FIG. 61 shows a 3D simulation of a room 1400 having an indentation 1402 representing a portion of the room that is inaccessible to any mobile objects. The room is partitioned into a plurality of grid points.

The iteration update steps are as follows:

S1. Let the input PDF be Po. Then the Gaussian smearing or diffusion is applied by the 2D convolution, resulting in P1. P1 represents the increase in the uncertainty of the object position based on underlying random motion.

S2. The Gaussian kernel has a half width of H_{hf} such that P1 is larger than Po by a border of width. The system considers that the walls are reflecting walls such that the probability content in these borders is swept inside the walls of Po.

S3. In the inaccessible region, the probability content of each grid point in the inaccessible region is set to that of the closest (in terms of Euclidean distance) wall grid point. The correspondence of the inaccessible grid points and the closest wall points is determined as part of the initialization process of the system, and thus is only done once. To save calculations in each iteration, every inaccessible grid point is pre-defined with a correction, forming an array of corrections. The structure of this matrix is

[Correction index, j_{source}, i_{source}, jₛᵢₙₖ, iₛᵢₙₖ]

S4. Finally the probability density is normalized such that it has an integrated value of one (1). This is necessary as the corner fringe regions are not swept and hence there is a loss of probability.

The probability after sufficient number of iterations to approximate a steady state is given in FIG. 62 for the room example of FIG. 61. In this example, the process starts with a uniform density throughout the accessible portion of the room, implying no knowledge of where the mobile object is. Note that the probability is higher in the vicinity of the walls as the probability impinging on the walls is swept back to the wall position. On the other hand, the probability in the interior is smaller but non-zero, and appears fairly uniform. Of course this result is a product of the heuristic assumptions of appropriating probability mass that penetrates into inaccessible regions. Actually, when measurements are applied the probability ridge at the wall contour becomes insignificant.

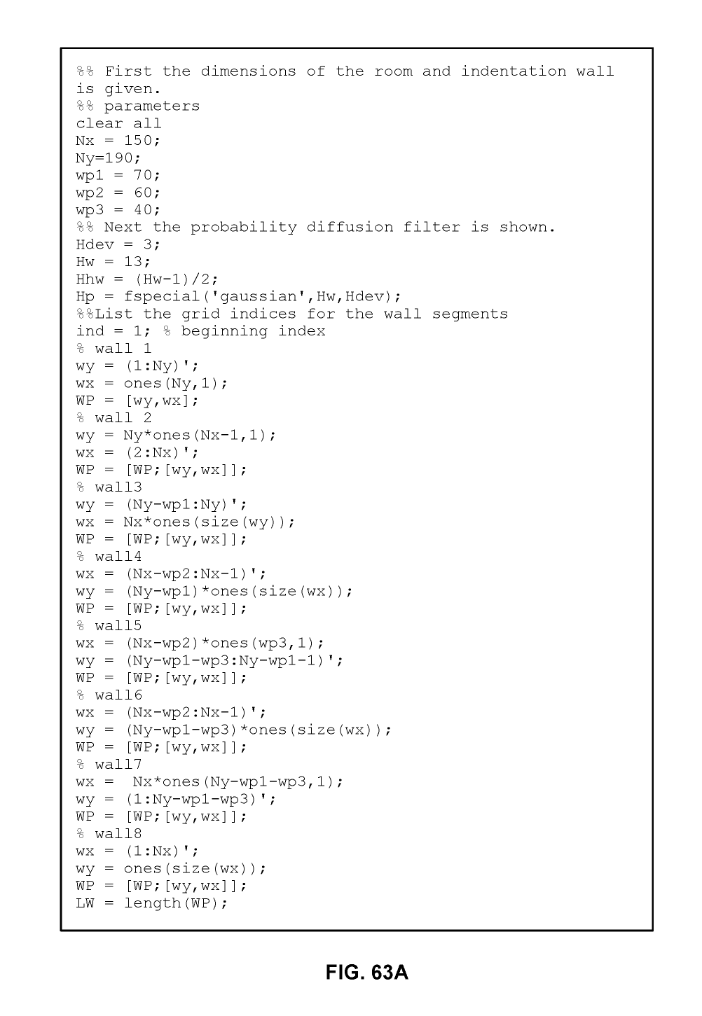

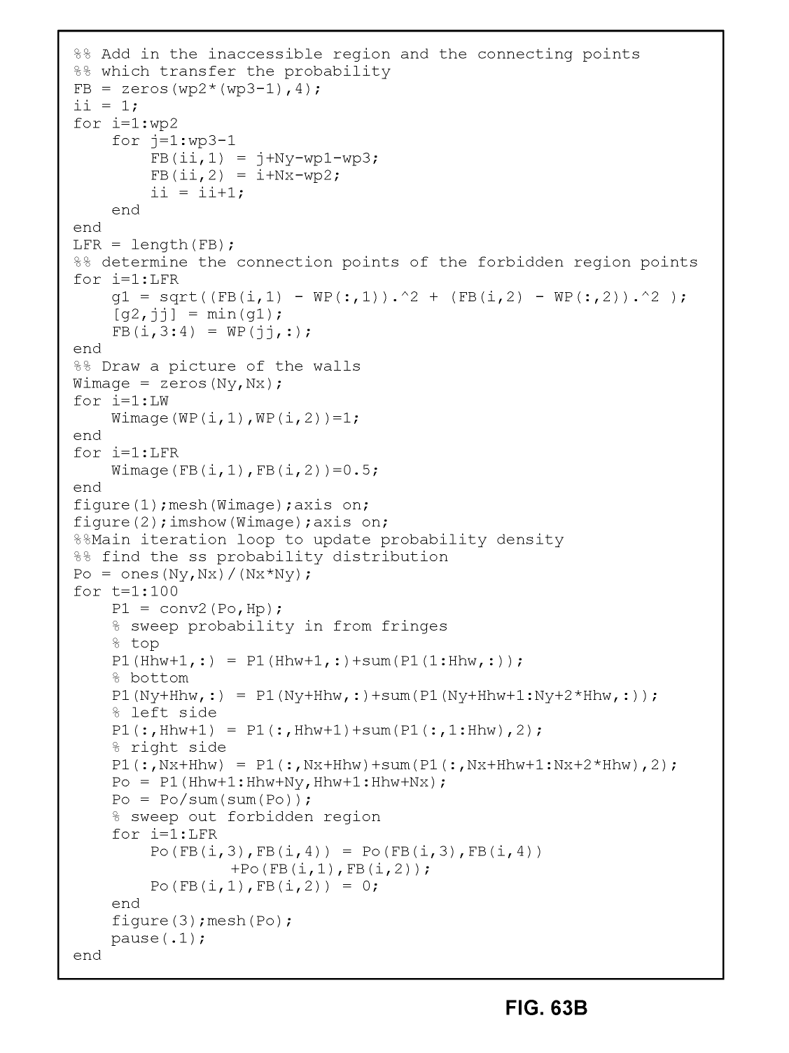

FIGS. 63A and 63B show a portion of the MATLAB® code used in the simulation.

(ii) Update Based on a General Measurement

Below, based on standard notation, x is used as the general state variable and z is used as a generic measurement related to the state variable. The Bayes rule is then applied as

$$p ( x \vert z ) = \frac{p ( z \vert x ) p ( x )}{p ( z )} = η p ( z \vert x ) p ( x ) , \qquad ( 31 )$$

where p(x) can be taken as the pdf prior to the measurement of z and p(x|z) is conditioned on the measurement. Note then that p(z|x) is the probability of the measurement given x. In other words, given the location x then p(z|x) is the likelihood of receiving a measurement z. Note that z is not a variable; rather it is a given measurement. Hence as z is somewhat random in every iteration then so is p(z|x), which can be a source of confusion.

Putting this into the evolving notation, the calculation of the pdf after the first measurement given can be expressed as

p_{j,i}¹=ηp_{z,j,i}¹p_{u,j,i}⁰. (32)

Here, p_{z,j,i}¹ is the probability or likelihood of the observation z given that the object is located at the grid point of {jΔ_{g},iΔ_{g}}. The prior probability of p_{j,i}⁰ is initially modified based on the grid transition to generate the pdf with update as p_{u,j,i}⁰. This is subsequently updated with the observation likelihood of p_{z,j,i}¹, resulting in the posterior probability of p_{j,i}¹ for the first update cycle. η is the universal normalization constant that is implied to normalize the pdf such that it always sums to 1 over the entire grid.

Consider the simplest example of initial uniform PDF such that p_{j,i}⁰ is a constant and positive in the feasibility region where the probability in the inaccessible regions is set to 0. Furthermore, assume that the object is known to be completely static such that there is no diffusion probability, or the Gaussian kernel of the transition probability is a delta function. We can solve for the location pdf as

$$\begin{matrix}{p}_{u , j , i}^{0} = {p}_{j , i}^{0} , & ( 33 ) \\ {p}_{j , i}^{t} = η {\prod }_{k = 1}^{t} {p}_{z , j , i}^{k} {p}_{u , j , i}^{0} . & ( 34 )\end{matrix}$$

Finally assume that the observation likelihood is constant with respect to time such that p_{z,j,i}^{k}=p_{z,j,i}⁰. This implies that the same observation is made at each iteration but with different noise or uncertainty. For large t the probability of p_{j,i}^{t} will converge to a single delta function at the point where p_{z,j,i}⁰ is maximum (provided that p_{j,i}⁰ is not zero at that point). Also implicitly assumed is that the measurements are statistically independent. Note that p_{j,i}⁰ can actually be anything provided that there is a finite value at the grid point where p_{z,j,i}⁰ is maximum.

Next, consider the case where the update kernel has finite deviation, which implies that there will be some diffusing of the location probability after each iteration. The measurement will reverse the diffusion. Hence we have two opposing processes like the analogy of the sand pile where one process spreads the pile (update probability kernel) and another group builds up the pile (observations). Eventually a steady state equilibrium will result that is tantamount with the uncertainty of the location of the object.

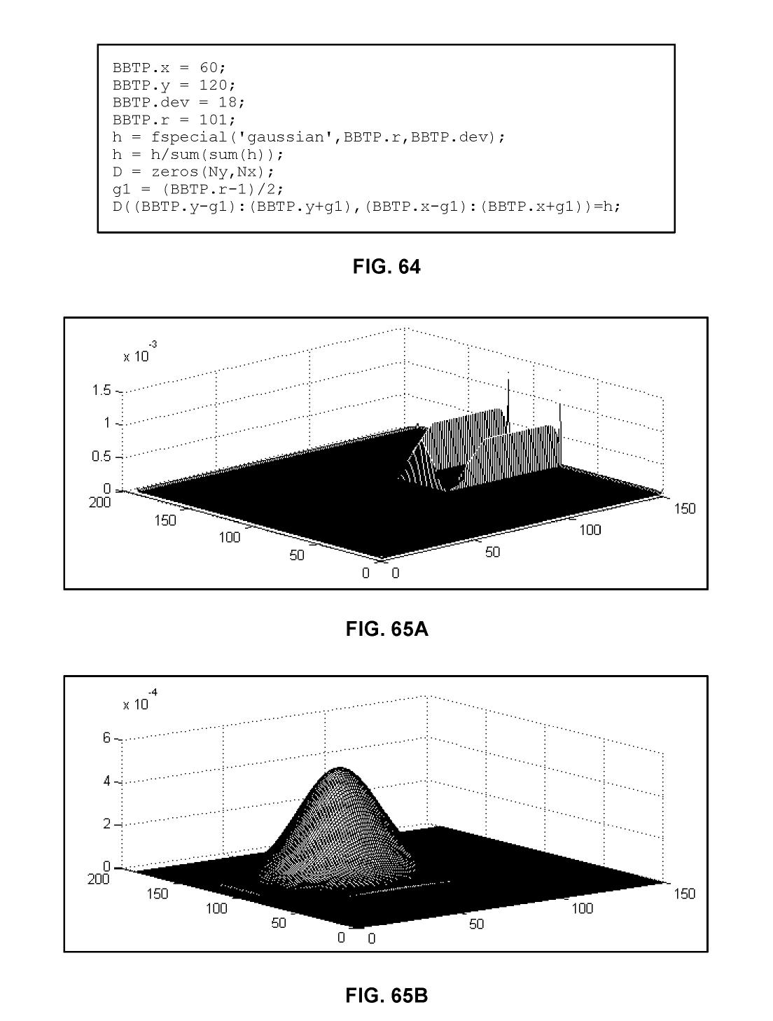

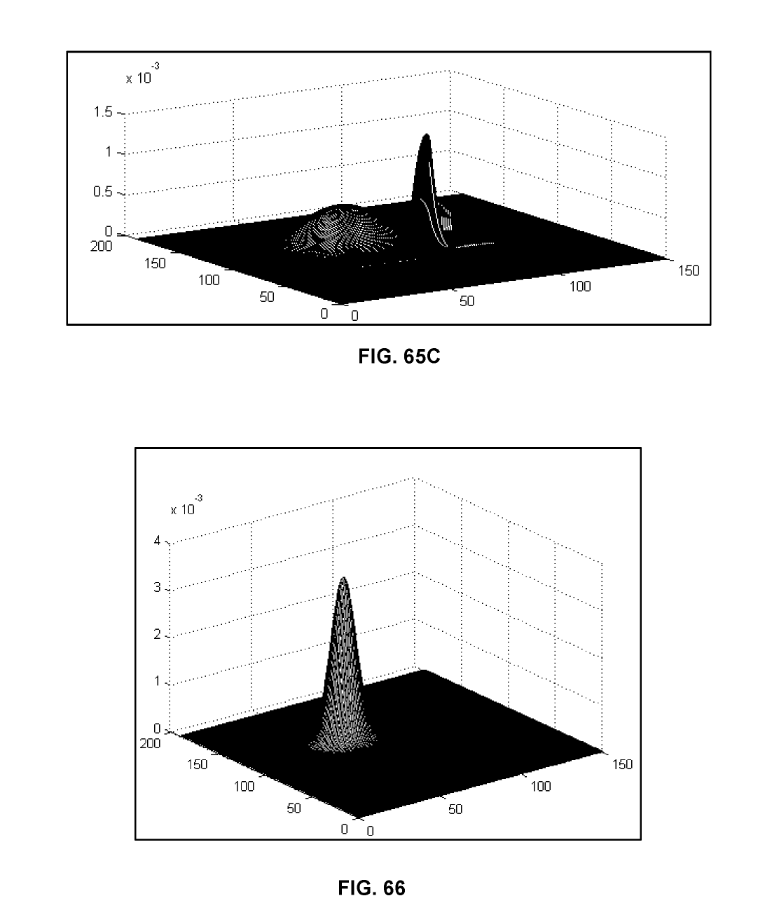

As an example, consider a camera view observation, which is described as a Gaussian shaped likelihood kernel (a PDF), and may be the BBTP estimate from the camera view. The Gaussian shaped likelihood kernel may be a simple 2D Gaussian kernel shape represented by the mean and deviation. FIG. 64 shows a portion of the MATLAB® code for generating such a PDF. FIGS. 65A to 65C show the plotting of p_{j,i}⁰ (the initial probability subject to the site map wall regions), p_{z,j,i}^{k}, which is the measurement probability kernel which is a constant shape every iteration but with a “random” offset equivalent to the actual measurement z, and is the variable D in the MATLAB® code of FIG. 64, and p_{j,i}¹ (the probability after the measurement likelihood has been applied).

After a few iterations, a steady state distribution is reached, an example of which is illustrated in FIG. 66. The steady state is essentially a weighting between the kernels of the diffusion and the observation likelihood. Note that in the example of FIG. 66, z is a constant such that p_{z,j,i}^{k} is always the same. On the other hand, in the practical cases there is no “steady state” distribution as z is random.

Consider the above example where the camera view tracking a blob in which the association of the blob and the mobile object is considered to be uninterrupted. In other words, there are no events causing ambiguity with regards to the one-to-one association between the moving blob and the moving mobile object. If nothing is known regarding the mobile object and the camera view does not track it with a Kalman filter velocity state variable, then the object probability merely diffuses in each prediction or update phase of the Bayesian cycle. This is tantamount to the object undergoing a two dimensional random walk. The deviation of this random walk model is applied in birds-eye view as it directly relates to the physical dimensions. Hence the camera view provides observations of the BBTP of a blob where nothing of the motion is assumed.

In the birds-eye view, the random walk deviation is made large enough such that the frame by frame excursions of the BBTP are accommodated. Note that if the deviation is made too small then the tracking will become sluggish. Likewise, if the deviation is too large then tracking will merely follow the measurement z and the birds-eye view will not provide any useful filtering or measurement averaging. Even if the object associated with the blob is unknown, the system is in an indoor environment tracking objects that generally do not exceed human walking agility. Hence practical limits of the deviation can be placed.

A problem occurs when the camera view observations are interrupted based on an obstruction of sorts like the object propagating behind an opaque wall. Now there will be an interruption in the blob tracks, and the birds-eye view then has to consider if these paths should be connected, i.e., if they should be associated with the same object. We calculated without camera view observations based on probability diffusion and realize that the probability “gets stuck” with centered at the end point of the first path with ever expanding deviation representing the diffusion. The association to the beginning of the second path is then based on a likelihood that initially grows but only reaches a small level. Hence the association is weak and dubious. The camera view cannot directly assist with the association of the two path segments as it has no assumptions of the underlying object dynamics. However, the camera view does know about the velocity of the blob just prior to the end of path 1 where camera view observations were lost.

Blob velocity can in principle be determined by the optical flow and movement of feature points of the blob resulting in a vector in the image plane. From this a mean velocity of the BBTP can be inferred by the camera view processing submodule alone. The BBTP resides on the floor surface (approximately) and then we can map this to the birds-eye view with the same routine that was used for the BBTP uncertainty probability polygon mapping onto the floor space. If the velocity vector is perfectly known then the diffusion probability is a delta function that is offset by a displacement vector that is the velocity vector times the frame update time. However, practically the velocity vector will have uncertainty associated with it and the diffusion probability will include this with a deviation. It is reasonable that the velocity uncertainty grows with time and therefore so should this deviation. This is of course heuristic but a bias towards drifting the velocity towards zero is reasonable.

VIII-13. H Matrix Processing

Below describes the H matrix processing necessary for the perspective transformations between the camera and the world coordinate systems. The meaning of variables in this section can be found in the tables of subsection “(vi) Data structures” below.

(i) Definition of Rotation Angles and Translation

Blobs in a captured image may be mapped to a 3D coordinate system using perspective mapping. However, such a 3D coordinate system, denoted as a camera coordinate system, is defined from the view of the imaging device or camera that captures the image. As the site may comprises a plurality of image devices, there may exist a plurality of camera coordinate systems, each of which may only be useful for the respective subarea of the site.

On the other hand, the site has an overall 3D coordinate system, denoted as a world coordinate system, for site map and for tracking mobile objects therein. Therefore there may need to a mapping between the world coordinate system and a camera coordinate system.

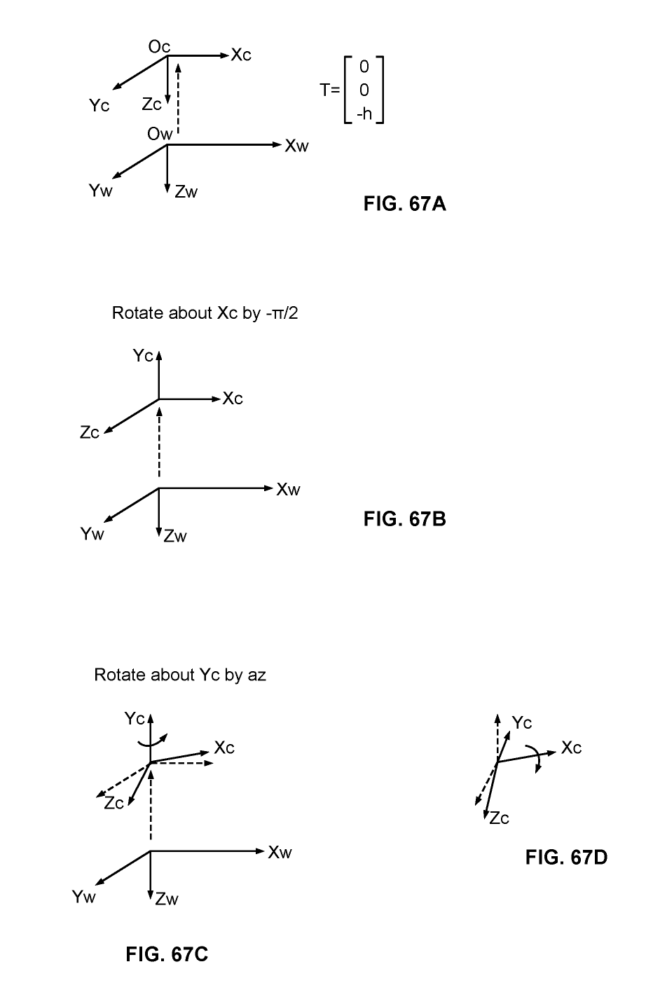

The world and camera coordinate systems are right hand systems. FIG. 67A shows the orientation of the world and camera coordinate systems with the translation vector T=[0 0 −h]^{T}. First rotate about Xc by (−pi/2) as in FIG. 67B. Rotation matrix is

$${R}_{1} = [ \begin{matrix}1 & 0 & 0 \\ 0 & 0 & - 1 \\ 0 & 1 & 0\end{matrix} ] . \qquad ( 35 )$$

Next, rotate in azimuth about Yc in the positive direction by az as in FIG. 67C. The rotation matrix is given as

$${R}_{2} = [ \begin{matrix}C & 0 & - S \\ 0 & 1 & 0 \\ S & 0 & C\end{matrix} ] , \qquad ( 36 )$$

where C=cos(az) and S=sin(az). Finally we do the down tilt of atilt as shown in FIG. 67D. The rotation is given by

$${R}_{3} = [ \begin{matrix}1 & 0 & 0 \\ 0 & C & S \\ 0 & - S & C\end{matrix} ] , \qquad ( 37 )$$

where C=cos(atilt) and S=sin(atilt). The overall rotation matrix is R=R₃R₂R₁, wherein the order of the matrix multiplication is important.

After the translation and rotation the camera scaling (physical distance to pixels) and the offset in pixels is applied.

$$\begin{matrix}x = s \frac{{x}_{c}}{{z}_{c}} + ox , & ( 38 ) \\ y = s \frac{{y}_{c}}{{z}_{c}} + oy . & ( 39 )\end{matrix}$$

x and y are the focal image plane coordinates which are in terms of pixels.

(ii) Direct Generation of the H Matrix

The projective mapping matrix is given as H=[R −RT] with the mapping of a world point to a camera point as

$$[ \begin{matrix}{x}_{c} \\ {y}_{c} \\ {z}_{c}\end{matrix} ] = H [ \begin{matrix}{x}_{w} \\ {y}_{w} \\ {z}_{w} \\ 1\end{matrix} ] . \qquad ( 40 )$$

Note that we still have to apply the offset and the scaling to map into the focal plane pixels.

(iii) Determining the H Matrix Directly from the Image Frame

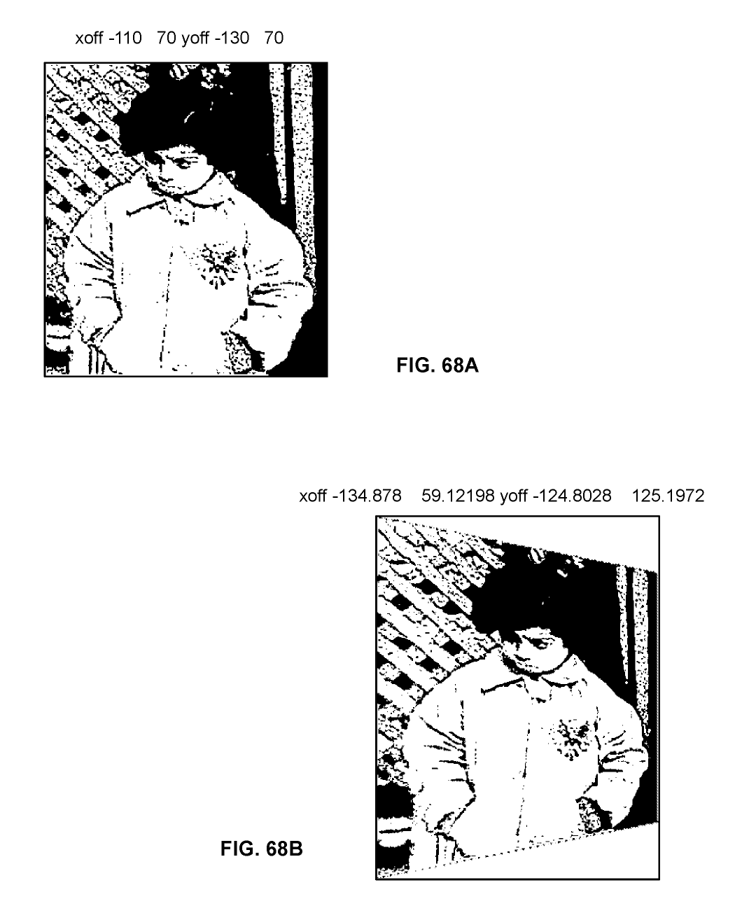

Instead of using the angles and camera height from the floor plane to get R and T and subsequently H, we can compute H directly from an image frame if we have a set of points on the floor and image that correspond. These are called control points. This is very useful procedure as it allows us to map from the set of control points to H to R and T. To illustrate this, suppose we have a picture that is viewed with the camera from which we can determine the four vertex points as shown in FIGS. 68A and 68B.

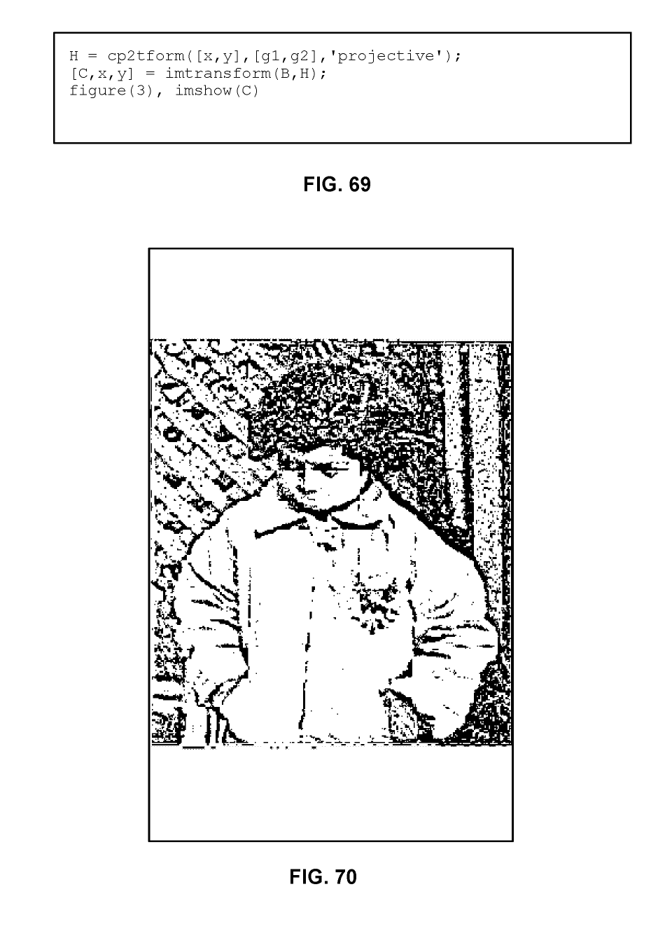

We can easily look at the camera frame and pick out the 4 vertex points of the picture unambiguously. Suppose that the vertex points of Pout are given by (−90, −100), (90, −100), (90, 100) and (−90, 100). The corresponding vertex points in the camera image are given as (0.5388, 1.2497), (195.7611, 39.3345), (195.7611, 212.3656) and (0.8387, 251.3501). We can then run a suitable function, e.g., the cp2tform( ) MATLAB® function, to determine the inverse projective transform. The MATLAB® code is shown in FIG. 69.

In FIG. 69, [g1,g2] is the set of input points of the orthographic view, which is the corner vertex points of the image. [x,y] is the set of output points, which are the vertex points of the image picked off the perspective image. These are used to construct the transformation matrix H. H can be used in, e.g., the MATLAB® imtransform( ) function to “correct” the distorted perspective image FIG. 68B back to the orthographic view resulting in FIG. 70.

Note that here we have used 4 vertex points. We may alternatively use more points and then H will be solved in a least-square sense.

The algorithm contained in cp2tform( ) and imtransform( ) is based on selecting control points that are contained in a common plane in the world reference frame. In the current case, the control points reside on the Z_{w}=0 plane. We will use the constraint of

$$[ \begin{matrix}{f}_{cx} \\ {f}_{cy} \\ {f}_{cz}\end{matrix} ] = [ \begin{matrix}{[ {R}_{1} ]}_{1} & {[ {R}_{1} ]}_{2} & \\ {[ {R}_{2} ]}_{1} & {[ {R}_{2} ]}_{2} & –RT \\ {[ {R}_{3} ]}_{1} & {[ {R}_{3} ]}_{2} & \end{matrix} ] [ \begin{matrix}{f}_{wx} \\ {f}_{wy} \\ 1\end{matrix} ] = H [ \begin{matrix}{f}_{wx} \\ {f}_{wy} \\ 1\end{matrix} ] \qquad ( 41 )$$

to first determine H and then extract the coefficients of {R, T}. The elements of H are denoted as

$$H = [ \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ] . \qquad ( 42 )$$

Note that the first two columns of H are the first two columns of R and the third column of H is −RT. The object then is to determine the 9 components of H from the pin hole image components. We have

$$\{ \begin{matrix}{f}_{x} = \frac{{f}_{cx}}{{f}_{cz}} = \frac{{H}_{11} {f}_{wx} + {H}_{12} {f}_{wy} + {H}_{13}}{{H}_{31} {f}_{wx} + {H}_{32} {f}_{wy} + {H}_{33}} , \\ {f}_{y} = \frac{{f}_{cy}}{{f}_{cz}} = \frac{{H}_{21} {f}_{wx} + {H}_{22} {f}_{wy} + {H}_{23}}{{H}_{31} {f}_{wx} + {H}_{32} {f}_{wy} + {H}_{33}} ,\end{matrix} \qquad ( 43 )$$

which is rearranged as

$$\{ \begin{matrix}{H}_{31} {f}_{x} {f}_{wx} + {H}_{32} {f}_{x} {f}_{wy} + {H}_{33} {f}_{x} = {H}_{11} {f}_{wx} + {H}_{12} {f}_{wy} + {H}_{13} , \\ {H}_{31} {f}_{y} {f}_{wx} + {H}_{32} {f}_{y} {f}_{wy} + {H}_{33} {f}_{y} = {H}_{21} {f}_{wx} + {H}_{22} {f}_{wy} + {H}_{23} .\end{matrix} \qquad ( 44 )$$

This results in a pair of constraints expressed as

$$\begin{matrix} \{ \begin{matrix}{u}_{x} b = 0 , \\ {u}_{y} b = 0.\end{matrix} \\ where & ( 45 ) \\ \{ \begin{matrix}b = & [ {H}_{11} & {H}_{12} & {H}_{13} & {H}_{21} & {H}_{22} & {H}_{23} & {H}_{31} & {H}_{32} & {{H}_{33} ]}^{T} , \\ {u}_{x} = & [ – {f}_{wx} & – {f}_{wy} & –1 & 0 & 0 & 0 & {f}_{x} {f}_{wx} & {f}_{x} {f}_{wy} & {f}_{x} ] , \\ {u}_{y} = & [ 0 & 0 & 0 & – {f}_{wx} & – {f}_{wy} & –1 & {f}_{y} {f}_{wx} & {f}_{y} {f}_{wy} & {f}_{y} ] .\end{matrix} & ( 46 )\end{matrix}$$

Note that we have a set of 4 points in 2D giving us 8 constraints but 9 coefficients of H. This is consistent with the solution of the homogeneous equation given to within a scaling constant as

$$[ \begin{matrix}{u}_{x , 1} \\ {u}_{y , 1} \\ ⋮ \\ {u}_{x , 4} \\ {u}_{y , 4}\end{matrix} ] b = [ \begin{matrix}0 \\ ⋮ \\ 0\end{matrix} ] . \qquad ( 47 )$$

Defining the matrix

$$U = [ \begin{matrix}{u}_{x , 1} \\ {u}_{y , 1} \\ ⋮ \\ {u}_{x , 4} \\ {u}_{y , 4}\end{matrix} ] , \qquad ( 48 )$$

we have Ub=0₈.

As stated above, any arbitrary line in the world reference frame is mapped into a line on the image plane. Hence the four lines of a quadrilateral in the world plane of Z_{w}=0 are mapped into a quadrilateral in the image plane. Each quadrilateral is defined uniquely by the four vertices, hence 8 parameters. We have 8 conditions which is sufficient to evaluate the perspective transformation including any scaling. The extra coefficient in H is due to a constraint that we have not explicitly imposed due to the desire to minimize complexity. This constraint is that the determinant of R is unity. The mapping in Equation (41) does not include this constraint and therefore we have two knobs that both result in the same scaling of the image. For example we can scale R by a factor of 2 and reduce the magnitude of T and leave the scaling of the image unchanged. Including a condition that |R|=1 or fixing T to a constant magnitude ruins the linear formulation of Equation (41). Hence we opt for finding the homogeneous solution to Equation (41) to within a scaling factor and then determining the appropriate scaling afterwards.

Using the singular value decomposition method (SVD), we have

U=xvw^{H}. (49)

As U is an 8×9 matrix the matrix, x is an 8×8 matrix of left singular vectors and w is a 9×9 matrix of right singular vectors. If there is no degeneracy in the vertex points of the two quadrilaterals (i.e., no three points are on a line) then the matrix v of singular values will be an 8×9 matrix where the singular values will be along the diagonal of the left 8×8 component of v with the 9th column as all zeros. Now let the 9th column of w be w₀, which is a unit vector orthogonal to the first 8 column vectors of w. Hence we can write

$${Uw}_{0} = {xvw}^{H} {w}_{0} = xv [ \begin{matrix}0 \\ ⋮ \\ 0 \\ 1\end{matrix} ] = x {0}_{9 \times 1} = {0}_{9 \times 1} . \qquad ( 50 )$$

Hence w₀ is the desired vector that is the solution of the homogeneous equation to within a scaling factor. That is, b=w₀. The SVD method is more robust in terms of the problem indicated above that H₃₃ could potentially be zero. However, the main motivation for using the SVD is that the vertices of the imaged quadrilaterals will generally be slightly noisy with lost resolution due to the spatial quantization. However, the 2D template pattern may have significantly many more feature points than the minimum four assumed. The advantage of using the SVD method is that it provides a convenient method of incorporating any number of feature point observations greater or equal to the minimum requirement of 4. Suppose n feature points are used. Then the v matrix will be 2n×9 with the form of a 9×9 diagonal matrix with the 9 singular values and the bottom block matrix of size (2n−9)×9 of all zeros. The singular values will be nonzero due to the noise and hence there will not be a right singular vector that corresponds to the null space of U. However, if the noise or distortion is minor then one of the singular values will be much smaller than the other 8. The right singular vector that corresponds to this singular value is the one that will result in smallest magnitude of the residual ∥Aw₀∥². This can be shown as follows

$$\begin{matrix}{‖ {Aw}_{0} ‖}^{2} = {w}_{0}^{H} {A}^{H} {Aw}_{0} \\ = {w}_{0}^{H} {wvx}^{H} {xvww}_{0} \\ = {λ}_{smallest}^{2}\end{matrix} \qquad ( 51 )$$

where λₛₘₐₗₗₑₛₜ² denotes the smallest singular value and w₀ is the corresponding right singular vector.

Once w₀ is determined by the svd of U, then we equate b=w₀ and H is extracted from b. We then need to determine the scaling of H.

Once H is determined, then we can map any point in the Z_{w}=0 plane to the image plane based on

$$\{ \begin{matrix}{f}_{x} = \frac{{H}_{11} {f}_{wx} + {H}_{12} {f}_{wy} + {H}_{13}}{{H}_{31} {f}_{wx} + {H}_{32} {f}_{wy} + {H}_{33}} , \\ {f}_{y} = \frac{{H}_{21} {f}_{wx} + {H}_{22} {f}_{wy} + {H}_{23}}{{H}_{31} {f}_{wx} + {H}_{32} {f}_{wy} + {H}_{33}} ,\end{matrix} \qquad ( 52 )$$

(iv) Obtaining R and T from H

From H we can determine the angles associated with the rotation and the translation vector. Details of this depends on the set of variables used. One possibility is the Euler angles of {aₓ, a_{y}, a_{z}}, a translation of {x_{T}, y_{T}, z_{T}} and scaling values of {sₓ, s_{y}, s_{z}}. The additional variable of s is a scaling factor that is necessary as H will generally have an arbitrary scaling associated with it. Additionally there are scaling coefficients of {sₓ, s_{y}} that account for the pixel dimensions in x and y. We have left out the offset parameters of {ox, oy}. These can be assumed to be part of the translation T. Furthermore the parameters {ox, oy, sₓ, s_{y}} are generally assumed to be known as part of the camera calibration.

The finalized model for H is then

$$H = s [ \begin{matrix}{s}_{x} & 0 & 0 \\ 0 & {s}_{y} & 0 \\ 0 & 0 & 1\end{matrix} ] [ \begin{matrix}{[ {R}_{1} ]}_{1} & {[ {R}_{1} ]}_{2} & \\ {[ {R}_{2} ]}_{1} & {[ {R}_{2} ]}_{2} & –RT \\ {[ {R}_{3} ]}_{1} & {[ {R}_{3} ]}_{2} & \end{matrix} ] \qquad ( 53 )$$

(v) Mapping from the Image Pixel to the Floor Plane

The mapping from the camera image to the floor surface is nonlinear and implicit. Hence we use MATLAB® fsolve( ) to determine the solution of the set of equations for {x_{w}, y_{w}}. For this example we assume that H is known from the calibration as well as s, ox and oy.

$$\begin{matrix}[ \begin{matrix}{x}_{c} \\ {y}_{c} \\ {z}_{c}\end{matrix} ] = H [ \begin{matrix}{x}_{w} \\ {y}_{w} \\ 0 \\ 1\end{matrix} ] . & ( 54 ) \\ x = s \frac{{x}_{c}}{{z}_{c}} + ox , & ( 55 ) \\ y = s \frac{{y}_{c}}{{z}_{c}} + oy , & ( 56 )\end{matrix}$$

Note that z_{w} has been set to zero as we are assuming the point on the floor surface.

(vi) Data Structures

Structures are used to group the data and pass it to functions as global variables. These are given as follows:

buildmap—describing the map of the site, including structure of all building dimensions, birds eye floor plan map. Members are as follows:

| member | description |
|---|---|
| XD | Overall x dimension of floor in meters |
| YD | Overall x dimension of floor in meters |
| dl | Increment between grid points |
| Nx, Ny | Number of grid points in x and y |

scam—structure of parameters related to the security camera. We are assuming the camera to be located at x=y=0 and a height of h in meters.

| member | description |
|---|---|
| h | Height of camera in meters |
| az | Azimuth angle in radians |
| atilt | Downtilt angle of the camera in radians |
| s | Scaling factor |
| ox | Offset in x in pixels |
| oy | Offset in y in pixels |
| T | 3D translation vector from world center to camera |
| | center in world coordinates |
| H | Projective mapping matrix from world to camera |
| | coordinates |

obj—structure of parameters related to each object (multiple objects can be accommodated)

| member | description |
|---|---|
| xo, yo | Initial position of the object |
| H, w, d | Height, width and depth of object |
| c | Homogeneous color of object in [R, G, B] |
| vx, vy | Initial velocity of the object |

misc—miscellaneous parameters

| member | description |
|---|---|
| Nf | Number of video frames |
| t | Index of video frame |
| Vd | Video frame array |

As those skilled in the art appreciate, in some embodiments, a site may be divided into a number of subareas with each subarea having one or more “virtual” entrances and/or exits. For example, a hallway may have a plurality of pillars or posts blocking the FOVs of one or more imaging devices. The hallway may then be divided into a plurality of subareas defined by the pillars, and the space between pillars for entering a subarea may be considered as a “virtual” entrance for the purposes of the system described herein.

Moreover, in some other embodiments, a “virtual” entrance may be the boundary of the FOV of an imaging device, and the site may be divided into a plurality of subareas based on the FOVs of the imaging devices deployed in the site. The system provides initial conditions for objects entering the FOV of the imaging device as described above. In these embodiments, the site may or may not have any obstructions such as walls and/or pillars, for defining each subarea.

As those skilled in the art appreciate, the processes and methods described above may be implemented as computer executable code, in the forms of software applications and modules, firmware modules and combinations thereof, which may be stored in one or more non-transitory, computer readable storage devices or media such as hard drives, solid state drives, floppy drives, Compact Disc Read-Only Memory (CD-ROM) discs, DVD-ROM discs, Blu-ray discs, Flash drives, Read-Only Memory chips such as erasable programmable read-only memory (EPROM), and the like.

Although embodiments have been described above with reference to the accompanying drawings, those of skill in the art will appreciate that variations and modifications may be made without departing from the scope thereof as defined by the appended claims.

What is claimed is:

1. A system for tracking at least one mobile object in a site, the system comprising:
at least a first imaging device having a field of view (FOV) overlapping a first subarea of the site and capturing images of at least a portion of the first subarea, the first subarea having at least a first entrance; and
one or more tag devices, each of the one or more tag devices being associated with one of the at least one mobile object and moveable therewith, each of the one or more tag devices having one or more sensors for obtaining one or more tag measurements related to the mobile object associated therewith; and
at least one processing structure for:
determining one or more initial conditions of the at least one mobile object entering the first subarea from the at least first entrance; and
combining the one or more initial conditions, the captured images, and at least one of the one or more tag measurements for tracking the at least one mobile object.

2. The system of claim 1 wherein the at least one processing structure builds a birds-eye view based on a map of the site, for mapping the at least one mobile object therein.

3. The system of claim 1 wherein said one or more initial conditions comprise data determined from one or more tag measurements regarding the at least one mobile object before the at least one mobile object enters the first subarea from the at least first entrance.

4. The system of claim 1 further comprising:
at least a second imaging device having an FOV overlapping a second subarea of the site and capturing images of at least a portion of the second subarea, the first and second subareas sharing the at least first entrance; and wherein the one or more initial conditions comprise data determined from the at least second imaging device regarding the at least one mobile object before the at least one mobile object enters the first subarea from the at least first entrance.

5. The system of claim 1 wherein the first subarea comprises at least one obstruction in the FOV of the at least first imaging device; and wherein the at least one processing structure uses a statistic model based estimation for resolving ambiguity during tracking when the at least one mobile object temporarily moves behind the obstruction.

6. A method for tracking at least one mobile object in a site, the method comprising:
obtaining a plurality of images captured by at least a first imaging device having a field of view (FOV) overlapping a first subarea of the site, the first subarea having at least a first entrance;
obtaining tag measurements from one or more tag devices, each of the one or more tag devices being associated with one of the at least one mobile object and moveable therewith, each of the one or more tag devices having one or more sensors for obtaining one or more tag measurements related to the mobile object associated therewith;
determining one or more initial conditions of the at least one mobile object entering the first subarea from the at least first entrance; and
combining the one or more initial conditions, the captured images, and at least one of the one or more tag measurements for tracking the at least one mobile object.

7. The method of claim 6 further comprising:
building a birds-eye view based on a map of the site, for mapping the at least one mobile object therein.

8. The method of claim 6 further comprising:
assembling said one or more initial conditions using data determined from one or more tag measurements regarding the at least one mobile object before the at least one mobile object enters the first subarea from the at least first entrance.

9. The method of claim 6 further comprising:
obtaining images captured by at least a second imaging device having an FOV overlapping a second subarea of the site, the first and second subareas sharing the at least first entrance; and
assembling the one or more initial conditions using data determined from the at least second imaging device regarding the at least one mobile object before the at least one mobile object enters the first subarea from the at least first entrance.

10. The method of claim 6 wherein the first subarea comprises at least one obstruction in the FOV of the at least first imaging device; and the method further comprising:
using a statistic model based estimation for resolving ambiguity during tracking when the at least one mobile object temporarily moves behind the obstruction.

11. One or more non-transitory, computer readable media storing computer executable code for tracking at least one mobile object in a site, the computer executable code comprising computer executable instructions for:
obtaining a plurality of images captured by at least a first imaging device having a field of view (FOV) overlapping a first subarea of the site, the first subarea having walls and at least a first entrance;
obtaining tag measurements from one or more tag devices, each of the one or more tag devices being associated with one of the at least one mobile object and moveable therewith, each of the one or more tag devices having one or more sensors for obtaining one or more tag measurements related to the mobile object associated therewith;
determining one or more initial conditions of the at least one mobile object entering the first subarea from the at least first entrance; and
combining the one or more initial conditions, the captured images, and at least one of the one or more tag measurements for tracking the at least one mobile object.

12. The computer readable media of claim 11 wherein the computer executable code further comprises computer executable instructions for:
building a birds-eye view based on a map of the site, for mapping the at least one mobile object therein.

13. The computer readable media of claim 11 wherein the computer executable code further comprises computer executable instructions for:
assembling said one or more initial conditions using data determined from one or more tag measurements regarding the at least one mobile object before the at least one mobile object enters the first subarea from the at least first entrance.

14. The computer readable media of claim 11 wherein the computer executable code further comprises computer executable instructions for:
obtaining images captured by at least a second imaging device having an FOV overlapping a second subarea of the site, the first and second subareas sharing the at least first entrance; and
assembling the one or more initial conditions using data determined from the at least second imaging device regarding the at least one mobile object before the at least one mobile object enters the first subarea from the at least first entrance.

15. The computer readable media of claim 11 wherein the first subarea comprises at least one obstruction in the FOV of the at least first imaging device; and wherein the computer executable code further comprises computer executable instructions for:
using a statistic model based estimation for resolving ambiguity during tracking when the at least one mobile object temporarily moves behind the obstruction.
